(19) United States
(12) Patent Application Publication
(10) Pub. No.: US 2025/0128237 A1
(43) Pub. Date: Apr. 24, 2025

(54) SEPARATION MEDIA AND PURIFICATION METHODS FOR METALS, CHIRAL MOLECULES, OR BOTH

(71) Applicant: Donaldson Company, Inc., Bloomington, MN (US)

(72) Inventor: Graham Temples, Greenville, SC (US)

(21) Appl. No.: 18/925,891

(22) Filed: Oct. 24, 2024

Related U.S. Application Data
(60) Provisional application No. 63/545,516, filed on Oct. 24, 2023.

(51) Int. Cl. B01J 20/32; B01D 15/38; B01J 20/26; B01J 20/28; B01J 20/289

(52) U.S. Cl. CPC B01J 20/3219; B01D 15/3828; B01D 15/3833; B01J 20/262; B01J 20/28033; B01J 20/289; B01J 20/3208; B01J 20/3248

(57) ABSTRACT

Separation media and separation devices containing the same are disclosed. Separation media includes a support substrate and a plurality of separation ligands. The separation ligands include an affinity group capable of binding a metal, capable of binding an enantiomer of a chiral molecule, or both. Methods of using the separation media are also disclosed.

### CROSS-REFERENCE TO RELATED APPLICATION

This application claims the benefit of U.S. Provisional Patent Application No. 63/545,516, filed Oct. 24, 2023, which is incorporated herein by reference in its entirety.

### FIELD

The present disclosure relates to separation media and separation devices containing the same. The separation media of the present disclosure include an affinity group capable of binding or chelating a metal, an enantiomer of a chiral molecule, or both. The separation media of the present disclosure may be useful for isolation of metals from mixtures, chiral separations, or both. The separation media of the present disclosure may be used for separations in membrane chromatography. The present disclosure further relates to methods of making and using the separation media.

### BACKGROUND

Metals are ubiquitous in daily life and industrial processing. Some metals are harmful to humans while others enable technology. As such, there is a need for articles and methods to isolate metals from various mixtures.

### SUMMARY

This disclosure describes, in one aspect, a separation media that includes a support substrate and a plurality of separation ligands immobilized on the support substrate. The plurality of separation ligands are of the formula SL:

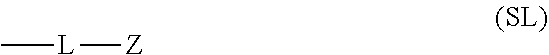

where L is a linker and Z is a separation group. The separation group includes an affinity group. The affinity group capable of binding a metal, capable of binding an enantiomer of a chiral molecule, or both. In some embodiments, the formula SL is of formula SL1 or SL2

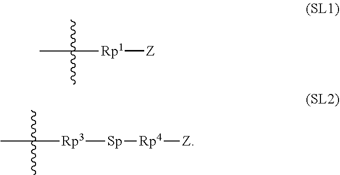

In SL1 and SL2, Rp¹, Rp³, and Rp⁴ each independently comprise the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, Rp^{M} or an isomer thereof

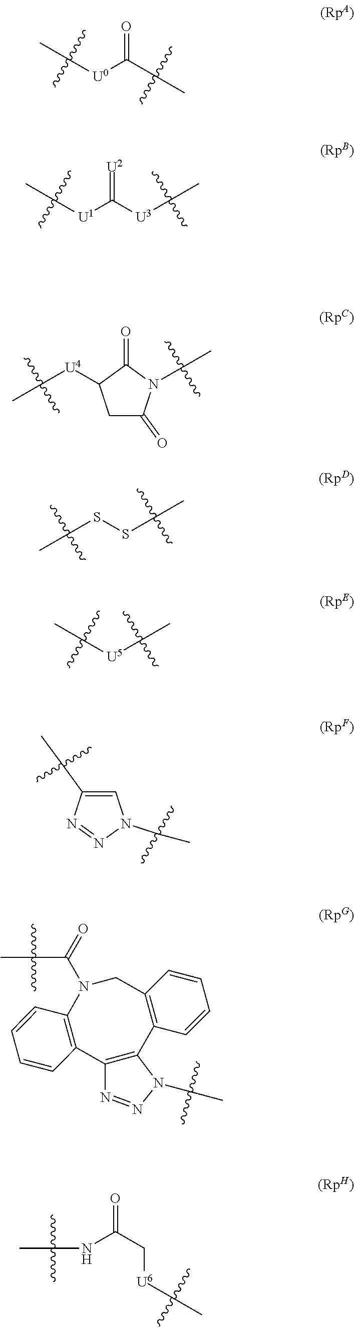

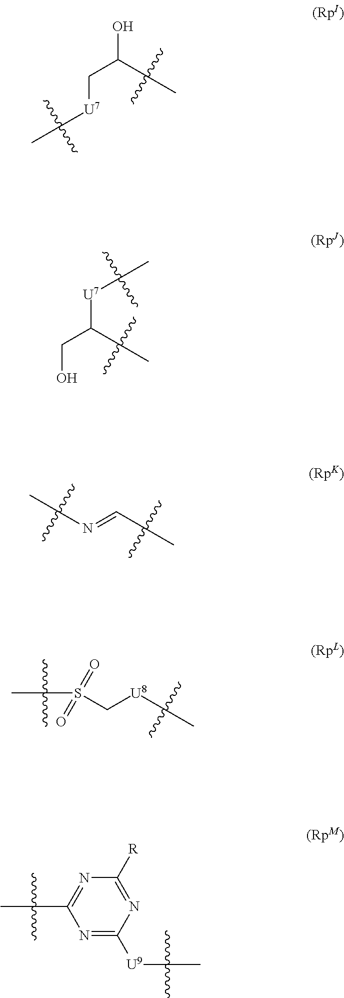

where U⁰, U¹, U², U³, U⁴, U⁵, U⁶, U⁷, U⁸ and U⁹ are each independently NH, O, or S; R is an organic group; and Sp is a spacer comprising a divalent organic group.

In some embodiments the affinity group comprises a crown ether. In some such embodiments, the affinity group comprises a crown ether and the separation media does not include an amine. In some such embodiments, the affinity group comprises a crown ether and the separation media does not include a silicon atom.

In some embodiments, the affinity group comprises a dithiocarbamate. In some embodiments, the affinity group comprises pyrrolidine dithiocarbamate, dimethyldithiocarbamate, or both. In some embodiments, the affinity group comprises an ethylene bis(dithiocarbamate). In some embodiments, the affinity group comprises ethylene-1,2-bisdithiocarbamate, propylenebis(dithiocarbamic); ethane-1,2-diylbis(dithiocarbamate), or any combination thereof.

In some embodiments, the affinity group comprises ethylenediaminetetraacetic acid; 1,2-bis(o-aminophenoxy)ethane-N,N,N′,N′-tetraacetic acid; 1,4,7-triazacyclononane-1,4,7-triacetic acid; 2,2′,2″,2′″-(1,4,7,10-tetraazacyclododecane-1,4,7,10-tetrayl)tetraacetic acid; 2-[6-[bis(carboxymethyl)amino]-5-[2-[2-[bis(carboxymethyl)amino]-5-methylphenoxy]ethoxy]-2-benzofuranyl]-5-oxazolecarboxylic acid; diethylenetriaminepentaacetic acid; 3,12-bis(carboxymethyl)-6,9-dioxa-3,12-diazatetradecane-1,14-dioic acid; nicotianamine; thylenediamine-N,N′-bis(2-hydroxyphenylacetic acid; ethylenediamine-N,N′-disuccinic acid; or any combination thereof.

In some embodiments, the affinity group comprises a chiral biological molecule, a chiral polymer, a helical polymer, a macrocyclic antibiotic, or any combination thereof. In some embodiments, the helical polymer includes double stranded DNA. In some embodiments, the biological molecule is a substituted or unsubstituted polysaccharide. In some embodiments, the substituted or unsubstituted polysaccharide comprises amylose, cellulose, chitosan, fructan, or aliginic acid. In some embodiments, the biological molecule is a peptide. In some embodiments, the peptide is albumin.

In another aspect, this disclosure describes a separation device that includes a housing and a separation media of the present disclosure disposed within the housing.

In another aspect, this disclosure describes a method for isolating a target molecule from an isolation solution. The isolation solution includes an isolation solvent and the target molecule. The target molecule includes a carbohydrate. The method includes contacting the isolation solution with the separation media or separation device of the present disclosure.

The above summary is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

The following detailed description of illustrative embodiments of the present disclosure may be best understood when read in conjunction with the following drawings.

FIG. 1A is a schematic showing a first reaction between a pre-immobilized affinity group and a second component.

FIG. 1B is a schematic showing a second reaction between a pre-immobilized affinity group and a second component.

FIG. 2A is a flow diagram of a first method for making the separation media of the present disclosure.

FIG. 2B is a flow diagram of a second method for making the separation media of the present disclosure.

FIG. 3A is a flow diagram of a third method for making the separation media of the present disclosure.

FIG. 3B is a flow diagram of a fourth method for making the separation media of the present disclosure.

FIG. 4A is a flow diagram of a fifth method for making the separation media of the present disclosure.

FIG. 4B is a flow diagram of a sixth method for making the separation media of the present disclosure.

FIG. 5A is a schematic of a separation media consistent with embodiments of the present disclosure.

FIG. 5B is a schematic representation of a separation device consistent with embodiments of the present disclosure.

FIG. 6 is a flow diagram of a method of using the separation media and/or separation devices of the present disclosure.

FIG. 7 is a first schematic synthetic strategy for the making of separation media consistent with the present disclosure. This strategy includes the deposition of a polymer onto the support substrate through the grafting on technique. This strategy also includes indirect immobilization of the separation ligands onto the support substrate and an amine assisted coupling method.

FIG. 8 is a second schematic synthetic strategy for the making of separation media consistent with the present disclosure. This strategy includes the deposition of a polymer onto the support substrate through the grafting from technique. This strategy also includes indirect immobilization of the separation ligands onto the support substrate and an amine assisted coupling method.

FIG. 9 is a third schematic synthetic strategy for the making of separation media consistent with the present disclosure. This strategy includes direct immobilization of the separation ligands onto the support substrate and an amine assisted conjugation method.

FIG. 10 is a fourth schematic synthetic strategy for the making of separation media consistent with the present disclosure. This strategy includes direct immobilization of the separation ligands onto the support substrate and an organic solvent assistance conjugation method.

FIG. 11 is the structure of a α-cyclodextrin.

FIG. 12 shows the structures of 12-crown-4 (i), dibenzo-18-crown-6 (ii), cyclam (iii), [2.2.2]cryptand (iv), 9-ane-S3 (v), and calix[4]arene with para-tert butyl substituents (vi).

The schematic drawings are not necessarily to scale. Like numbers used in the figures refer to like components, steps and the like. However, it will be understood that the use of a number to refer to a component in a given figure is not intended to limit the component in another figure labeled with the same number. In addition, the use of different numbers to refer to components is not intended to indicate that the different numbered components cannot be the same or similar to other numbered components.

### Definitions

All scientific and technical terms used herein have meanings commonly used in the art unless otherwise specified. The definitions provided herein are to facilitate understanding of certain terms used frequently herein and are not meant to limit the scope of the present disclosure.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

As used herein, the symbol

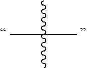

and “-” when used in the context of a compound or chemical formula (hereinafter can be referred to as “a point of attachment bond” or “point of attachment”) denote a bond that is a point of attachment between two chemical entities, or a chemical entity and a support substrate, one of which is depicted as being attached to the point of attachment bond and the other of which is not depicted as being attached to the point of attachment bond. For example,

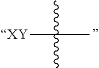

indicates that the chemical entity “XY” is bonded to another chemical entity or a support substrate via the point of attachment bond.

In some embodiments, where a general formula is shown with a covalent bond connecting a group to a compound, the group may be described as the common functional group. For example, if the group R is described relative to the formula CH₃CH₂CH₂—R, the organic group may be described, for example, as an aromatic ring.

The term “organic group” refers to a group that has carbon-hydrogen bonds. The group may also include heteroatoms such as O, S, N, or P. One or more heteroatoms may be catenated at any location in the organic group (e.g., ether, thioether, or amine). A heteroatom may be covalently bonded to a carbon atom through a double bond (e.g., ketone, imine). A heteroatom covalently bonded to a carbon atom may also be covalently bonded to another heteroatom (e.g., phosphodiester, sulfone). One or more functional groups may be included in an organic group, for example, alkane (branched, linear, or cyclic), alkene (branched or linear), alkyne (branched or linear), aromatic, amine (primary, secondary, tertiary, or quaternary), amino, amide, alcohol (primary, secondary, or tertiary), alkoxy, aldehyde, carboxylic acid, ether, ester, imine, phosphoester, phosphodiester, sulfone, sulfonamide, urea, thiourea, thioether, or any combination thereof, and ionized versions thereof. Generally, the organic group may be covalently bonded to a compound. The point of attachment of the organic group to the compound may be described in several ways. For example, in some embodiments, the organic group may be described as the monovalent or radical of the respective functional group (e.g., alkyl for alkane, aryl for aromatic ring, aminyl for a primary or secondary amine). In some embodiments, where a general formula is shown with a covalent bond connecting the organic group to a compound, the organic group may be described as the common functional group. For example, if the organic group R is described relative to the formula CH₃CH₂CH₂—R, the organic group may be described, for example, as an aromatic ring.

The term “catenated” in the context of heteroatoms refers to a heteroatom (e.g., O, S, N, P) that replaces at least one carbon atom in a carbon chain. For example, ether groups contain one catenary oxygen atom with at least one carbon atom on each side of the catenary oxygen atom and polyether groups contain more than one catenary oxygen atom with carbon atoms on each side of the more than one catenary oxygen atoms.

The term “aryl” refers to a monovalent group that is aromatic. The aryl group may be carbocyclic or include one or more heteroatoms such as S, N, or O. Example aryl groups include, but are not limited to, phenyl, thiophenyl, furanyl, pyridinyl, pyrimidinyl, piperidinyl, and pyrrolyl.

The term “alkanediyl” refers to a divalent group that is a radical of an alkane and includes groups that are linear, branched, cyclic, bicyclic, or a combination thereof.

The term “backbone” refers to the longest contiguous chain. One or more branches may be covalently bonded to the backbone.

The term “aromatic” refers to a cyclic, fully conjugated planar structure that obeys Hückel's rules, that is the compound has 4n+2pi electrons where n is a positive integer or zero. For example, benzene has 6 pi electrons. Thus, 6=4n+2pi. Solving for n gives 1. Therefore, benzene is an aromatic compound.

The term “kosmotrope” is generally used to denote a solute that increases the degree of ordered-ness of water by stabilizing water-water interactions. Kosmotropes may be ionic or non-ionic. In contrast, the term “chaotrope” is generally used to denote a solute that decreases the degree of ordered-ness of water by destabilizing water-water interactions. Chaotropes may be ionic or non-ionic.

The term “peptide” refers to a sequence of amino acid residues without regard to the length of the sequence. Therefore, the term “peptide” refers to any amino acid sequence having at least two amino acids and includes full-length proteins and, as the case may be, polyproteins.

The term “polypeptide” refers to a sequence of amino acid residues without regard to the length of the sequence. Therefore, the term “polypeptide” refers to any amino acid sequence having at least two amino acids and includes full-length proteins, fragments thereof, and/or, as the case may be, polyproteins.

The term “protein” refers to any sequence of two or more amino acid residues without regard to the length of the sequence, as well as any complex of two or more separately translated amino acid sequences. Protein also refers to amino acid sequences chemically modified to include a carbohydrate, a lipid, a nucleotide sequence, or any combination of carbohydrates, lipids, and/or nucleotide sequences. As used herein, “protein,” “peptide,” and “polypeptide” are used interchangeably.

In the description, particular embodiments may be described in isolation for clarity. Reference throughout this specification to “one embodiment,” “an embodiment,” “certain embodiments,” “one or more embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments. Thus, features described in the context of one embodiment may be combined with features described in the context of a different embodiment except where the features are necessarily mutually exclusive.

For any method disclosed herein that includes discrete steps, the steps may be performed in any feasible order. And, as appropriate, any combination of two or more steps may be performed simultaneously.

### DETAILED DESCRIPTION

The present disclosure provides separation media and separation devices containing the same. Specifically, the disclosure provides separation media that may be used to temporarily immobilize a metal and/or an enantiomer of a chiral molecule from a mixture. To that end, the separation media of the present disclosure include separation ligands. The separation ligands include a separating group that can be an affinity group, an assistance group, or a capping group. The affinity group includes a group capable of binding a metal, a compound that includes a metal, an enantiomer of a chiral molecule, or any combination thereof. Multiple layers of separation media of the present disclosure may be arranged in a stacked configuration to increase separation specificity and/or efficiency. The separation media of the present disclosure may be used for separations in membrane chromatography.

Water pollution from human activities is a growing problem. For example, toxic levels of various metals can make water unsafe for plants, animals, and/or humans. Wastewater from industrial processing in various industries (e.g., battery manufacturing, nuclear industries, electronic manufacturing, pharmaceutical manufacturing, textile industries, paper and pulp industries, mining, smelting, electric power plants, wood preserving, and metal working) may include various metals. Additionally, electronic waste (e.g., circuit boards, semiconductors, and devices that include the same) include various metals. It may be desirable to treat such waste streams to prevent metals from entering the environment and/or to recover such metals for future use. It may also be desirable to quantify the amount of one or more metals in such waste streams and/or in the ground water.

Many biologically active molecules are chiral. For example, many small molecule drugs are chiral. Some synthetic reactions used to produce small molecule drugs and/or small molecule drug intermediates result in the formation of racemates. Separation of the enantiomers of the racemates may be important prior to administration because, for example, one of the enantiomers may be toxic. For example, the D-configuration of penicillamine is commonly used to treat heavy metal poisoning while the L-configuration is toxic. Methods and media that can facilitate the separation of the enantiomers of chiral molecules may increase the efficiency of chiral molecule synthesis and purification.

Chiral separations; that is, the separation of one or more enantiomers of a chiral molecule, traditionally uses resin based chiral chromatography columns. A drawback of resin-based columns is that the binding capacity of the target molecule (e.g., a chiral molecule or a specific enantiomer of a chiral molecule) decreases as flow rate increases. More specifically, as the flow rate increases, the column residence time decreases, and the purification recovery of the target molecule initially loaded onto the column decreases.

Long residence times are used to attain high binding capacities of the target molecules due to slow mass transfer of target molecules through the small pore structures of resins. Typical resin chromatography products are configured to have a residence time of six minutes or longer to achieve optimal binding capacity. Such long residence times may result in low productivity and/or target molecule degradation.

Resin-based columns may be prone to clogging and/or fouling. Additionally, as a symptom of column clogging and/or use of a high flow rate, resin-based chromatography systems can suffer from high backpressure. Furthermore, due to the desirability of long residence times and low flow rates, large volume purification may require a large amount of resin, multiple resin columns run in sequence, and/or slow flow rates.

Membrane chromatography is an alternative to resin-based chromatography. Adsorptive membranes (membranes that do not display affinity ligands) with large flow-through pores can operate with short residence times but have low binding capacity. Existing porous hydrogel membranes often have higher binding capacities than membranes; however, their small mesh size often results in poor target macromolecule accessibility leading to decreased binding capacity at short residence times. Additionally, high backpressure (e.g., greater than 3 bar) due to increased flow rates associated with shorter residence times is an issue associated with porous hydrogels.

The present disclosure describes separation media that include an affinity ligand and may be used for separations in membrane chromatography. In contrast to resin columns, membrane adsorbers perform well at short column residence times, potentially providing rapid separations. The present disclosure provides separation media that are suitable for separation, purification, and/or concentration of targets such as metals and/or an enantiomer of a chiral molecule.

Atoms or molecules of interest that may be separated using the separation media of the present disclosure are collectively referred to here as targets. The targets of the present disclosure include metals, molecules that include a metal, and/or enantiomers of chiral molecules. A chiral molecule is a molecule that has at least two forms that are non-superimposable (enantiomers).

Each chiral molecule includes at least one stereocenter and at least one pair of enantiomers. The target may be present in a solution, suspension, or dispersion. For simplicity, the liquid containing the target is referred to here as an isolation solution. Also, for simplicity, a target may be referred to in the singular but it is understood that an isolation solution may include a plurality of target molecules of the same identity. An isolation solution may also include two or more targets of different identity. In some embodiments, the isolation solution is a waste mixture otherwise termed wastewater, an environmental mixture, a reaction mixture, or any combination thereof. Waste mixtures and environmental waste mixtures may include water, one or more organic solvents, or both. As such, wastewater may include water, one or more organic solvents, or both.

In some embodiments, the isolation solution includes a waste mixture. A waste mixture is a mixture that was formed and/or used during a process or an application or a mixture that is formed from mixing a liquid with a discarded component. Examples of waste mixtures that are formed and/or used during a process or application include industrial waste mixtures; reaction waste; and commercial and domestic wastewater. Industrial waste mixtures are formed or used in processes such as in textile processing, mining, technology manufacturing (e.g., electroplating waste) agriculture run off, and others. Reaction waste includes any components of a chemical reaction mixture that are not the desired product (e.g., solvent, catalysts, unreacted components, byproducts); solvents and/or other molecules used during isolation and/or purification; or both. A reaction waste may include enantiomers of product in which one of the enantiomers is the desired enantiomer. Commercial and domestic wastewater include sewage and other wastewater from homes and businesses commonly treated by municipal water treatment facilities. An example of a waste mixture formed from mixing a liquid with a discarded component is an electronic waste mixture (e-waste) where at least a component of an electronic device (e.g., a circuit board) is mixed with a solvent. The solvent can extract the metals and the mixture can be filtered before being used in an isolation solution.

In some embodiments, the isolation solution is an environmental mixture. An environmental mixture is a water source in the environment that is not actively being used for industrial processes. The environmental mixture may have had treated or untreated wastewater disposed within it. Examples of environmental mixtures include lakes, ponds, and streams.

In some embodiments, the isolation mixture is a reaction mixture. A reaction mixture includes reaction waste and, in some cases, the desired product. In some embodiments, the reaction waste includes enantiomers of a chiral molecule where one of the enantiomers is the desired product. In some embodiments, the reaction waste includes a metal.

In some embodiments, where the isolation solution includes a waste mixture, it may be desirable to remove one or more metals from the water mixture prior to disposal and/or further processing. In some embodiments, where the isolation solution includes an electronic waste mixture, reaction waste, or a reaction mixture, it may be desirable to harvest metals from these mixtures for reuse. In some embodiments, where the isolation solution includes an environmental mixture or a waste mixture, it may be desirable to quantify the amount of a metal in those mixtures.

The separation media may be configured for use with organic solvents. The separation media may be configured for use with water. The separation media may be configured to separate the target molecules from an isolation solution that includes organic solvents, water, or both.

The separation media of the present disclosure includes a plurality of separation ligands immobilized on a support substrate. The plurality of separation ligands include one or more separation groups. A separation group is a chemical group that facilitates the isolation of a target from an isolation solution. Facilitation of separation may be in the form of a chemical group to which the target binds; a chemical group that allows for increased density of the affinity group-target interaction and/or increases the target attraction to the support substrate; or a chemical group that blocks a reactive group from covalently modifying the target during contact with the separation media; or any combination thereof.

A separation group may be an affinity group, an assistance group, or a capping group. The separation media includes a plurality of separation ligands that include an affinity group. In some embodiments, the plurality of separation ligands includes two or more different affinity groups. Each of the two or more affinity groups may bind to the same target or different targets.

In addition to the plurality of separation ligands that include an affinity group, the separation media may include a plurality of separation ligands that include an assistance group; a plurality of separation ligands that include a capping group; or both.

A support substrate is the base material for the separation media. The support substrate provides a platform for which the separation ligands are immobilized. The support substrate includes at least one membrane. In some embodiments, the support substrate is the at least one membrane. In some embodiments, the support substrate includes two or more membranes arranged in a stacked configuration. In addition to the at least one membrane, the support substrate may include additional layers such as hydrogels, woven fibrous materials (i.e., a material made by the interlacing of multiple fibers), nonwoven fibrous materials (i.e., a material made from one or more fibers that are bound together through chemical, physical, heat, or mechanical treatment); or any combination thereof. Such additional layers may impart rigidity and structure to the support substrate. In some embodiments, the support substrate includes a functionalized material that is deposited on the surface of the at least one membrane. The functionalized material may provide reactive handles to which the separation ligands may be reacted to be immobilized to the support substrate. In embodiments where the separation media includes multiple layers, the layers may be laminated.

Any layer of the support substrate may be made of any suitable material. A suitable support substrate material is a material that is porous so as to allow the isolation solution to pass through the support substrate. In some embodiments, a suitable support substrate is a material that does not react with the target, or other molecules in the isolation solution, to form a type of covalent bond which would permanently immobilize said target or molecule to the support substrate.

The support substrate includes at least one membrane. A membrane is understood as a sheet of material with a continuous pathway of polymeric material in all dimensions. The membrane may be made of any suitable support substrate material. Examples of suitable support substrate membrane materials include polyolefins; polyethersulfone; poly(tetrafluoroethylene); nylon; fiberglass; hydrogels; polyvinyl alcohol; natural polymers such as cellulose, cellulose ester, cellulose acetate, regenerated cellulose, cellulosic nanofiber, cellulose derivatives, agarose, chitosan; polyethylene; polyester; polysulfone; expanded polytetrafluoroethylene (ePTFE), polyvinylidene fluoride; polyamide (Nylon); polyacrylonitrile; polycarbonate; and any combination thereof.

In some embodiments, the membrane itself is functionalized prior to immobilizing the separation ligands. Functionalization of the membrane may be done to install reactive handles (e.g., a support substrate reactive handle as discussed herein) on the membrane. The reactive handles react with cooperative reactive handles on the separation ligands to form a covalent bond thereby immobilizing the separation ligands on the support substrate (as discussed herein). Functionalization may be accomplished by plasma treatment, corona treatment, and the like.

In some embodiments, the support substrate includes a functionalized layer. In some embodiments, the functionalized layer is a membrane. A functionalized layer is a material disposed on the surface of a support substrate layer (e.g., disposed on the surface of the at least one membrane) and includes the support substrate reactive handles that may be used for separation ligand immobilization. A functionalized layer may be covalently attached to the support substrate; adhered to the support substrate through electrostatic forces, hydrogen-bonding, and/or Van der Waals forces; laminated to the support substrate; or simply contacting the support substrate. A functionalized layer may be deposited on the surface of a support substrate (e.g., on the surface of the at least one membrane) using a variety of deposition techniques such as chemical vapor deposition, dip coating, spray coating, electrospinning, and the like.

In some embodiments, the functionalized layer is a polymer that is disposed onto the support surface using a grafting on or grafting from polymerization technique. Without wishing to be bound by theory, it is thought that disposing a polymer on the support substrate may increase the surface area and number of available support substrate reactive handles that can be used to immobilize the separation ligands and therefore result in high binding capacity of the separation media. The terms “grafting on,” “grafting onto,” and “grafted onto” refer to already formed polymer chains that adsorb or covalently attach to a surface (e.g., a support substrate surface). The terms “grafting from” or “grafted from” refer to a polymer chain that is initiated and grown from a surface (e.g., a support substrate surface). Any suitable polymer may be grafted on or grafted from a support substrate to form a functionalized layer. Suitable polymers are those that include a functional group that includes a reactive handle that allows for attachment of separation ligands to the support substrate. The reactive handle is not the polymerizable group, but instead is a group that remains intact following polymerization.

Example polymers that include a reactive handle or a functional group that can be converted to a reactive handle (i.e., support substrate reactive handle) include carboxylic acids, amines, alcohols, epoxides, amides, azide, alkynes, and the like. Examples of monomers that can be used to form such polymers include vinyl alcohol, hydroxy functional acrylates (e.g., 2-hydroxyehtyl acrylate and 4-hydroxybutyl acrylate), hydroxy functional methacrylate (e.g., hydroxyethyl methacrylate), epoxy containing monomers, and hydroxy functional acrylamides (e.g., N-hydroxyethyl acrylamide). Examples of specific polymers that may be grafted on or grafted from a support substrate include polydopamine, poly(vinyl alcohol), poly(acrylic acid), poly(glycidyl methacrylate, and poly 2-hydroxyethyl acrylate (formed from 2-hydroxyethyl acrylate monomers). Graft on and graft from polymerization may be accomplished using a suitable technique such as addition polymerization (e.g., free radical polymerization such as atom transfer radical polymerization (ATRP) and reversible addition fragmentation chain transfer (RAFT) polymerization; anionic polymerization; and cationic polymerization), or condensation polymerization. In some embodiments, where the polymer is grafted from the support substrate, an initiator is first coupled to the support substrate (e.g., through an OH group on the support substrate). Any suitable initiator may be used, for example, 2-bromo-2-methylpropionyl bromide (BiBB).

The membranes of the support substrate are porous and can have an average pore size, as measure by a capillary flow porometer, of 10 micrometers or less, 5 micrometers or less, 2 micrometers or less, 1 micrometer or less, 0.6 micrometers or less, 0.5 micrometers or less, 0.45 micrometers or less, or 0.2 micrometers or less. The membrane may have an average pore size of 0.1 micrometers or greater, 0.2 micrometers or greater, 0.45 micrometers or greater, 0.5 micrometers or greater, 0.6 micrometers or greater, 0.7 micrometers or greater, or 1 micrometer or greater. The membrane may have an average pore size ranging from about 0.1 micrometers to 10.0 micrometers, 0.1 micrometers to 0.2 micrometers, 0.1 micrometers to 0.45 micrometers, 0.1 micrometers to 0.5 micrometers, 0.1 micrometers to 1 micrometers, 0.2 micrometers to 0.45 micrometers, 0.2 micrometers to 0.50, 0.2 micrometers to 1 micrometers, 0.2 micrometers to 2 micrometers, 0.2 micrometers to 10 micrometers, 0.45 micrometers to 1 micrometers, 0.45 micrometers to 2 micrometers, 0.45 micrometers to 10 micrometers, 1 micrometers to 2 micrometers, or 1 micrometers to 5 micrometers. In some embodiments, the support substrate has an average pore size of 0.1 micrometers to 0.5 micrometers, 0.1 micrometers to 0.6 micrometers, 0.1 micrometers to 0.3 micrometers, or 0.4 micrometers to 0.6 micrometers.

In some embodiments, the support membrane includes cellulose such as regenerated cellulose, cellulose acetate, or cellulose ester. In some such embodiments, the support membrane has an average pore size 0.1 micrometers to 0.5 micrometers, 0.1 micrometers to 0.6 micrometers, 0.1 micrometers to 0.3 micrometers, or 0.4 micrometers to 0.6 micrometers.

The membrane may have a thickness of 2500 micrometers or less, 1000 micrometers or less, 500 micrometers or less, 250 micrometers or less, or 100 micrometers or less. The thickness of the membrane may be in a range of 30 micrometers to 500 micrometers, 50 micrometers to 500 micrometers, 80 micrometers to 500 micrometers, 100 micrometers to 500 micrometers, 250 micrometers to 500 micrometers, 30 micrometers to 250 micrometers, 50 micrometers to 250 micrometers, 80 micrometers to 250 micrometers, 100 micrometers to 2500 micrometers, 30 micrometers to 100 micrometers, 50 micrometers to 100 micrometers, or 80 micrometers to 100 micrometers.

In some embodiments, the support substrate includes multiple membranes stacked in a multilayer arrangement to increase capacity or selectivity of the separation media for a given application. The multilayer membrane configuration (i.e., only considering the membrane layers of a support substrate) may have a thickens of 10,000 micrometers or less, 7,500 micrometers or less, 5,000 micrometers or less, 4,000 micrometers or less, 3,000 micrometers or less, 2,500 micrometers or less, 2,000 micrometers or less, 1,000 micrometers or less, 750 micrometers or less, 500 micrometers or less, 400 micrometers or less, or 300 micrometers or less. The stacked arrangement of membranes may have a thickness ranging from 70 micrometers to 10,000 micrometers, 70 micrometers to 100 micrometers, 70 micrometers to 200 micrometers, 70 micrometers to 300 micrometers, 70 micrometers to 400 micrometers, 70 micrometers to 500 micrometers, 70 micrometers to 750 micrometers, 70 micrometers to 1,000 micrometers, 70 micrometers to 2,000 micrometers, 70 micrometers to 3,000 micrometers, 70 micrometers to 4,000 micrometers, 70 micrometers to 5,000 micrometers, 250 micrometers to 300 micrometers, 250 micrometers to 400 micrometers, 250 micrometers to 500 micrometers, 250 micrometers to 750 micrometers, 250 micrometers to 1,000 micrometers, 250 to 2,000 micrometers, 250 to 3,000 micrometers, 250 to 4,000 micrometers, 250 to 5,000 micrometers, 500 micrometers to 1,000 micrometers, 500 micrometers to 2,000 micrometers, 500 micrometers to 3,000 micrometers, 500 micrometers to 4,000 micrometers, or 500 micrometers to 5,000 micrometers in thickness.

In some embodiments, the membrane is a regenerated cellulose membrane having a pore size of between 0.2 micrometers and 5.0 micrometers, a thickness of between 70 micrometers and 2,000 micrometers. Such membranes may be in a stacked arrangement approximately 70 micrometers to 10,000 micrometers in thickness.

The support substrate may include or be a microfiltration membrane. Microfiltration membranes are typically created through a phase inversion process or an expansion process. Typical materials used to prepare membranes include polyethersulfone (PES), nylon, polyvinylidene fluoride (PVDF), cellulose acetate, regenerated cellulose, polypropylene, and expanded polytetrafluoroethylene (ePTFE).

A plurality of separation groups are immobilized on the support substrate. The separation groups include at least an affinity group. The affinity group is capable of binding a metal, an enantiomer of a chiral molecule, or both.

In some embodiments, the affinity group is capable of binding a metal. Binding of the metal may be through chelation to create a chelated metal. Chelation involves the formation or presence of two or more coordinate bonds between a single affinity group or two or more affinity groups and one or more metal atoms in a single complex. A coordinate bond is a two electron bond between two atoms where the two electrons come from the same atom. In some cases, a single affinity group may chelate a metal. In other cases, two or more distinct affinity groups located proximate to each other on the support surface may work in concert to chelate a metal. For example, two or more affinity groups may contribute to one or more of the coordinate bonds to the metal.

As used herein, the term “metal” includes all of the elements and their isotopes and oxidation states except H, He, N, O, F, Ne, P, S, Cl, Ar, Se, Br, Kr, I, Xe, and Rn. A metal may be a part of a larger compound. As such, separation media of the present disclosure that can be used to chelate a compound that includes a metal.

In some embodiments, the affinity ligand is capable of binding a transition metal and actinide, a lanthanide, a post-transition metal, a metalloid, or any combination thereof. Transition metals include Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, Db, Sg, Bh, Hs, Mt, Ds, Rg, Cn, isotopes thereof, and oxidation states thereof. Actinides include Ac, Th, Pa, U, Np, Pu, Am, Cm, Bk, Cf, Es, Fm, Md, No, Lr, isotopes thereof, and oxidation states thereof. Lanthanides include La, Ce, Pr, Nd, Pm, Sm, Eu, Gd, Tb, Dy, Ho, Er, Yb, Lu, isotopes thereof, and oxidation states thereof. Post-transition metals include Al, Ga, In, Sn, Ti, Pb, Bi, Po, isotopes thereof, and oxidation states thereof. Metalloids include B, Si, Ge, As, Sb, As, Te, isotopes thereof, and oxidation states thereof.

In some embodiments, the affinity ligand is capable of binding a highly toxic metal. Highly toxic metals are metals that are particularly dangerous to living things at low levels. Highly toxic metals include Cr, As, Cd, Hg, Pb, As, T1, isotopes thereof, and oxidation states thereof.

In some embodiments, the affinity ligand is capable of binding a precious metal. Precious metals are rare and of high economic value. Examples of precious metals include Au, Ag, Pt, Pd, Ru, Rh, Re, Os, Ir, isotopes thereof, and oxidation states thereof.

In some embodiments where the affinity group can chelate a metal, the affinity group includes one or more donor atoms. A donor atom is neutral or charged atom (e.g., N, O, S, and P) that have a free electron pair that can bind to a metal via a coordination bond. Donor atoms are often described in the context of a donor chemical group. The terms “donor” and “donor group” refer to a donor chemical group. One or more of the atoms within the donor group may act as a donor atom. Donor chemical groups may be described in their neutral or ionized state. When a donor group is described in its neutral state it is understood that its charged state may include the donor atom or may also include a donor atom. Examples of donor groups include thiols (—SH) and thiolates (—S—); alcohols (—OH) and oxides such as alkoxides (R—O— where R is a carbon containing group), aryloxides (R—O— where R is aryl), and phenoxides (R—O— where R is phenyl); ethers (—O—); thioethers (—S—); carboxylic acids (—C(═O)(OH)) and carboxylates, [—C(═O)O]—); amines such as primary, secondary, and tertiary amines; oximines (—N—OH); carbamates (N(R¹)(R²)C(═O)OR³) where R¹, R², and R³ are each independently H, alkyl, aryl, phenyl, or a point of attachment to a larger compound); thiocarbonate (—O(C═O)S—); dithiocarbamate (N(R¹)(R²)C(═S)SR³ where R¹, R², and R³ are each independently H, alkyl, aryl, phenyl, or a point of attachment to a larger compound); ketones (—C(═O)—); aldehydes (—C(═O)H); amides (—C(═O)NR¹R² where R¹, R², and R³ are each independently H, alkyl, aryl, phenyl, or a point of attachment to a larger compound); ureas (N(R¹)(R²)C(═O)N(R³)(R⁴), where R¹, R², R³ and R⁴ are each independently H, alkyl, aryl, phenyl, or a point of attachment to a larger compound); sulfones (—S(O)₂—); sulfates ([—S(O₃)]⁻); sulfoxides (—S(O)—); esters; and carbonyl containing groups having a hydroxy on the carbon alpha to the carbonyl carbon (also called carbonyl containing groups having an alpha hydroxy). In some embodiments, the affinity group includes at least one of a thiol, thiolate, alcohol, oxide, ether, thioether, carboxylic acid, carboxylate, amine, carbamate, dithiocarbamate, ketone, aldehyde, urea, sulfone, sulfate, sulfoxide, or a carbonyl containing group with an alpha hydroxy.

The strength of a coordination bond between a donor and a metal may be influenced by the identity of the metal and the identity of the donor group or donor groups participating in the coordination bond. Additionally, the strength of a coordination bond may be influenced at least in part by the identity of the other chemical moieties in the compound that includes the one or more donor groups.

Affinity group capable of binding a metal may have a variety of denticities. Denticity is the total number of donor groups in an affinity group that can bind to a metal via a coordinate bond, though not all donor groups may bind to a metal via a coordinate bond. In some embodiments, the denticity of the affinity group can be an integer from 1 to 30. In some embodiments, the affinity group has a denticity of two. In some embodiments, the affinity group has a denticity of three. In some embodiments, the affinity group has a denticity of four. In some embodiments, the affinity group has a denticity of five. In some embodiments, the affinity group has a denticity of six. In some embodiments, the affinity group has a denticity of seven. In some embodiments, the affinity group has a denticity of eight. In some embodiments, the affinity group has a denticity of nine. In some embodiments, the affinity group has a denticity of ten. In some embodiments, the affinity group has a denticity of elven. In some embodiments, the affinity group has a denticity of twelve. In some embodiments, the affinity group has a denticity of thirteen. In some embodiments, the affinity group has a denticity of fourteen. In some embodiments, the affinity group has a denticity of fifteen. In some embodiments, the affinity group has a denticity of sixteen. In some embodiments, the affinity group has a denticity of seventeen. In some embodiments, the affinity group has a denticity of eighteen. In some embodiments, the affinity group has a denticity of nineteen. In some embodiments, the affinity group has a denticity of twenty. In some embodiments, the affinity group has a denticity of twenty-one. In some embodiments, the affinity group has a denticity of twenty-two. In some embodiments, the affinity group has a denticity of twenty-three. In some embodiments, the affinity group has a denticity of twenty-four. In some embodiments, the affinity group has a denticity of twenty-five. In some embodiments, the affinity group has a denticity of twenty-six. In some embodiments, the affinity group has a denticity of twenty-seven. In some embodiments, the affinity group has a denticity of twenty-eight. In some embodiments, the affinity group has a denticity of twenty-nine. In some embodiments, the affinity group has a denticity of thirty.

Compounds that can bind a metal can be classified by one or more components of their structure such as a particular donor group, a combination of donor groups, and/or the linker separating two or more donor groups. As used herein, the term “chelation class” refers to a particular donor group, combination of donor groups, and/or the linker separating two or more donor groups on a compound.

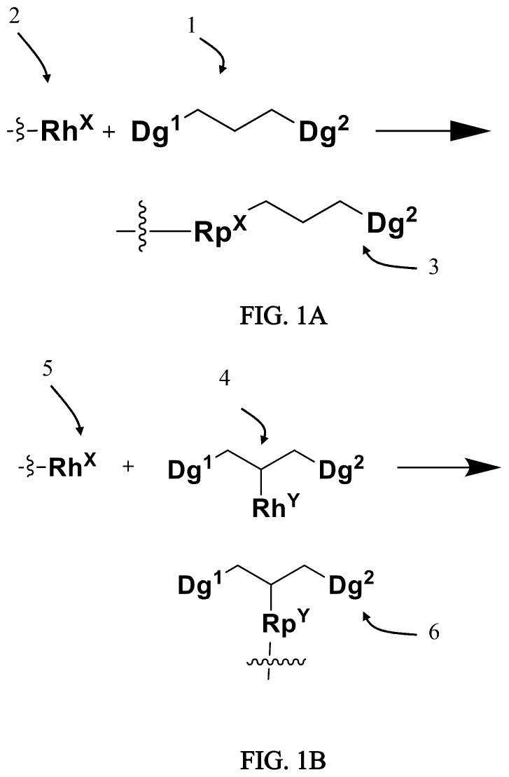

Affinity groups can be categorized based on their chelation class once the separation group containing the affinity group is immobilized on the surface and/or based on the chelation class of an affinity group before it undergoes any reactions (e.g., reactions to immobilize it on the surface), termed a precursor affinity group. A precursor affinity group is a compound that includes an affinity group and has at least one reactive handle for a conjugation reaction to another component or to the support surface (see discussion herein about reactive handles and reaction products). In some cases, a donor group on the precursor affinity group may be the reactive handle and the reaction product of the donor group with a cooperative reactive handle may result in a reaction product that is not a donor group or in a donor group having a different identity than the donor group of the precursor affinity group. For example, FIG. 1A shows the reaction between a precursor affinity group 1 and a second component 2. The precursor affinity group 1 has two donors Dg¹ and Dg². The second component precursor has a reactive handle Rh^{X}. In the reaction, the donor group Dg¹ of the precursor affinity group 1 functions as a reactive handle to react with the reactive handle of the second component 2 to form a reaction product Rp^{X}. The reaction product Rp^{X} may or may not include a donor group.

In some embodiments, the precursor affinity group includes a reactive handle that is not a donor. In such embodiments, the reaction product between the precursor affinity group and the reactive handle of the second component may or may not form a donor group. For example, FIG. 1B shows the reaction between precursor affinity group 4 and a second component precursor 5. The precursor affinity group 4 has two donors, Dg¹ and Dg² and a reactive handle Rh^{Y}. The second component precursor has a reactive handle Rh^{X}. In the reaction, the reactive handle Rh^{Y} of the precursor affinity group 4 reacts with the reactive handle Rh^{X} of the second component 2 to form a reaction product Rp^{Y}. The reaction product Rp^{Y} may or may not include a donor group.

In some embodiments, the chelation class of an affinity group or an affinity group precursor is a dithiol. Dithiols are compounds that include two thiol groups (or thiolate groups depending on the pH).

In some embodiments, the chelation class of an affinity group or an affinity group precursor is a dithiocarbamate. When defined as a chelation class, a dithiocarbamate is a compound that includes at least two dithiocarbamates. In some such embodiments, the dithiocarbamate may be an ethylene (bis)dithiocarbamate. An ethylene (bis)dithiocarbamate is a compound that includes at least two dithiocarbamates separated by a C₂ spacer. The C₂ spacer can be substituted or unsubstituted. For example, the C₂ spacer may be substituted with an alkyl or a covalent bond to a pendant group that includes a reactive handle.

In some embodiments, the chelation class of an affinity group or an affinity group precursor is an aminocarboxylic acid or aminocarboxylate depending on the pH. An aminocarboxylic acid or aminocarboxylate is a compound that has a carboxylic acid and an amine separated by a carbon spacer. The carbon spacer may be C₁ through C₁₀, such as, for example, C₁, C₂, or C₃. The carbon spacer may be substituted, such as, for example with an aryl, alkyl, or a covalent bond to a pendant group that includes a reactive handle. The carbon spacer does not include any heteroatoms between the amine and the carboxylic acid. The aminocarboxylic acid may be an alpha aminocarboxylic acid (C₁ spacer), a beta aminocarboxylic acid (C₂ spacer), or a gamma aminocarboxylic acid (C₃ spacer). In some embodiments, the chelation class of an affinity group or an affinity group precursor is a polyaminocarboxylic acid. A polyaminocarboxylic acid has two or more aminocarboxylic acids. In some embodiments, the chelation class of an affinity group or an affinity group precursor is an aminopolycarboxylic acid. An aminopolycarboxylic acid has an amine that is connected to two or more carboxylic acids through two or more carbon spacers. As such, aminopolycarboxylic acids are polyaminocarboxylic acids, but not every polyaminocarboxylic acid is an aminopolycarboxylic acid.

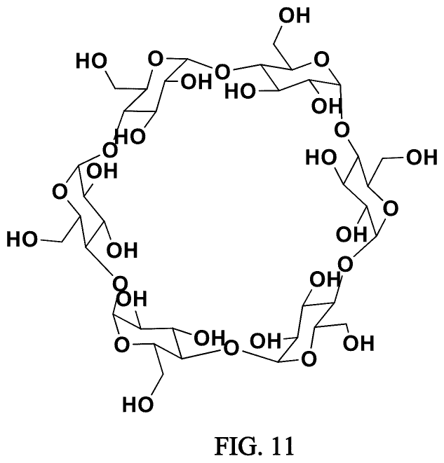

In some embodiments, the chelation class of an affinity group or an affinity group precursor is a cyclodextrin. As used herein, the term “cyclodextrin” refers to a glucose oligosaccharide where the glucose subunits are covalently joined via an α-1,4-glycosic bonds to form a macrocycle. Cyclodextrins are described by the number of glucose subunits. For example, a cyclodextrin may have six (α-cyclodextrin; α-CD; see FIG. 11), seven (β-cyclodextrin; β-CD), eight (γ-cyclodextrin), nine, or ten glucose units. Cyclodextrins may be unsubstituted or substituted. An unsubstituted cyclodextrin is a cyclodextrin where none of the hydroxyl groups of the glucose subunits are replaced with a different moiety. A substituted cyclodextrin is a cyclodextrin where one or more of the hydroxyl groups of the glucose subunits of the cyclodextrin are substituted with a different moiety. The substituent may be described as the entire group that replaces the hydroxyl or as an R group where the location of the substituent can be described as —OR or —OCH₂R where R is a moiety other than H. Example substitutions include 2-hydroxypropyl (R=—CH₂CH(OH)(CH₃)), methoxy (R=—OCH₃), acetate (—O(CO)CH³), 3,5-dimethylphenyl carbamate, and sulfobutylether (R=CH₂CH₂CH₂CH₂(SO₃)⁻). Examples of substituted cyclodextrins that may be used as an affinity group or an affinity group precursor include hydroxypropyl-β-cyclodextrin (HP-β-CD; CAS No. 128446-35-5), hydroxypropyl-γ-cyclodextrin (HP-γ-CD; CAS No. 128446-34-3), methyl-β-cyclodextrin (M-β-CD; CAS No. 128446-36-6), sulfobutylether-β-cyclodextrin (SBE-β-CD; CAS No. 182410-00-0), and 1(1-napthyl)ethyl carbamoyl-β-cyclodextrin.

The pattern of cyclodextrin substitution may vary. A single hydroxyl on the entire cyclodextrin may be substituted or two or more hydroxyls on the cyclodextrin may be substituted. In some cases where two or more hydroxyls are substituted, the two or more hydroxyls may be on the same glucose subunit, different glucose subunits, or both. When a plurality of substituted cyclodextrin compounds from the same class are used as an affinity group or affinity group precursor, the number and pattern of the substitution on each cyclodextrin in the plurality may be the same or different.

The average number of substitutions on a cyclodextrin in a plurality of cyclodextrins having the same substituent is described as the average degree of substitution. In one or more embodiments, the average degree of substitution is 1 or greater, 2 or greater, 3 or greater, 4 or greater, 5 or greater, 6 or greater, 7 or greater, 8 or greater, 9 or greater, 10 or greater, 11 or greater, 12 or greater, 13 or greater, 14 or greater, 15 or greater, 16 or greater, 17 or greater, 18 or greater, or 19 or greater. In one or more embodiments, the average degree of substitution is 20 or fewer, 19 or fewer, 18 or fewer, 17 or fewer, 16 or fewer, 15 or fewer, 14 or fewer, 13 or fewer, 12 or fewer, 11 or fewer, 10 or fewer, 9 or fewer, 8 or fewer, 7 or fewer, 6 or fewer, 5 or fewer, 3 or fewer, or 2 or fewer. In one or more embodiments, the average degree of substitution is 6 to 8.

Substituted cyclodextrins can be described by the identity of the substitution and the number of glucose subunits denoted as X-Y-cyclodextrin where X is the identity of the substitution and Y is the number of glucose subunits in the cyclodextrin. For example, a hydroxypropyl substituted cyclodextrin having seven glucose subunits can be described as hydroxypropyl-β-cyclodextrin. Additionally, the average degree of substitution may be denoted for substituted cyclodextrins using the formula (X)ₙ—Y-cyclodextrin where X is the identity of the substitution, n is the average degree of substitution, and Y is the number of glucose subunits.

Unsubstituted cyclodextrins can be denoted as unsubstituted Y-cyclodextrin where Y is the number of the glucose subunits. For example, unsubstituted β-cyclodextrin refers to a cyclodextrin having seven glucose subunits and no substitutions.

In some embodiments, the chelation class of an affinity group or an affinity group precursor is a crown ether. As used herein, the term “crown ether” refers to a cyclic compound that includes at least three independently selected heteroatom moieties where adjacent heteroatom moieties are covalently linked by an alkanediyl (divalent radical of an alkane), a substituted alkanediyl, or an alkenediyl (divalent radical of an alkene). The term “heteroatom moiety” includes heteroatoms such as O, S, and N, as well as heteroatom containing groups such as N—R where R is H or a substituent. In some embodiments, the alkanediyl may be ethanediyl (—CH₂CH₂—), propanediyl (—CH₂CH₂CH₂—), or butanediyl (—CH₂CH₂CH₂CH₂—). In some embodiments, a substituted alkanediyl may be mono-substituted, di-substituted, tri-substituted, or tetra-substituted. For example, the substituted alkanediyl may be monosubstituted ethanediyl (—CH(R′)CH₂—) or a di-substituted ethanediyl (—CH(R¹)CH(R²)—) where R¹ and R² are independently selected substituents. An example of a substituent is tartaric acid. In some embodiments, the alkenediyl may be ethenediyl. In some such embodiments, the ethenediyl may be of the formula —C(R³)C(R⁴)— where R³ and R⁴ are bonds to atoms in an aromatic group of which the two carbons are a part of. For example, in some embodiments, the crown ether may include one more benzene substituents or 1,1′-binaphthyl substituents where the ethenediyl is a part of the substituent. The substituent or aromatic group may include a reactive handle that allows for the attachment of the crown ether to the support substrate.

In some embodiments, the crown ether is an oxygen crown ether. An oxygen crown ether includes heteroatoms that are only oxygen atoms. In such cases, the oxygen crown ether can be described by the general notation X-crown-Y where X is the total number of atoms in the polyether backbone and Y is the total number of oxygen atoms in the polyether backbone. For example, 12-crown-4 refers to a crown ether having twelve atoms in the backbone of which four are oxygen atoms in the backbone (four —CH₂CH₂O— repeating groups). Examples of oxygen crown ethers include 8-crown-4 (i in FIG. 11); 15-crown-5; 18-crown-6; 21-crown-7; and substituted versions thereof where the named oxygen crown ether includes a monosubstituted ethanediyl, a di-substituted ethanediyl, or an ethenediyl. Examples of substituted oxygen crown ethers include dibenzo-18-crown-6 (ii in FIG. 11; CAS NO: 14187-32-7).

In some embodiments, the crown ether is an aza crown ether. An aza crown ether includes at least one heteroatom moiety that is an N, NH, or N—R where R is a substitute. In some embodiments, an aza crown ether can include one or more oxygen atom heteroatom moieties. In some embodiments, an aza crown ether includes only N, NH, and/or N—R heteroatom moieties. Examples of aza crown ethers include 1,4,7-trimethyl-1,4,7-triazacyclononane (CAS NO: 96556-057); cyclam (iii in FIG. 11; CAS NO: 295-37-4); 1-aza-12-crown-4-ether (CAS NO: 41775-76-2); and 1 aza-18-crown-6 (CAS NO: 33941-15-0).

In some embodiments, the aza crown ether is a cryptand. A cryptand is a bicyclic crown ether having a bridge between two non-adjacent nitrogen containing heteroatom moieties. Cryptands may be described by the general formula N[L1][L2][L3]N where L1, L2, and L3 are each bonded to each N. L1, L2, and L3 are each independently (C(R¹)(R²))₁(C(R³)(R⁴))ₙ₂(C(R⁵)(R⁶))ₙ₃(C(R⁷)(R⁸))ₙ₄(X) where R¹, R², R³, R⁴, R⁵, R⁶, R⁷, R⁸, and R⁹ are each independently H or a substituent; X is a heteroatom or heteroatom containing group; and n1, n2, n3, and n4 are each independently 0, 1, 2, 3, or 4. In some embodiments L1, L2, and L3 are the same. In other embodiments, at least two of L1, L2, and L3 are different. In some embodiments the cryptand has the formula N[CH₂CH₂OCH₂CH₂OCH₂CH₂]₃N (iv in FIG. 11; [2.2.2]cryptand; CAS NO: 23978-09-8).

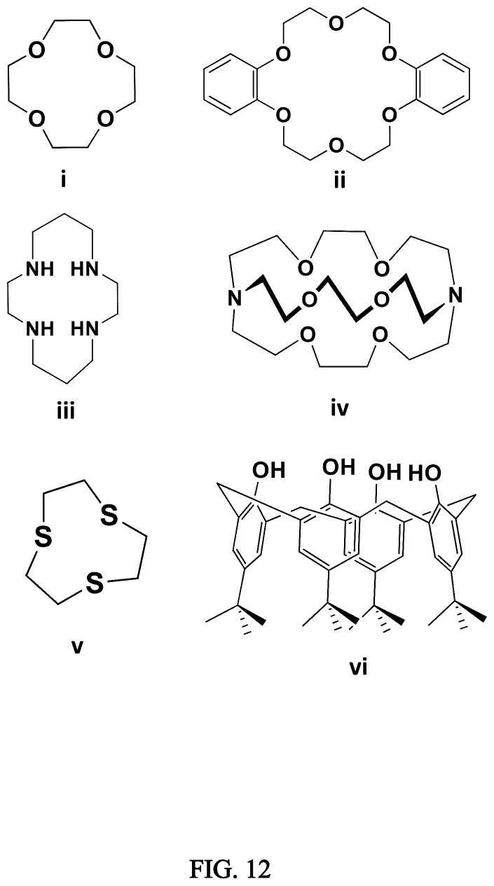

In some embodiments, the crown ether is a thia crown ether. A thia crown ether includes at least one S heteroatom moiety. In some embodiments, a thia crown ether can include one or more oxygen atom heteroatom moieties. In some embodiments, a thia crown ether includes only S heteroatom moieties. Examples of thia crown ethers include 9-ane-S3 (v in FIG. 12; CAS NO: 6573-11-1) and 14-ane-S4 (CAS NO: 24194-61-4).

In some embodiments, the chelation class of an affinity group or an affinity group precursor is a calixarene. Calixarenes are polycyclic phenol compounds of the general formula I.

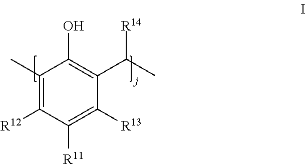

In formula I, each R¹¹, R¹², R¹³, and R¹⁴ are independently H or a substituent. The substituent may be any group, such as, for example, an alkyl, a sulfonic acid, an amide, an acid, a thiol, or an amine. An alkyl substituent group may be, for example, methyl, ethyl, n-propyl, isopropyl, n-butyl, iso-butyl, or sec-butyl. j is an integer from 3 to 20, such as, 3, 4, 5, 6, 7, 8, 9, 10, 11, 12, 13, 14, 15, 16, 17, 18, 19 or 20. Calixarenes can be described as calix[n]arene where n is the number of substituted (where at least one of R¹¹, R¹², and R¹³ is not H) or unsubstituted (R¹¹, R¹², and R¹³ are H) phenols (i.e., j in Formula I). An example calixarene is calix[4]arene with a para-tert-butyl substituent (vi in FIG. 12). Calixarenes can chelate metals through phenol OH group. Calixarenes may be used to bind a variety of metals including, but not limited to, cadmium, lead, lanthanides, and actinides.

In some embodiments, the chelation class of an affinity group or an affinity group precursor is a calix[n]furane, a calix[n]pyridine, or a thiacalix[n]arene where n is the number of substituted or unsubstituted furans, substituted or substituted pyridines, or substituted or unsubstituted phenols. A calix[n]furane is a calixarene where phenols are replaced with furane rings (the methylene spacer may be ortho to the oxygen of the furane ring). A calix[n]pyridine is a calixarene but the phenols are replaced with pyridine (the methylene spacer may be ortho to the nitrogen of the pyridine ring). A thiacalix[n]arene is a calixarene where the methylene spacer is replaced by a sulfur atom. The sulfur atom may participate in metal chelation.

For simplicity, the identity of an affinity group or a portion of an affinity group may be from the perspective of the compound used to form the affinity group. For example, if an affinity group is formed from the reaction of one of the carboxylic acids of iminodiacetic acid with a second component, the affinity group is said to include iminodiacetic acid or said to be an iminodiacetic acid affinity group. Additionally, stated compounds used to form affinity groups include derivatized forms of such compounds in which an atom of the stated compound is replaced by or includes a covalent bond to a reactive handle or to a pendant group that includes a reactive handle. The pendant group extends from the core structure of the stated compound. For example, iminodiacetic acid may be modified to include a covalent bond to a reactive handle or to a pendant group that includes a reactive handle. An affinity group formed from the derivatized iminodiacetic acid can still be said to include iminodiacetic acid; that is, the affinity group is an iminodiacetic acid affinity group.

Table 1 shows examples of compounds that may be used to bind a metal, the chemical abstract services number (CAS NO.) of the compound, examples of specific metals the compound may chelate, the chelation class, and the types and numbers of donor groups. When a CAS NO. is given, the CAS NO. may refer to the compound alone or the compound in chelation with a specific metal. In such cases where the CAS NO. refers to a compound in chelation with a specific metal, it is understood that the identity of the metal may change. Though specific metals or groups of metals are listed for each compound, it is understood that the compound may bind other metals.

TABLE 1

| | CAS | Metals it can | Chelation | |
|---|---|---|---|---|
| Compound Name | NO. | chelate | Classification Group | Donor Groups |
| deferasirox | 201530- | Fe | | 1 carboxylic acid, 2 |
| | 41-8 | | | alcohols |
| trientine | 38260- | Pb, Mg, Cu | diamine | 4 amines |
| | 01-4 | | | |
| deferiprone | 30652- | Fe | | 1 ketone, 1 alcohol |
| | 11-0 | | | |
| deferoxamine | 70-51-9 | Fe | oxamine | 1 amine, 3 |
| | | | | oxamines, 5 amides |
| dimercaptosuccinic | 304-55-2 | Pb, Hg, As, | dithiol | 2 carboxylic acids, 2 |
| acid (DMSA) | | Tc | | thiols |
| dimercaprol (BAL) | 59-52-9 | As, Hg, Au, | dithiol | 1 alcohol, 2 thiols |
| | | Pb, Sb, Tl, Bi | | |
| 2,3-dimercapto-1- | 74-61-3 | As, Hg, Au, | dithiol | 1 sulfate, 2 thiols |
| propanesulfonic acid | | Pb, Sb, Tl, Bi | | |
| (DMPS) | | | | |
| monoisoamyl 2,3- | 141056- | As, Pb, Hg, | dithiol | 2 thiols, 1 ester, 1 |
| dimercaptosuccinic | 24-8 | Cd, Ga | | carboxylic acid |
| acid (MiADMSA) | | | | |
| monomethyl 2,3- | | As, Pb, Hg, | dithiol | |
| dimercaptosuccinic | | Cd, Ga | | |
| acid (MmDMSA) | | | | |
| monocyclohexyl 2,3- | | As, Pb, Hg, | dithiol | |
| dimercaptosuccinic | | Cd, Ga | | |
| acid (MchDMSA) | | | | |
| D-penicillamine | 52-67-5 | Cu, As | | 1 thiol, 1 amine, 1 |
| | | | | carboxylic acid |
| pyrrolidine | 25769- | Zn, Cd, Fe | dithiocarbamate | 1 dithiocarbamate |
| dithiocarbamate | 03-3 | | | |
| (PDTC) | | | | |
| dimethyldithiocarbamate | 128-04-1 | Zn | dithiocarbamate | 1 dithiocarbamate |
| ethylene-1,2- | 12427- | Mn, Zn | ethylene | 2 dithiocarbamates, |
| bisdithiocarbamate | 38-2 | | bis(dithiocarbamate) | 2 amines |
| (MANEB) | | | | |
| propylenebis(dithiocarbamic) | 35449- | Zn | ethylene | 2 dithiocarbamates |
| (PROPINEB) | 52-6 | | bis(dithiocarbamate) | |
| ethane-1,2- | 12122- | Zn | ethylene | 2 dithiocarbamates |
| diylbis(dithiocarbamate) | 67-7 | | bis(dithiocarbamate) | |
| (ZINEB) | | | | |
| iminodiacetic acid | 142-73-4 | Tc, Ni | polyaminocarboxylic | 2 carboxylic acids, 1 |
| (IDA) | | | acid/ | amine |
| | | | aminopolycarboxylic | |
| | | | acid | |
| nitriotriacetic acid | 139-13-9 | Ni, Co, Cr, | polyaminocarboxylic | 3 carboxylic acids, 1 |
| (NTA) | | Cu, As, | acid/ | amine |
| | | | aminopolycarboxylic | |
| | | | acid | |
| ethylenediaminetetraacetic | 600-00-4 | Fe, Hg, CU, | polyaminocarboxylic | 4 carboxylic acids, 2 |
| acid (EDTA) | | Pb, Zn, Cd, | acid/ | amines |
| | | Al, Fe, Ca, | aminopolycarboxylic | |
| | | Mg, Na, K; | acid | |
| | | lanthanides; | | |
| | | Cr; Cd | | |
| 1,2-bis(o- | 85233- | Ca | polyaminocarboxylic | 4 carboxylic acid, 2 |
| aminophenoxy)ethane- | 19-8 | | acid/ | ethers |
| N,N,N′,N′-tetraacetic | | | aminopolycarboxylic | |
| acid (BAPTA) | | | acid | |
| 1,4,7- | 56491- | commonly | polyaminocarboxylic | 4 carboxylic acids, 3 |
| triazacyclononane- | 86-2 | used for | acid | amines |
| 1,4,7-triacetic acid | | radio labeled | | |
| (NOTA) | | atom | | |
| 2,2′,2″,2″-(1,4,7,10- | 60239- | Gd, Y, Ca, | polyaminocarboxylic | 4 carboxylic acids, 4 |
| tetraazacyclododecane- | 18-1 | Fe, | acid | amines |
| 1,4,7,10- | | lanthanides | | |
| tetrayl)tetraacetic acid | | | | |
| (DOTA) | | | | |
| 2-[6- | 96314- | Ca | polyaminocarboxylic | 5 carboxylic acids, 2 |
| [bis(carboxymethyl)amino]- | 98-6 | | acid/ | ethers, 2 amines |
| 5-[2-[2- | | | aminopolycarboxylic | |
| [bis(carboxymethyl)amino]- | | | acid | |
| 5-methylphenoxy]ethoxy]- | | | | |
| 2-benzofuranyl]-5- | | | | |
| oxazolecarboxylic acid | | | | |
| (Fura-2) | | | | |
| diethylenetriaminepent | 67-43-6 | Th, U, Np, | polyaminocarboxylic | 5 carboxylic acids, 3 |
| aacetic acid (DTPA) | | Am, Ce, Fe, | acid/ | amines |
| | | Gd, actinides | aminopolycarboxylic | |
| | | | acid | |
| 3,12- | 67-42-5 | Mg, Ca, Ce | polyaminocarboxylic | 4 carboxylic acids, 2 |
| bis(carboxymethyl)- | | | acid/ | amines, 2 ethers |
| 6,9-dioxa-3,12- | | | aminopolycarboxylic | |
| diazatetradecane-1,14- | | | acid | |
| dioic acid (EGTA) | | | | |
| nicotianamine | 34441- | Fe | polyaminocarboxylic | 3 carboxylic acids, 2 |
| | 14-0 | | acid | amines |
| thylenediamine-N,N′- | 1170-02- | Fe, Pb | polyaminocarboxylic | 2 carboxylic acids, 2 |
| bis(2-hydroxyphenylacetic | 1 | | acid | alcohols, 2 amines |
| acid (EDDHA) | | | | |
| ethylenediamine-N,N′- | 20846- | Fe | polyaminocarboxylic | 4 carboxylic acids, 2 |
| disuccinic acid (EDDS) | 91-7 | | acid | amines |

In some embodiments, the affinity group and/or affinity group precursor includes any one of the compounds in Table 1 or a derivatized from thereof. A derivatized form of an affinity group is the stated affinity group is derived from an affinity group precursor of the stated affinity group that is functionalized with a direct covalent bond to a reactive handle and/or a pendant group that includes a linker and a reactive handle, the linker separating and linking the stated affinity group to the reactive handle.

In some embodiments, the affinity group is capable of binding an enantiomer of a chiral compound. For example, in some embodiments, the affinity group is capable of distinguishing and binding to one enantiomer of a pair of enantiomers with a higher affinity than the other enantiomer of the pair of enantiomers allowing for chiral separations. Affinity groups that may be capable of binding an enantiomer of a chiral compound include macrocyclic compounds such as cyclodextrins, calixarenes, and crown ethers; chiral biological molecules; chiral polymers; helical polymers; and macrocyclic antibiotics.

In some embodiments where the affinity group is capable of binding an enantiomer of a chiral compound, the affinity group includes a cyclodextrin, a calixarene, a crown ether, or any combination thereof. The cyclodextrin, calixarene, or crown ether may be, for example, any of those described herein.

In some embodiments, the affinity group includes a chiral biological molecule. Examples of chiral biological molecules include peptides and polysaccharides. In some embodiments, the affinity group includes a polysaccharide. In some embodiments, the affinity group includes a polysaccharide such as amylose, cellulose, fructan, chitosan, alginic acid, salts thereof, or any combination thereof. The polysaccharide may be substituted or unsubstituted. For example, one or more of the hydroxyl groups on a polysaccharide may be substituted or replaced with a carbamate, an ester, or both. Examples of carbamates that be used to replace one or more hydroxyls on a polysaccharide include 3,-5-dimethyl phenyl carbamate; methyl benzyl carbamate; 3-chlorophenyl carbamate; 3-chloro-4-methyphenylcarbamate; 5-chloro-2-methylphenylcarbamatel; and any combination thereof. An example of an ester that may be used to replace one or more hydroxyls on a polysaccharide is methyl benzoate.

In some embodiments, the affinity group includes a peptide. In some embodiments, the affinity group includes albumin (e.g., human serum albumin and bovine serum albumin), alpha-1-acid glycoprotein, ovomucoid, cellobiohydrolase I, or any combination thereof. In some embodiments, the peptide is a glycopeptide; that is, a peptide that includes one or more saccharides substituents. Examples of glycopeptides that may be employed as affinity groups include vancomycin, teicoplanin, and ristocetin.

In some embodiments, the affinity group includes a chiral polymer. A chiral polymer is a polymer that includes a plurality of stereocenters. Chiral polymers can be formed from a monomer that has one or more stereocenters where upon formation of the polymer at least one stereocenter is maintained. Chiral polymers may be homopolymers or be the polymerization reaction product between two or more different monomers. Examples of chiral polymers include polymethylglutamate and (S)—N-(1-phenylethyl) acrylamide.

In some embodiments, the affinity group includes a helical polymer. A helical polymer is a polymer that folds into a left-handed or right handed helix. Helical polymers may be biological helical polymers; that is, the polymer itself is found in nature or the monomers of the polymer are found in nature. An example of a biological helical polymer is a double stranded deoxyribonucleic acid (DNA). In some embodiments, the affinity group includes double stranded DNA. Another example of a biological helical polymer are peptides that fold into alpha-helix secondary structures. In some embodiments, the affinity group includes a peptide that includes an alpha-helix secondary structure. Helical polymers may be synthetic or polymers engineered to form a helix.

In some embodiments, the affinity group includes a macrocyclic antibiotic. A macrocyclic antibiotic is a compound that includes a cycle of 10 or more atoms and displays antibiotic properties. Examples of macrocyclic antibiotics that may be employed as an affinity group include vancomycin, teicoplanin, ristocetin, thiostrpton, rifamycin B, rifamycin SV, fradiomycin, kanalycin, streptomycin, and any combination thereof.

In some embodiments, the separation media includes a plurality of separation ligands that include a separation group that is an assistance group. An assistance group is a chemical moiety that facilitates the binding of the target to the affinity group; binds the target through electrostatic interactions and/or hydrophobic interactions; or both. In some embodiments, the assistance group may allow for a high density of target molecules to bind to separation ligands that include an affinity group. In some embodiments, the assistance group may aid in attracting the target to the support substrate such as to allow for the target to be in proximity to a separation group that includes an affinity group. For example, the assistance group may be ionizable or possess a formal charge which may be opposite the charge of the target molecule. In such cases, the oppositely charged assistance group may attract the target to the support substrate which may allow the target to bind to the affinity group.

In some embodiments, the assistance group functions as a cation or anion exchange chromatography ligand. Anion exchange ligands have a positively charged functional group that targets negatively charged target molecules through electrostatic interactions. The anion exchange ligand may possess a formal positive charge, or the positive charge can be induced through the pH of the solution that the anion exchange ligand is exposed to. Cation exchange ligands have a positively charged functional group that target negatively charged target molecules through electrostatic interactions. The cation exchange ligand may possess a formal negative charge, or the negative charge can be induced through the pH of the solution that the cation exchange ligand is exposed to.

In some embodiments, the assistance group possesses a positive formal charge or is ionizable under certain pH conditions to have a positive charge. Such assistance groups may be beneficial when the target has a negative formal charge. Examples of such assistance groups include primary, secondary, tertiary, and quaternary amines. Suitable amines may be diamines, triamines, and polyamines.

Examples of primary amines include methylene diamine, ethylene diamine, propylene diamine, butylenediamine (putrescine), pentylamine, or any aliphatic diamine with 1-18 carbons between the terminal amines, covalently attached to the support substrate via one of the amines. Such ligands can be made from polyamines such as ethylene diamine, diethylenetriamine, triethylenetetramine covalently attached via one of the amines.

Examples of secondary amines can include any of the aforementioned primary amines immobilized to the substrate, substituted with an additional R-group as described above. In cases in which diamines are used, secondary amines may also be formed by covalent interaction with the substrate coupling both amines to the substrate. Ligands containing secondary amines with the structure of the ligand may also be immobilized such as linear polyethyleneimine, spermidine, or spermine. Furthermore, groups containing a non-terminal primary amine (e.g., 3-aminopentane) may also be conjugated to the substrate to result in a secondary amine.

Examples of suitable tertiary amines include N,N-dimethylethylenediamine; N,N-dimethylpropylenediamine; N,N-diethylpropylenediamine; or any aliphatic diamine with aliphatic carbon group substitution on one or both amines ranging from one to six carbons, with a linker having 2-18 carbons between the terminal amines.

Examples of quaternary amines include any of the aforementioned primary amines that have undergone a quaternarization reaction resulting in a permanent positive charge. Such reactions can be performed with alkyl groups such as methyl iodide or aryl groups such as benzyl iodide. Quaternary amines can further include any of the aforementioned tertiary amines that have undergone a quaternarization reaction resulting in a permanent positive charge. Such reactions can be described by the Menshutkin reaction which uses an alkyl halide to form a quaternary ammonium salt from a reaction with a tertiary amine. Such reactions can be performed with alkyl containing groups of varying length such as butyl bromide or aryl groups such as benzyl chloride or combinations therein. Additionally, compounds containing quaternary amines can be immobilized on the support substrate directly.

In other embodiments, the assistance group possesses a negative formal charge or is ionizable under certain pH conditions to have a negative charge. Such assistance group may be beneficial when the target has a positive formal charge. The difference in charge of target and the assistance molecule may allow for an electrostatic interaction between the target and the assistance group thereby allowing the target to be proximate to the support surface and the affinity groups which may increase the probability of the target of binding to an affinity group.

In some embodiments, the assistance group is such that it is able to induce hydrophobic interactions with the target molecules. Hydrophobic interactions exploit the differences in hydrophobicity between the target molecules and possible impurities in the isolation solution. In one embodiment, such ligands include aliphatic chains with three carbons or longer (common used lengths include butyl, pentyl, hexyl, heptyl, octyl, nonyl, decyl, undecyl, and dodecyl), benzyl, phenyl, phenol, pyridine, boronic acid groups, branched polymers such as polypropylene glycol, and sulfur-containing thiophilic ligands such as propanethiol, 2-butanethiol, 3,6-dioxa-1,8-octanedithiol, octanethiol, benzyl mercaptan, 2-mercaptopyridine, thiophenol, 1,2-ethanedithiol, 1,4-benzenedimethanethiol, 2-phenylethanethiol, and the like, and any combination thereof.

In some embodiments, separation ligands that include an assistance group can be directly incorporated into a functionalized layer of a support substrate through polymerization of a monomer that includes an assistance group.

In some embodiments, the separation media includes a plurality of separation ligands that includes a separation group that is a capping group. A capping group is a chemical moiety that prevents reactive groups of the support membrane from reacting with the target or any other molecule in the isolation solution. A capping group may be employed to block support substrate reactive handles that have not reacted with other separation ligands. A capping group may be used to cap the end of a polymer chain. Capping groups may be any chemical group that is non-reactive towards the target or other molecules in the isolation solution.

In some embodiments, a separation ligand immobilized on a support substrate has the formula (SLim)

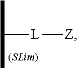

where L is a linker, Z is a separation group, and the vertical black line is the support substrate.

Each separation ligand of the plurality of separation ligands has the formula SL

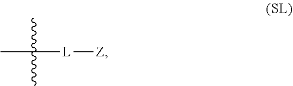

where L is a linker and Z is a separation group. L separates the support substrate from Z. The separation group may include an affinity group, an assistance group, capping group, or assistance group. The affinity group may be any affinity group as disclosed herein. The assistance group may be any assistance group as disclosed herein. The capping group may be any capping group as disclosed herein. The assistance group may be any capping group as disclosed herein.

Separation ligands of multiple chemical compositions may be immobilized to a single support substrate. For example, a support substrate may include a first portion of a separation ligands of formula -L-Z and a second portion of separation ligands of formula -L-Z. In some embodiments, the first portion and the second portion of separation ligands include the same separation group (Z) but have different linkers (L). In other embodiments, the first portion and the second portion of the separation ligands may have the same linker (L) but have different separation groups.

In some embodiments, L is of formula L1 such that the separation ligand of formula SL is of formula SL1.

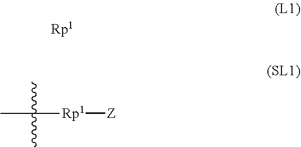

where Rp¹ is a reaction product, and Z is the separation group. A reaction product is the chemical group resulting from the reaction of two cooperative functional handles (as discussed herein). In a separation ligand of formula SL1, the linker is the reaction product. The reaction product Rp¹ links the support substrate (not shown) and the separation group (Z). A covalent bond from Rp¹ to the support substrate is the point of covalent attachment of the linker (L1) to the support substrate. A covalent bond from Rp¹ to the separation group (Z) is the point of covalent attachment of the linker (L1) to the separation group (Z). Rp¹ may be any reaction product as disclosed herein.

The reaction product (Rp¹) may be the reaction product between any two cooperative reactive handles (as described herein). Examples of reaction products include amides, ureas, thioureas, carbamates, carbonates, esters, thioethers, ethers, and triazoles. In some embodiments, a reaction product (e.g., such as Rp¹) is Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, Rp^{M} or an isomer thereof.

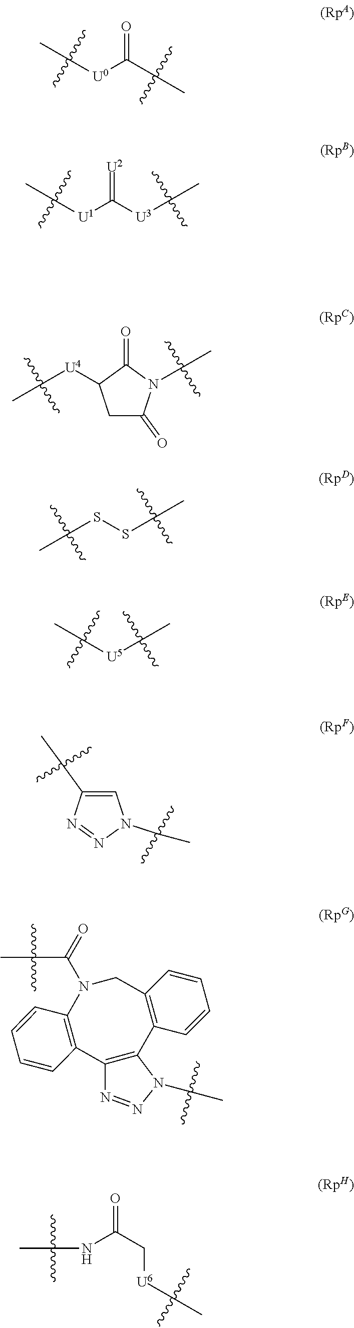

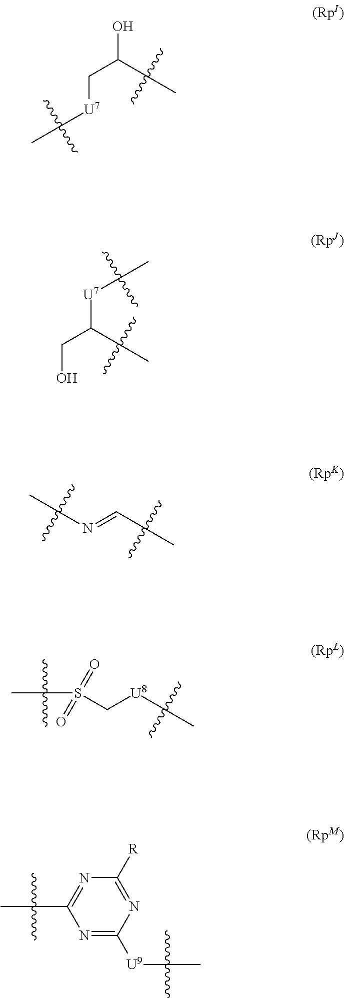

U⁰, U⁴, U⁵, U⁶, U⁷, U⁸ and U⁹ (found in Rp^{A}, Rp^{C}, Rp^{E}, Rp^{H}, Rp^{I}, Rp^{L}, Rp^{K}, and Rp^{M}) respectively) are independently NH, N, O, or S. For Rp^{B} each of U¹, U², and U³ are independently NH, N, O, or S. R in Rp^{M} may be H, an organic group, or a halogen. The reaction products have two connection points, each of which may be covalently linked to the support substrate or any component of a separation ligand. For separation ligands of formula SL1, one connection point the reaction product Rp¹ is linked to the separation group while the other connection point of the reaction product Rp¹ is linked to the support substrate.

In some embodiments, the reaction product does not include an imine. For example, in some embodiments, the reaction product does not include Rp^{K}. In some embodiments when the affinity group includes an ether, a cyclodextrin, or a calixarene, the reaction product does not include an imine. State differently, in some embodiments, a separation ligand that includes a crown ether, a cyclodextrin, or a calixarene does not include an imine.

In some embodiments, the separation media does not include immobilized silicon atoms. For example, in some embodiments, the separation media does not include a covalent bond from the support substrate to a silicon atom, a covalent bond from a separation ligand to a silicon atom, or a silicon atom within a separation ligand. In embodiments where the separation media does not include immobilized silicon atoms, the separation membrane was formed without using reagents that includes a silicon group (e.g., an aminosilane).

In some embodiments where the separation ligand is of formula SL1, Rp¹ is Rp^{A} where U⁰ is NH. In some such embodiments, the amide nitrogen (U⁰) of Rp^{A} is covalently linked to the separation group. In other such embodiments, the amide nitrogen of Rp^{A} is covalently linked to the support substrate.

In some embodiments where the separation ligand is of formula SL1, Rp¹ is Rp^{A} where U⁰ is O. In some such embodiments, the ester oxygen (U⁰) of Rp^{A} is covalently linked to the separation group. In other such embodiments, the ester oxygen of Rp^{A} is covalently linked to the support substrate.

In some embodiments where the separation ligand is of formula SL1, Rp¹ is Rp^{L} where U⁸ is O. In some such embodiments, oxygen is covalently linked to the separation group. In other such embodiments, the oxygen is covalently linked to the support substrate.

In some embodiments where the separation ligand is of formula SL1, Rp¹ is Rp^{M} where U⁹ is O and R is a halogen. In some such embodiments, the oxygen is covalently linked to the separation group. In other such embodiments, the oxygen is covalently linked to the support substrate.

The identity of a reaction product (e.g., Rp¹) depends at least in part on the type of conjugation chemistry used to form the reaction product. In a conjugation reaction, each component being linked together includes a reactive handle, such that the reactive handles are cooperative reactive handles. Components that include a reactive handle for conjugation reactions are termed precursor compounds or precursors. A precursor compound includes the component and a reactive handle covalently linked to the component. Cooperative handles or cooperative reactive handles are two or more reactive handles that when exposed to each other under favorable reaction conditions a conjugation reaction occurs to form a reaction product between the reactive handles. Components that have been conjugated through a conjugation reaction may be referred to as a conjugate. For example, component A and component B are to be conjugated through a conjugation reaction. The component A precursor includes a reactive handle X. The component B precursor includes a reactive handle Y. X and Y are cooperative. A conjugation reaction between the component A precursor and the component B precursor results in the formation of an A-B conjugate that includes the reaction product between X and Y. It is understood that the notation of a conjugate is from the perspective of the conjugated components, not the precursors of those components (i.e., A-B conjugate not A precursor-B precursor conjugate). This is because upon completion of the conjugation reaction, the precursor components are no longer precursors. In the case of a component precursor that includes two independently reactive handles, one of which has been reacted with a different component precursor to form a conjugate, the conjugate notation is still from the perspective of the conjugated components, not the precursor components, with the understanding that the conjugate includes the unreacted second reactive handle. For example, a component D precursor includes a first reactive handle J and a second reactive handle Z. The component B precursor has the reactive handle Y. J and Y are cooperative handles. A conjugation reaction between the component A precursor and the component B precursor results in the formation of an A-B conjugate that includes the reaction product between J and Y. The A-B conjugate also includes the unreacted second reactive handle Z.

Any pair of cooperative reactive handles may be used to form a reaction product of the present disclosure. Examples of cooperative handles include an activated ester and an amine; an amine and an NHS-ester; a hydroxyl and an NHS-ester; a hydroxyl and an epoxide; an acyl chloride and an amine; and acyl chloride and a alcohol; an amine and an epoxide; a thiol and an epoxide; a thiol and a maleimide; a disulfide and a thiol; an azide and an alkyne (azide and a linear alkyne in the presence of Cu(I); an azide and a cyclic alkyne such as cyclooctyne, difluorinated cyclooctyne, dibenzocyclooctyne, TMTH-Sulfoxlmine, biarylazacyclooctynone, or bicyclo[6.1.0]nonyne); an amine and an isocyanate; an amine and an isothiocyanate, a amine and a benzoyl fluoride; a thiol and a Iodoacetamide; a thiol and a bromoacetamide; a disulfide and 2-thiopyridine; a thiol and 3-arylpropiolonitirle; a phenol and a diazonium salt; a phenol and 4-phenyl-1,2,4-triazoline-3,5-dione; a phenol, an aldehyde, and a aniline; a hydroxyl and sodium periodate; a thiol and an iodoacetamide; an amine and a pyridoxal phosphate; an azide and a functionalized triphenyl phosphine; a tetrazine and a strained alkene; a vinyl sulfone and a hydroxyl; a halotriazine (e.g., dichlorotriazine) and a hydroxyl; and the like.

Examples of individual reactive handles that may be used to form the separation media of the present disclosure include Rh^{A} (hydroxyl), Rh^{B} (thiol), Rh^{C} (amine), Rh^{D} (activated ester), Rh^{E} (azide), Rh^{F} (alkyne), Rh^{G} (NHS-ester), Rh^{H} (maleimide), Rh^{I} (where X is a Cl, Br, or I leaving group attached to carbon that can undergo nucleophilic substitution; e.g., a bromoacetamide or iodoacetamide), Rh^{J} (cyclooctyne), Rh^{K} (isocyanate), Rh^{L} (isothiocyanate), Rh^{M} (where X is a Cl, Br, or I leaving group attached to carbon that can undergo nucleophilic substitution), Rh^{N} (an epoxide), Rh^{O}(an acyl chloride), Rh^{P} (aldehyde), R^{Q} (halotriazine where X is Cl, I, or Br and R is an organic group, H or a halogen), Rh^{R} (vinyl sulfone), and isomers thereof. Chemical structures of Rh^{A}—Rh^{R} are depicted below.

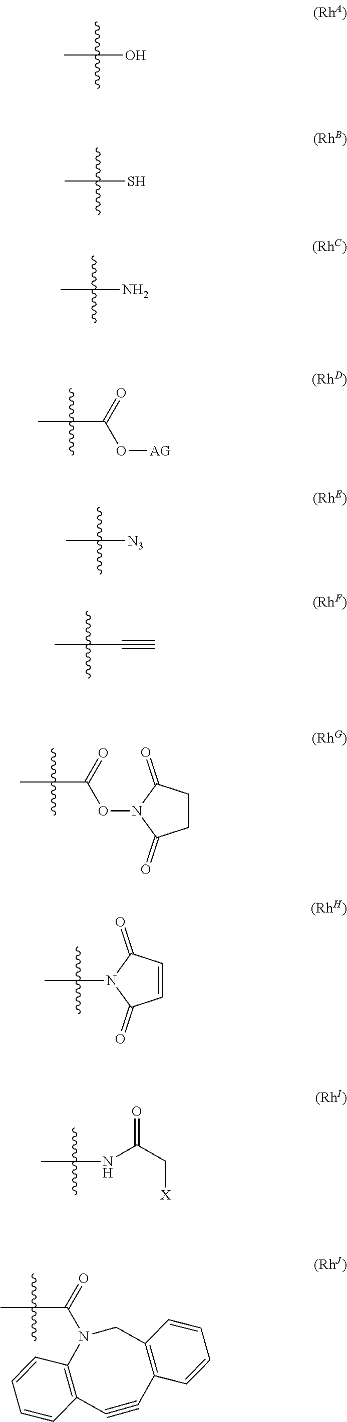

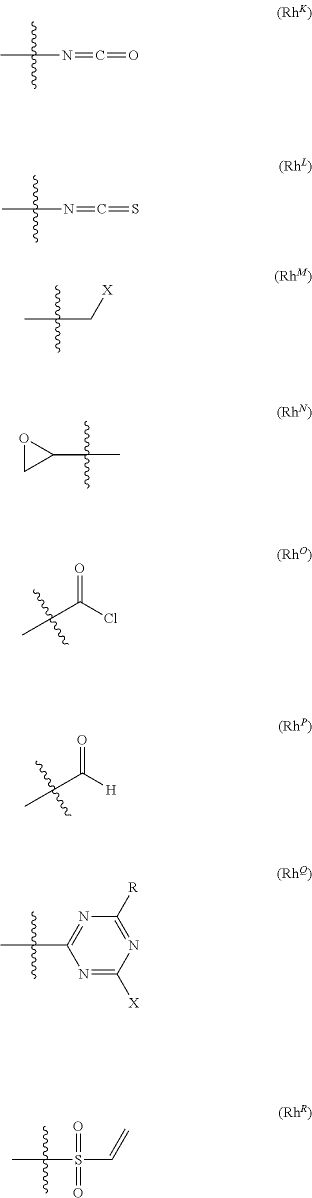

X in RhM and RhI may be -chloro, -bromo, or -iodo.

Rh^{D} is an activated ester where AG is an activating group. An activated ester is an ester that is reactive with an activated ester cooperative reaction handle (e.g., an amide) in a conjugation reaction. Activated esters may be denoted as the type of activated ester or by the activating group. Examples of activating groups include O-acylisoureas, benzotriazoles (with a bond between the ester oxygen and one nitrogen of the triazole), pentafluorophenyl, and tetrafluorophenyl. In some embodiments, Rh^{D} may be an activated ester of a carboxylic acid. In such embodiments, the activated ester is formed through the reaction of a carboxylic acid with one or more reagents that install the activating group. For example, a carboxylic acid may be converted into an activated ester having a O-acylisoureas activating group by treating the carboxylic acid with various carbodiimide reagents (e.g., N,N′-dicyclohexylcarbodiimide, 1-ethyl-3-(3 dimethylaminopropyl)carbodiimide, diisopropylcarbodiimide (DIC)) under favorable reaction conditions. A carboxylic acid may be converted into an activated ester having a benzotriazole activating group by treating the carboxylic acid with various carbodiimide reagents followed by treatment with hydroxybenzotriazole (HOBT) or by treating the carboxylic acid with various benzotriazole containing compounds (e.g., O-(benzotriazol-1-yl)-N,N,N′,N′-tetramethyluronium hexafluorophosphate (HBTU); O-(benzotriazol-1-yl)-N,N,N′,N′-tetramethyluronium tetrafluoroborate (TBTU); 2-(1H-enzotriazol-1-yl)-1,1,3,3-tetramethyluronium hexafluorophosphate (HBTU); benzotriazol-1-yloxy)tris(dimethylanino)phosphoniun hexafluorophosphate (BOP); (benzotriazol-1-yloxy)tripyrrolidinophosphonium hexafluorophosphate (PyBOP); and O-(7-azabenzotriazol-1-yl)-N,N,N′,N′-tetramethyluronium tetrafluoroborate (TA TU) under favorable reaction conditions. Other reagents are available for making activated esters from carboxylic acids including brornotripyrrolidinophosphoniuim hexafluorophosphate (PyBrOP); O—(N-succinimidyl)-1,1,3,3-tetramethyl-uronium tetrafluoroborate (TSTU); O-(5-norbornene-2,3-dicarboximido)-N,N,N′,N′-tetramethyluronium tetrafluoroborate (TNTU); O-(1,2-dihydro-2-oxo-1-pyridyl-N,N,N′,N′-tetranethyluroniumi tetrafiuoroborate (IPTU); and 3-(diethylphosphoryloxy)-1,2,3-benzotriazin-4(3H)-one (DEPBT); carbonyldiimidazole. In some emabodiiments, the activated ester may be created in situ from a carboxylic acid and not isolated prior to a conjugation reaction.

Rh^{O} is an acyl chloride. Acyl chlorides may be prepared from carboxylic acids, for example, using thionyl chloride. Acyl chlorides may not be stable and as such, may be prepared in situ and not isolated prior to a conjugation reaction.

Reactive handles Rh^{A}, Rh^{B}, Rh^{C}, Rh^{D}, Rh^{E}, Rh^{F}, Rh^{G}, Rh^{H}, Rh^{I}, Rh^{J}, Rh^{K}, Rh^{L}, Rh^{M}, Rh^{N}, Rh^{O}, Rh^{P}, Rh^{Q}, and Rh^{R} include various pairs of cooperative handles that can form the reaction products of Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L} and Rp^{M}. For example, under favorable reaction conditions, a conjugation reaction between Rh^{A} and Rh^{D} forms Rp^{A} where U⁰ is O. Under favorable reaction conditions, a conjugation reaction between Rh^{D} and Rh^{C} forms Rp^{A} where U⁰ is NH. Under favorable reaction conditions, a conjugation reaction between Rh^{C} and Rh^{G} forms Rp^{A} where U⁰ is NH. Under favorable reaction conditions, a conjugation reaction between Rh^{B} and Rh^{H} forms Rp^{C} where U⁴ is S. Under favorable reaction conditions, a conjugation reaction between two Rh^{B} forms Rp^{D}. Under favorable reaction conditions, a conjugation reaction between Rh^{C} and Rh^{I} forms Rp^{H} where U⁶ is NH. Under favorable reaction conditions, a conjugation reaction between Rh^{B} and Rh^{I} forms Rp^{H} where U⁶ is S. Under favorable reaction conditions, a conjugation reaction between Rh^{M} and Rh^{B} forms Rp^{E} where U⁵ is S. Under favorable reaction conditions, a conjugation reaction between Rh^{M} and Rh^{C} forms Rp^{E} where U⁵ is NH. Under favorable reaction conditions, a conjugation reaction between Rh^{K} and Rh^{C} forms Rp^{B} where U¹ and U³ are NH and U² is O. Under favorable reaction conditions, a conjugation reaction between Rh^{L} and Rh^{C} forms Rp^{B} where U¹ and U³ are NH and U² is S. Under favorable reaction conditions, a conjugation reaction between Rh^{F} and Rh^{E} forms Rp^{F}. Under favorable reaction conditions, a conjugation reaction between Rh^{J} and Rh^{E} forms Rp^{G}. Under favorable reaction conditions, a conjugation reaction between Rh^{N} and Rh^{A} forms Rp^{I} or Rp^{J} where U⁷ is O. Under favorable reaction conditions, a conjugation reaction between Rh^{N} and Rh^{B} forms Rp^{I} or Rp^{J} where U⁷ is S. Under favorable reaction conditions, a conjugation reaction between Rh^{N} and Rh^{C} forms Rp^{I} or Rp^{J} where U⁷ is N. Under favorable reaction conditions, a conjugation reaction between Rh^{O} and Rh^{A} forms Rp^{A} where U⁰ is O. Under favorable reaction conditions, a conjugation reaction between Rh^{O} and Rh^{B} forms Rp^{A} where U⁰ is NH. Under favorable reaction conditions, a conjugation reaction between Rh^{P} and Rh^{C} forms Rp^{K}. Under favorable reaction conditions, a conjugation reaction between Rh^{A} and Rh^{Q} forms Rp^{M} where U⁹ is O. Under favorable reaction conditions, a conjugation reaction between Rh^{A} and Rh^{R} forms Rp^{L} where U⁹ is O.

Conjugation reactions between cooperative handles may be done under favorable reaction conditions. Favorable reaction conditions are conditions that facilitate a reaction, increase the yield of a reaction, minimize unwanted biproducts of a reaction, and/or increase the rate of a reaction. Example reaction conditions include reaction temperature, reaction atmosphere composition, reaction solvent, the presence of a catalyst, the presence of a base, the presence of an acid, and any combination thereof. Favorable reaction conditions for conjugation reactions are known.

Cooperative handles may be chosen such that the conjugation reaction is an orthogonal conjugation reaction. Orthogonal conjugation reactions are reactions where the chemistry is selective such that only two cooperative handles react to form a reaction product even when additional reactive handles or pairs of cooperative reactive handles may be present. Orthogonal conjugation reactions may be useful because they allow for multiple selective conjugation reactions to take place in series or in parallel. Orthogonality of two or more conjugation reactions may be achieved by choosing reactive handles that are only reactive with their cooperative counterpart in the presence of other cooperative reactive handle pairs. Orthogonality of two or more conjugation reactions may also be achieved by using reactive handles that are reactive with multiple cooperative counterparts, but the reactivity can be influenced through the reaction conditions such that only a specific pair of cooperative handles will react in the given set of reaction conditions.

To form a separation ligand of formula SL1, conjugation reaction precursor compounds are employed, each precursor compound having a reactive handle that is cooperative with the reactive handle of a different precursor compound. In some embodiments, a separation ligand of formula SL1 is formed through the conjugation of a separation group precursor of formula Pre-Z(1) and a support substrate precursor of formula Pre-M(1) by way of synthetic scheme S1. The support substrate precursor includes a reactive handle Rh¹ that is covalently attached to the support substrate (shown as a thick black vertical line). The separation group precursor includes the separation group (Z) of formula SL1 and a separation group reactive handle Rh². Rh¹ and Rh² are cooperative reactive handles and may be any pair of cooperative reactive handles as disclosed herein. In scheme S1, the support substrate reactive handle (Rh¹) is reacted with the separation group reactive handle (Rh²) to from a reaction product (Rp¹) thereby forming a separation ligand of formula SL1.

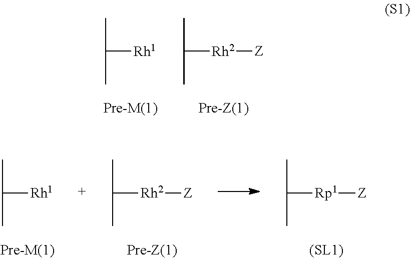

In some embodiments the material of the support substrate does not include a reactive handle that is cooperative with the separation group reactive handle (Rh²). In such embodiments, scheme S1 may further include installing the support substrate reactive handle Rh¹. The support substrate reactive handle Rh¹ may be installed through treatment of the support substrate to form the Rh¹. In such embodiments, a chemical functionality already present on the support substrate is transformed into the support substrate reactive handle. For example, the support substrate may be exposed to an oxidizing or reducing reagent (or conditions). The support substrate reactive handle Rh¹ may be installed through the installation of a functionalized layer. In such embodiments, the functionalized layer is considered a part of the support substrate. In such embodiments, the reactive handle of the functionalized layer is the support substrate reactive handle. Examples of materials suitable for a functionalized layer are discussed herein.

In some embodiments, the affinity group of a separation group includes a reactive handle directly on the affinity group. For example, in some embodiments where the affinity group includes iminodiacetic acid, the reactive handle may be one or more of the carboxylic acids or activated carboxylic or iminodiacetic acid. In some embodiments where the affinity group is a saccharide or a polysaccharide, the reactive handle may be one or more of the hydroxyls on the saccharide or polysaccharide.

In some embodiments, where a separation group includes a diamine or a polyamine, the reactive handle of the reactive handle may be one of the amines of the diamine or polyamine.

In some embodiments, a separation group of an affinity group includes a linker that separates the reactive handle from the affinity group. The linker is covalently attached to the reactive handle and the affinity group. The linker can be of any length and any compostions that does not completely inhibit the ability of the separation group to bind the target and/or completely inhibit the conjugation reaction of the separation group precursor with the support substrate precursor.

In some embodiments, the linker (L) is of formula L2 such that SL is of formula SL2; that is:

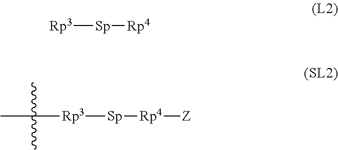

In formulas L2 and SL2, Sp is a spacer, Rp³ is a first reaction product, and Rp⁴ is a second reaction product. In formula SL2, Z is the separation group. The linker of formula L2 includes Sp, Rp³ and Rp⁴. In a separation ligand of formula SL2, a covalent bond from Rp³ to the support substrate is the point of covalent attachment of the linker (L2) to the support substrate. A covalent bond from Rp⁴ to the separation group (Z) is the point of covalent attachment of the linker (L2) to the separation group (Z). Rp³ and Rp⁴ may be any reaction product as described herein.

In some embodiments where the separation ligand is of formula SL2, Rp³, Rp⁴, or both are Rp^{A} where U⁰ is NH. In some such embodiments, the amide nitrogen (U⁰) of Rp^{A} is covalently linked to the support substrate or covalently linked to the separation group. In other such embodiments, the amide nitrogen of Rp^{A} is covalently linked to the spacer.

In some embodiments where the separation ligand is of formula SL2, Rp³, Rp⁴, or both are Rp^{A} where U⁰ is O. In some such embodiments, the ester oxygen (U⁰) of Rp^{A} is covalently linked to the support substrate or covalently linked to the separation group. In other such embodiments, the ester oxygen of Rp^{A} is covalently linked to the spacer.

The spacer (Sp) of the linker (L1) may be of any length and/or chemical composition that does not completely inhibit the formation of the first reaction product and the second reaction product. The spacer (Sp) may be of any length and/or chemical composition that does not completely inhibit the ability of the affinity group to bind to its intended target.

The spacer (Sp) includes a divalent organic group. The divalent organic group includes a backbone. The backbone is the longest contiguous chain of atoms within the spacer (Sp). In some embodiments, the backbone is a carbon-based backbone. A backbone that is carbon-based is a backbone that has a greater number of carbon atoms than heteroatoms in the backbone. The backbone may include one or more substitutions extending from the backbone and/or one or more functional groups catenated within the backbone.

In some embodiments, the backbone is an alkanediyl (divalent group that is a radical of an alkane) or an alkenediyl (divalent group that is a radical of an alkene). The alkanediyl or alkenediyl may have a backbone chain length of C1 to C18, C1 to C10, C1 to C6, C1 to C4, C1 to C3, or C2 to C4. An alkenediyl may have one or more double bonds. The one or more double bonds may be located at any point along the backbone.

In some embodiments, the backbone includes one or more catenated functional groups. Catenated functional groups have at least one atom that is a part of the backbone; that is, at least one atom of the functional group lies within the backbone chain. The at least one atom of the functional group that is a part of the backbone can be a carbon or a heteroatom. For example, in some embodiments, the backbone includes a catenated ketone where the carbon atom of the carbonyl of the ketone is a part of the backbone. In other embodiments, the backbone includes a catenated amide. In some such embodiments, the nitrogen of the catenated amide is a part of the backbone and the carbon of the carbonyl is not a part of the backbone. In other such embodiments, the nitrogen and the carbonyl carbon of the amide are a part of the backbone. Example catenated functional groups include, ethers; thioethers; esters (where the ester oxygen atom is a part of the backbone, or where the ester oxygen and the carbonyl carbon are a part of the backbone); thioesters (where the thioester sulfur atom is a part of the backbone, or where the thioester sulfur atom and the carbonyl carbon are a part of the backbone); amides (where the amide nitrogen is a part of the backbone, or where the amide nitrogen and the carbonyl carbon are a part of the backbone); ureas (where one of the urea nitrogens is a part of the backbone, or where both of the urea nitrogens and the carbonyl carbon are a part of the backbone); carbamates (where the carbamate oxygen is a part of the backbone; the carbamate nitrogen is a part of the backbone; or the carbamate oxygen, the carbamate nitrogen, and the carbonyl carbon are a part of the backbone); thioureas (where one of the urea nitrogens is a part of the backbone, or where both of the urea nitrogens and the carbonyl carbon are a part of the backbone); secondary and tertiary amines; aromatic rings (where at least two atoms of the aromatic ring are a part of the backbone); and any combination thereof.

In some embodiments the spacer includes a catenated ether (i.e., a catenated oxygen atom). In some such embodiments, the backbone includes a polyethylene glycol chain of 1, 2, 3, 4, 5, 6, 7, 8, 9, or 10 —OCH₂CH₂— repeat units. In some embodiments, the spacer includes a catenated ketone. In some such embodiments, the spacer is of the formula —(CO)— (i.e., the backbone is a C1 alkanediyl and the C1 is the carbonyl carbon of the catenated ketone).

In some embodiments where the separation ligand is of formula SL2, Rp3 and Rp4 are both RpE where each U5 is independently O, NH, or S. In some embodiments, the U5 of Rp3 is O and the U5 of Rp4 is O. In some embodiments, the U5 of Rp3 is NH and the U5 of Rp4 is NH. In some embodiments, the U5 of Rp3 is O and the U5 of Rp4 is NH. In some embodiments, the U5 of Rp3 is NH and the U5 of Rp4 are O.

In some embodiments where Rp3 and Rp4 are both RpE, Sp may be —C(O)—. In some such embodiments, L2 may be described as RpB. In some embodiments were L2 is RpB, U2 is O. In some embodiments were L2 is RpB, U1 is O. In some embodiments were L2 is RpB, U3 is O. In some embodiments were L2 is RpB, U1 is NH. In some embodiments were L2 is RpB, U3 is NH. In some embodiments were L2 is RpB, U1 is O, U2 is O, and U3 is NH. In some embodiments were L2 is RpB, U1 is NH, U2 is O, and U3 is O.

In some embodiments where the separation ligand is of formula SL2, Rp3 is RpE and Rp4 is RpI or RpJ where U5 and U7 are each independently O, NH, or S. In some embodiments U5 is NH and U7 is NH. In some embodiments U5 is O and U7 is O. In some embodiments U5 is NH and U7 is O. In some embodiments U5 is O and U7 is NH.

In some embodiments where Rp3 and Rp4 are both RpE, Sp may be —(CH2)n- where n is 0, 1, 2, 3, 4, 5, 6, 7, 8, 9, or 10. In some such embodiments, L2 is of the formula

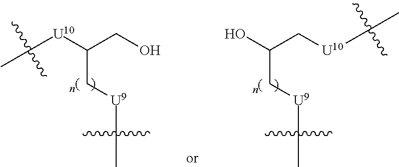

where U9 and U10 are each independently O, NH, or S and n is 0, 1, 2, 3, 4, 5, 6, 7, 8, 9, or 10. U9 may be U5 from RpI and U10 may be U7 from RpJ. In some embodiments U9 is NH and U10 is NH. In some embodiments U9 is O and U10 is O. In some embodiments U9 is NH and U10 is O. In some embodiments U9 is O and U10 is NH.

In some embodiments, a separation ligand of formula SL is of formula

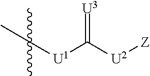

where U1, U2, and U3 are each independently O, NH, or S and Z is a separation group. For example, in some embodiments, a separation ligand of formula SL is

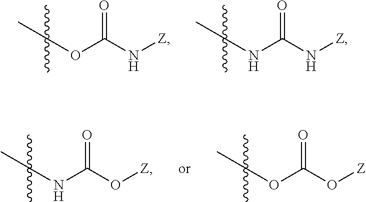

where Z is a separation group. In some embodiments, Z is an affinity group.

In some embodiments, a separation ligand of formula SL is of formula

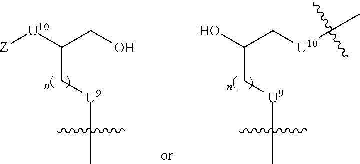

U⁹ and U¹⁰ are each independently O, NH, or S where Z is a separation group. In some embodiments, SL is

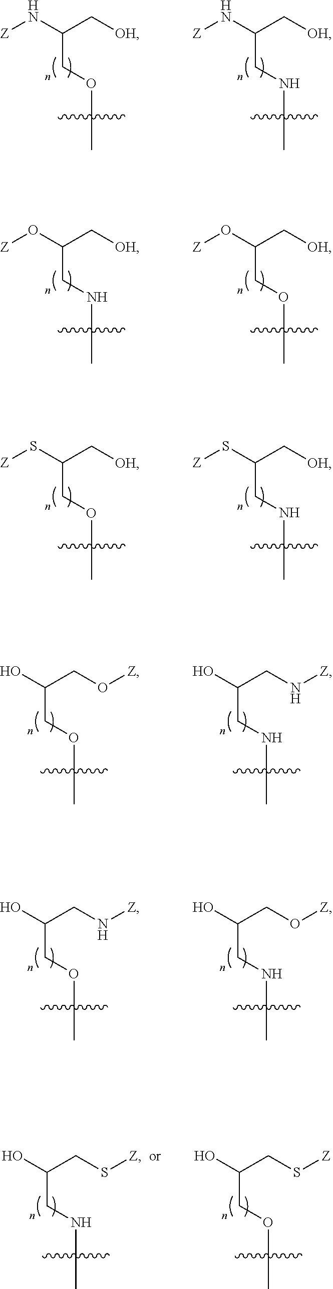

where Z is a separation group and n is 0, 1, 2, 3, 4, 5, 6, 7, 8, 9, or 10. In some embodiments Z is an affinity group.

To form a separation ligand of formula SL2, a series of conjugation reaction precursor compounds are employed, each precursor compound having a reactive handle that is cooperative with the reactive handle of a different precursor compound. In some embodiments, a separation media of formula SL2 is formed through the conjugation of a linker precursor of formula Pre-L, an affinity group precursor of formula Pre-Z(2), and a support substrate precursor of formula Pre-M(2). The linker precursor (Pre-L) includes the spacer Sp of the separation media of formula SL2, a first linker reactive handle Rh³, and a second linker reactive handle Rh⁴. The support substrate precursor (Pre-M(2)) includes a support substrate (vertical black line) and a support substrate reactive handle Rh⁵. The separation group precursor (Pre-Z(2)) includes the separation group Z of formula SL2 and a separation group reactive handle Rh⁶.

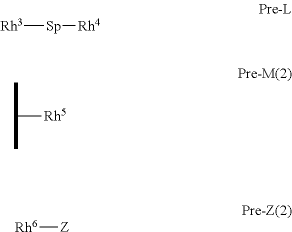

Rh³ and Rh⁵ are a pair of cooperative reactive handles. Rh⁴ and Rh⁶ are a pair of cooperative reactive handles. Rh³ of the linker precursor reacts with Rh⁵ of the support substrate precursor in a conjugation reaction to from a reaction product (i.e., Rp³ of formula SL2). Rh⁴ of the linker precursor reacts with Rh⁶ of the separation group precursor in a conjugation reaction to from a reaction product (i.e., Rp⁴ of formula SL2).

Because the linker precursor includes two reactive handles, the linker precursor is a bifunctional linker. In some embodiments, the linker precursor may be a multifunctional linker precursor that has three or more reactive handles. At least one of the reactive handles is configured to react with the support substrate precursor. The additional reactive handles may be configured to react with a cooperative reactive handle on one or more separation groups. Examples of bifunctional and multifunctional linker precursors include, epichlorohydrin; diglycidyl ether; triglycidyl ether; tetraglycidyl ether; triazine; poly triazine; poly acrylic (e.g., the COOH groups can be made into activated ester reactive handles); succinic acid (e.g., the COOH groups can be made into activated ester reactive handles); glutaraldehyde; divinylsulfone; triazines; anhydrides; N′N′-disuccinimidyl carbonate (DSC); and diisocyanates (e.g., compound having two isocyanate groups).

In some embodiments, a separation ligand of formula SL2 may be formed through two conjugation reactions. The reactions may be conducted in any order or simultaneously. For example, in some embodiments, a separation ligand of formula SL2 is formed by way of synthetic scheme 2 (S2).

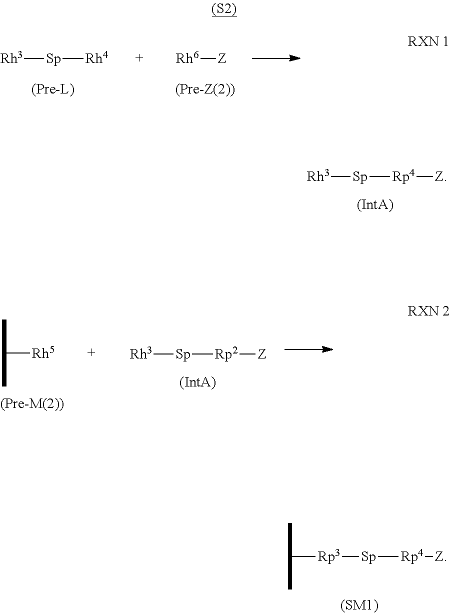

In a first conjugation reaction of scheme S2 (RXN1), the separation group reactive handle (Rh⁶) is reacted with a first linker reactive handle (Rh⁴) in a first conjugation reaction to from a first reaction product Rp⁴ thereby resulting in intermediate A (IntA). Intermediate A is a linker-separation group conjugate that includes the first reaction product (Rp⁴) and the second linker reactive handle (Rh³). IntA may be isolated or taken forward to the second conjugation reaction without isolation. In a second conjugation reaction of S2 (RXN 2) the second linker reactive handle (Rh³) of IntA is reacted with the support substrate reactive handle (Rh⁵) to form a second reaction product (Rp³), thereby forming a separation ligand of formula SL2.

In some embodiments, a separation ligand of formula SL2 is formed by way of synthetic scheme 3 (S3).

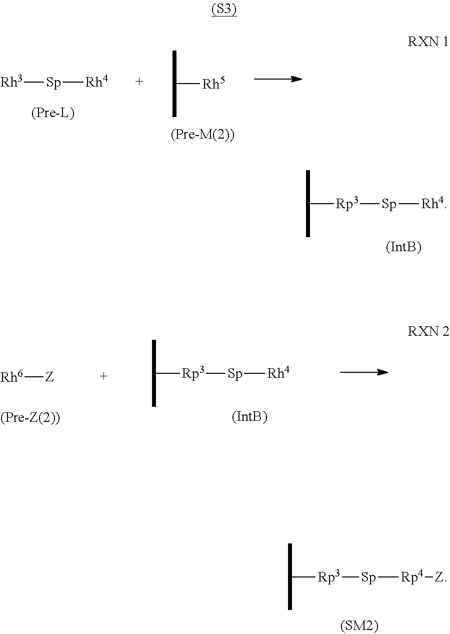

In a first conjugation reaction of scheme S3 (RXN1), the support substrate reactive handle (Rh⁵) is reacted with a first linker reactive handle (Rh³) in a first conjugation reaction to from a first reaction product (Rp³) thereby resulting in intermediate B (IntB). Intermediate B is a linker-support substrate conjugate that includes the first reaction product (Rp³) and the second linker reactive handle (Rh⁴). IntB may be isolated or taken forward to the second conjugation reaction without isolation. In a second conjugation reaction of S3 (RXN 2) the second linker reactive handle (Rh⁴) of IntB is reacted with the separation group reactive handle (Rh⁶) to form a second reaction product (Rp⁴), thereby forming a separation ligand of formula SL2.

Synthetic scheme S4 and synthetic scheme S5 are examples of forming a separation ligand of formula SL2 through scheme S3 using the bifunctional linker (Pre-L) N,N′-disuccinimidyl carbonate (S3) or epichlorohydrin (S4). In both S4 and S5, R10 can be OH, NH2, or SH and R11 can be O, NH, or S depending on the identity of R10.

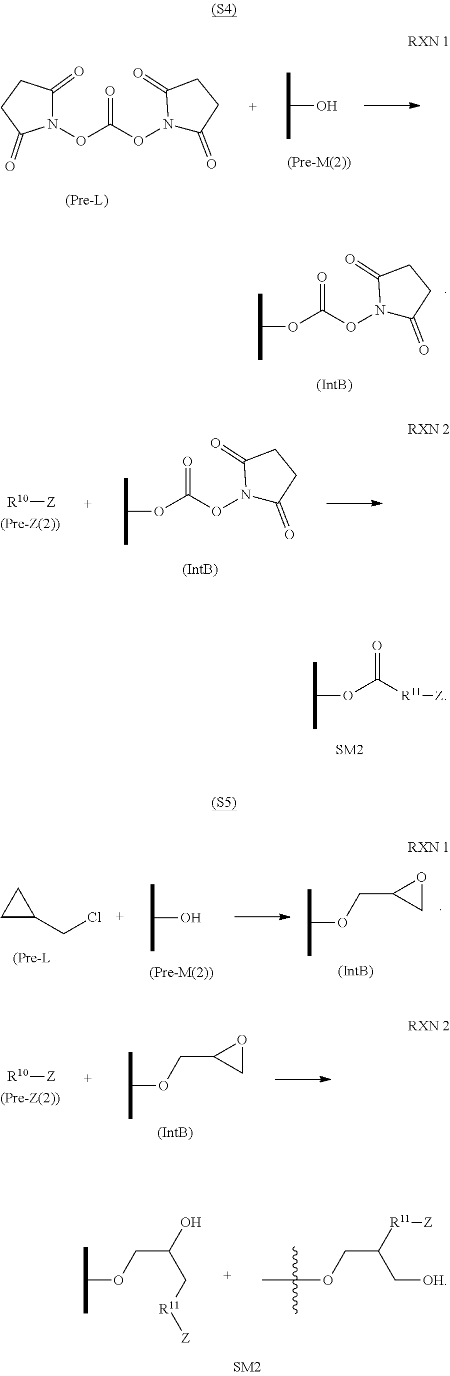

The present disclosure provides methods of making the separation media of the present disclosure. The separation media may be any separation media as disclosed herein. The separation media may be made methods described in PCT application number PCT/US2019/065805 (WO2020123714A1, Zhou), which is incorporated by reference in its entirety.

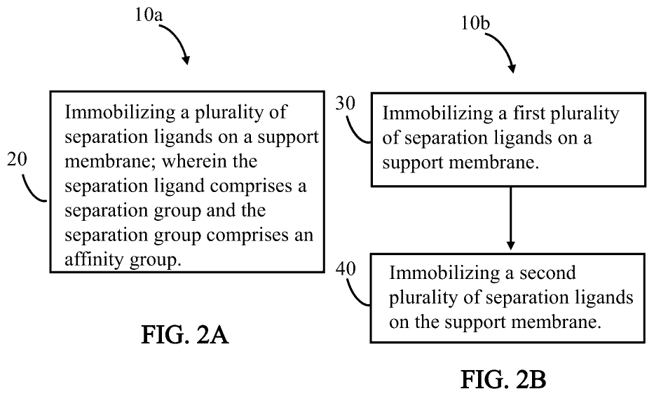

FIG. 2A is a flow diagram depicting a general method 10a for making a separation media of the present disclosure. The general method 10a includes immobilizing a plurality of separation ligands on a support substrate (step 20). Each separation ligand includes a separation group and a linker. The separation media may be of formula SLim. The separation group includes the affinity group. Each separation ligand may be of formula SM, SM1, or SM2. Each separation ligand can be immobilized according to any relevant synthetic scheme described herein (e.g., S1, S2, S3, S4, or S5).

In some embodiments, the separation media includes a first plurality of separation ligands immobilized on the support substrate and a second plurality of separation ligands immobilized on the support substrate. FIG. 2B is a flow diagram depicting a general method 10b for making a separation media of the present disclosure that includes at least two pluralities of separation ligands. Each plurality of separation ligands immobilized on a support substrate may be of formula SLim. Each separation ligand of the first plurality of separation ligands and the second plurality of separation ligands includes a separation group and a linker. Each separation ligand of the first plurality of separation ligands and the second plurality of separation ligands may be of formula SM, SM1, or SM2. Each separation ligand of the first plurality of separation ligands and the second plurality of separation ligands can be immobilized according to any relevant synthetic scheme described herein (e.g., S1, S2, S3, S4, or S5).

The method 10b includes immobilizing the first plurality of separation ligands on a support substrate (step 30). The method 10b further includes immobilizing the second plurality of separation ligands on the support substrate (step 40).

In some embodiments of method 10b, the first plurality of separation ligands includes an assistance group, and the second plurality of separation ligands includes an affinity group. Without wishing to be bound by theory, it is thought that the assistance groups of the first plurality of separation ligands can interact with (e.g., via electrostatics and/or hydrophobic or hydrophilic interactions) with the affinity group of separation group precursor used to form the second plurality of separation ligands. Through these interactions, the separation group precursors may concentrate on the surface of the support substrate thereby increasing conjugation reaction efficiency (e.g., speed and/or yield). An increase in reaction efficiency may allow a lower concentration of second plurality of separation ligands to be used in the reaction step than would be needed to achieve the same reaction yield and/or surface coverage without the use of assistance groups. In some embodiments, the assistance group includes an amine. In such embodiments where separation ligands that include an amine assistance group are immobilized prior to immobilization of separation ligands containing affinity groups, the method is amine assisted.

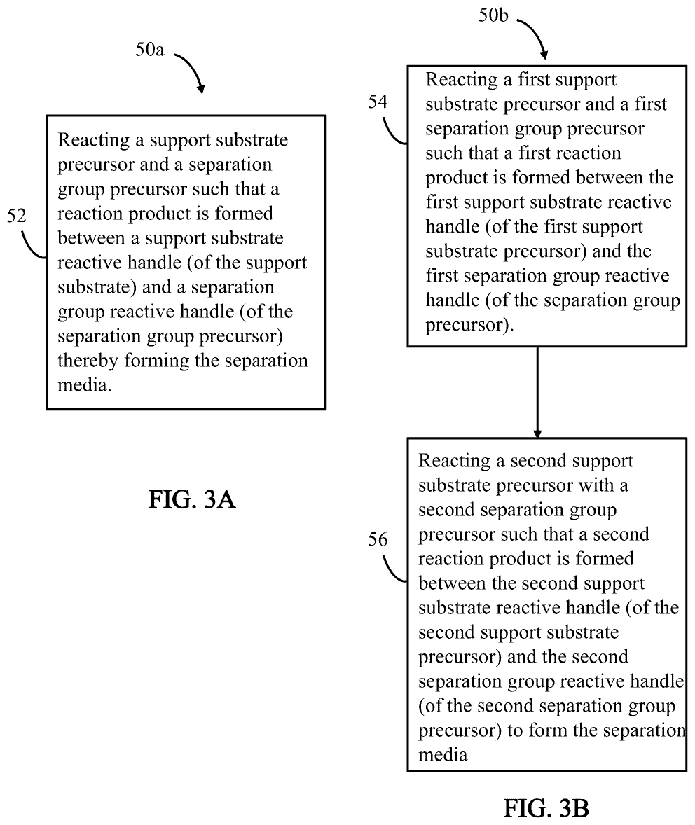

In some embodiments, method 10a or 10b may include method 50a. FIG. 3A is a flow diagram outlining method 50a for making a separation media including a separation ligand of the present disclosure. Method 50a may be understood in reference to synthetic scheme S1 as described herein; however, it is understood that method 50a is not limited to the synthetic scheme S1. The separation ligand of the separation media made from method 50a is synthesized from two components, a separation group precursor (e.g., Pre-Z(1)) and a support substrate precursor (e.g., Pre-M(1)). The separation group precursor includes the separation group (Z) and a separation group reactive handle (Rh¹). The support substrate precursor includes a support substrate (thick vertical black line) and a support substrate reactive handle (Rh¹). The separation group reactive handle and the support substrate reactive handle are cooperative handles. Method 50a includes reacting a support substrate precursor and a separation group precursor such that a reaction product (e.g., Rp¹) is formed between the support substrate reactive handle (of the support substrate precursor) and the separation group reactive handle (of the separation group precursor) thereby forming the separation media (e.g., the immobilized separation ligand of Formula SLim.

In some embodiments, step 52 may be accomplished using a reaction mixture. The reaction mixture includes a solvent and the separation group precursor. The reaction mixture may be applied to the support substrate, or the support substrate may be submerged in the reaction mixture. The solvent may include an organic solvent, water, or both. In some embodiments, the solvent is an aqueous buffer that includes one or more salts and/or buffering agents as disclosed herein. The reaction mixture may include additional compounds that facilitate the reaction. For example, the reaction mixture may include an acid, a base, an initiator, a catalyst, or any combination thereof.

In some embodiments where the solvent includes an organic solvent, the reaction step is considered to be “organic assisted” or “organic solvent assisted.” In an organic assisted method, the solvent of the reaction mixture includes water and at least one water-miscible organic solvent. Examples of water-miscible organic solvents include ethanol, acetone, acetonitrile, methanol, propanol (e.g., 2-propanol, 1-propanol), 2-butanol, tetrahydrofuran, dimethylformamide, and dimethyl sulfoxide. The ratio of water to organic solvent in the reaction mixture is such that the reaction mixture is at or near the cloud point of the mixture. The cloud point is the point at which a liquid solution undergoes a liquid-liquid phase separation to from an emulsion or a liquid-solid phase transition to form a stable suspension or a precipitate. The cloud point can be visualized by observing the water-to-organic solvent ratio at which the reaction solution becomes turbid. Without wishing to be bound by theory, it is thought that including an organic solvent in the reaction mixture such that the reaction mixture is at or near the cloud point increases the conjugation reaction efficiency. The organic solvent molecule can displace water molecules in the separation group precursor thereby increasing interactions between the separation group precursor and the support substrate.

It is possible to define a range of appropriate amounts of organic solvent in the reaction solution in which the upper boundary is expressed by [V %_{cp}+a(100%−V %_{cp})] and the lower boundary is expressed by [V %_{cp}−bV %_{cp}], where “V %_{cp}” is the percent by volume of the organic solvent in the reaction mixture at the cloud point, “a” is the upper deviation from the cloud point, and “b” is the lower deviation from the cloud point. For the purpose of an example, if the percent by volume of the organic solvent in the ligand solution at the cloud point (V %_{cp}) is 60%, and the upper and lower boundaries are defined by a=0.3 and b=0.5, then the corresponding appropriate amounts of organic solvent in the reaction mixture would range from 30% to 72% organic solvent by volume. In embodiments, the reaction mixture can include amount of organic solvent in which “a” is about 0.01, 0.02, 0.03, 0.04, 0.05, 0.06, 0.07, 0.08, 0.09, 0.1, 0.12, 0.14, 0.16, 0.18, 0.2, 0.25, 0.3, 0.4, 0.5, 0.6, 0.7, 0.8, 0.9, 0.99 and “b” is about 0.01, 0.02, 0.03, 0.04, 0.05, 0.06, 0.07, 0.08, 0.09, 0.1, 0.12, 0.14, 0.16, 0.18, 0.2, 0.25, 0.3, 0.4, 0.5, 0.6, 0.7, 0.8, 0.9, 0.99. In some embodiments, the reaction mixture includes an amount of organic solvent ranging from 70% to 130%, 80% to 120%, 90% to 110%, or 95% to 105% of the volumetric amount of the organic solvent at the cloud point of the reaction mixture.

In embodiments where the reaction mixture is aqueous and includes one or more salts, the reaction step may be kosmotropic salt assisted. In a kosmotropic salt assisted method, the reaction mixture includes water and at least one kosmotropic salt at a concentration such that the reaction mixture is at or near its cloud point. Examples of kosmotropic salts include sodium phosphate, sodium sulfate, and ammonium sulfate. Without wishing to be bound by theory, it is thought that including a kosmotropic salt in the reaction mixture such that the reaction mixture is at or near the cloud point increases the conjugation reaction efficiency. The salt molecules can disrupt the solvation shell of separation group precursors thereby increasing interactions between the separation group precursor and the support substrate.

In some embodiments, the separation media includes a first plurality of separation ligands immobilized on the support substrate and a second plurality of separation ligands immobilized on the support substrate. In some such embodiments, method 50b may be used to prepare the separation media. FIG. 3B is a flow diagram outlining method 50b for making a separation media that includes multiple pluralities of separation ligands immobilized to the support substrate. The first plurality of separation ligands synthesized according to method 50b are made from two components a first support substrate reactive precursor and a first separation group precursor. The second plurality of separation ligands synthesized according to method 50b are made from two components a second support substrate reactive precursor and a second separation group precursor. The first support substrate precursor includes the first support substrate reactive handle. The second support substrate precursor includes a second support substrate reactive handle. The first support substrate reactive handle and the second support substrate reactive handle may be the same or different. The first separation group precursor includes a separation group and a first separation group reactive handle. The second separation group precursor includes a separation group and the second separation group reactive handle. The first support substrate reactive handle and the first separation group reactive handle are cooperative reactive handles. The second support substrate reactive handle and second separation group reactive handle are cooperative handles.

Method 50b includes reacting the first support substrate precursor and the first separation group precursor such that a first reaction product is formed between the first support substrate reactive handle (of the first support substrate precursor) and the first separation group reactive handle (of the first separation group precursor). The method further includes reacting the second support substrate precursor with the second separation group precursor such that a second reaction product is formed between the second support substrate reactive handle (of the second support substrate precursor) and the second separation group reactive handle (of the second separation group precursor).

In some embodiments, the first separation group precursor includes an amine, and the entire method (50b) is amine assisted.

In some embodiments, step 54, step 56, or both are organic solvent assisted or kosmotropic salt assisted. For example, step 54 may be accomplished with a first reaction mixture that includes the first separation group precursor, water, and an organic solvent that is miscible with water or a kosmotropic salt. Step 56 may be accomplished with a second reaction mixture. The second reaction mixture includes the second separation group precursor water and an organic solvent that is miscible with water or at least one kosmotropic salt.

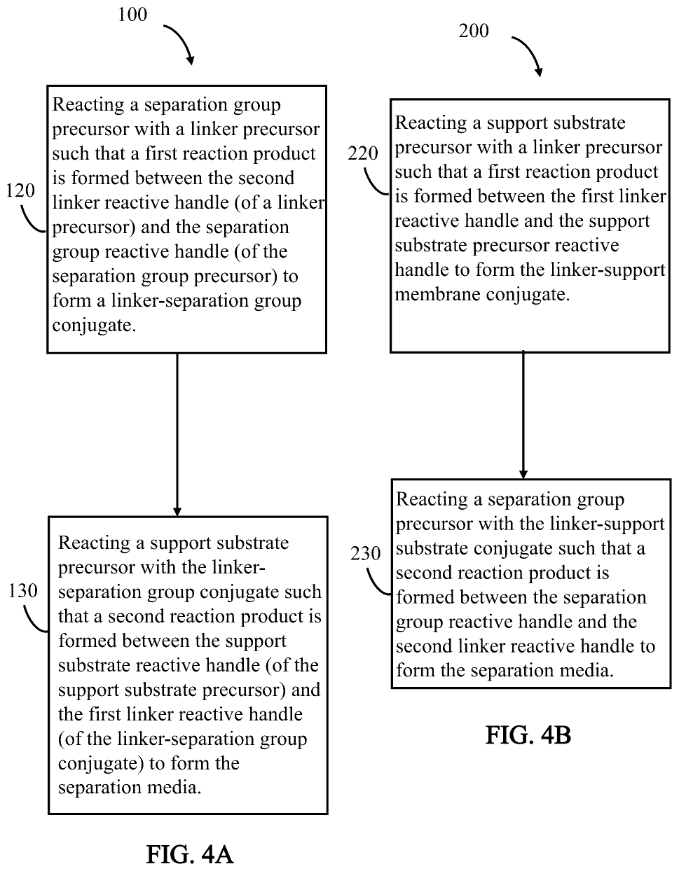

In some embodiments, method 10a, 10b, 50a, or 50b may include method 100. FIG. 4A is a flow diagram outlining method 100. Method 100 may be understood in reference to synthetic scheme S2 as described herein; however, it is understood that the method of 100 is not limited to the synthetic scheme S2. The separation ligands of the separation media made according to method 100 are synthesized from three components, a linker precursor (e.g., Pre-L), a support substrate precursor (e.g., Pre-M(2)), and a separation group precursor (e.g., Pre-Z(2)). The linker precursor includes a first linker reactive handle (Rh³), a second linker reactive handle (Rh⁴), and a spacer (Sp) that covalently links the first linker reactive handle and the second linker reactive handle. The separation group precursor includes a separation group (Z) and a separation group reactive handle (Rh⁶). The support substrate precursor includes a support substrate (thick vertical black line) and a support substrate reactive handle (Rh⁵). The second linker reactive handle (Rh⁴) and the separation group reactive handle (Rh⁶) are cooperative reactive handles. The first linker reactive handle (Rh³) and the support substrate reactive handle (Rh⁵) are cooperative reactive handles.

The method 100 includes reacting the separation group precursor with the linker precursor such that a first reaction product is formed between the second linker reactive handle (of a linker precursor) and the separation group reactive handle (of the separation group precursor) to form a linker-separation group conjugate (step 120). Method 100 further includes reacting the support substrate precursor with the linker-separation group conjugate of step 120 such that a second reaction product is formed between the support substrate reactive handle (of the support substrate precursor) and the first linker reactive handle (of the linker-separation group conjugate) to form the separation media (step 130).

In some embodiments, method 10a, 10b, 50a, or 50b may include the method 200. FIG. 4B is a flow diagram outline method 200. The method 200 may be understood in reference to synthetic scheme S3 as described herein; however, it is understood that the method of 200 is not limited to the synthetic scheme S3. The separation ligand made according to method 200 is synthesized from three components, a linker precursor (e.g., Pre-L), a support substrate precursor (e.g., Pre-M(2)), and a separation group precursor (e.g., Pre-Z(2)). The linker precursor includes a first linker reactive handle (Rh³), a second linker reactive handle (Rh⁴), and a spacer (Sp) that covalently links the first linker reactive handle and the second linker reactive handle. The separation group precursor includes a separation group (Z) and a separation group reactive handle (Rh⁶). The support substrate precursor includes a support substrate (thick vertical black line) and a support substrate reactive handle (Rh⁵). The second linker reactive handle (Rh⁴) and the separation group reactive handle (Rh⁶) are cooperative reactive handles. The first linker reactive handle (Rh³) and the support substrate reactive handle (Rh⁵) are cooperative reactive handles.

Method 200 includes reacting a support substrate precursor with a linker precursor such that a first reaction product is formed between the first linker reactive handle and the support substrate precursor reactive handle to form the linker-support substrate conjugate. Method 200 further includes reacting a separation group precursor with the linker-support substrate conjugate such that a second reaction product is formed between the separation group reactive handle and the second linker reactive handle to form the separation media.

Any step of method 100 or method 200 may be organic solvent assisted or kosmotropic salt assisted.

In some embodiments, methods 10a, 10b, 50a, 50b, 100, and 200 further include functionalizing the support substrate to install the support substrate reactive handles. Installing the support substrate reactive handles followed by one or more conjugation reactions to immobilize the separation ligands to the reactive handles is called indirect immobilization. In such embodiments, the method may further include depositing a polymer having reactive handles onto the support substrate. In some embodiments, the polymer is deposited such that it is grafted onto the support substrate. In other embodiments, the polymer is deposited such that it is grafted from the support substrate. In embodiments where the polymer is grafted from the support substrate, the method may further include coupling an initiator to the support substrate to form an immobilized initiator. In such embodiments, the method may further include polymerizing a plurality of monomers from the immobilized initiator.

In some embodiments, the support substrate reactive handle is already a part of the support substrate and not from a deposited functional layer. In such embodiments, the separation ligands are immobilized directly to the support substrate in a process called direct immobilization. Any of the methods 10a, 10b, 50a, 50b, 100, and 200 may include direct immobilization.

Direct and indirect immobilization may be accomplished using the amine assisted method, without amine assistance groups (not amine assisted), using the organic solvent assistance method, using the kosmotropic assisted method, not using the kosmotropic salt assisted method, or any combination thereof.

In some embodiments, the methods of 10a, 10b, 50a, 50b, 100, and 200 include swelling the support substrate prior to any one of the conjugation steps. Swelling the support substrate includes exposing the support substrate to a swelling mixture. The swelling mixture includes one or more organic solvents. Examples of organic solvent that may be used in a swelling mixture include dimethyl sulfoxide, acetonitrile, tetrahydrofuran, dimethylformamide, hexamethylphosphoramide, ionic liquids, sulfolane, or any combination thereof.

The separation media of the present disclosure may be employed in a separation device. The separation device is a submergible membrane, membrane chromatography column, a membrane chromatography cassette, or other membrane chromatography device that includes the separation media of the present disclosure. A separation device may be operated manually or integrated with software, pumps, detectors, and/or other accessories.

In some embodiments, the separation media is a submergible membrane. In some such embodiments, the submergible membrane includes the separation media disposed with a housing such that the housing is configured to allow an isolation solution to contact the membrane when the device is submerged in the isolation solution and/or when an isolation solution is flow across the device. Submergible membranes may be particularly useful for applications of using the separation media of the present disclosure to remove metals from waste mixtures such as waste water.

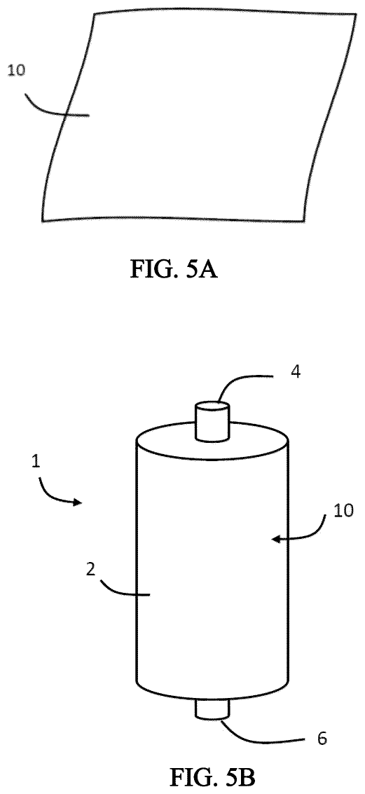

The separation media 10 is schematically shown as a membrane in FIG. 5A. The separation media membrane 10 may be provided in a separation device 1 (e.g., a chromatography column), shown in FIG. 5B. The separation device 1 includes a housing 2 with an inlet 4 and an outlet 6 to facilitate flow through the device. The separation device (e.g., membrane chromatography column, membrane chromatography cassette, or other membrane chromatography device) may provide a residence time of the target of 5 minutes or less, 2 minutes or less, 1 minute or less, 30 seconds or less, 20 seconds or less, 10 seconds or less, or 6 seconds or less. According to an embodiment, using membrane-based purification devices can significantly improve productivity.

In some embodiments, two or more separation media of the present disclosure may be arranged in a stacked configuration. The stacked configuration may be employed in a separation device. In some embodiments, a first separation media and a second separation media are arranged in a stacked configuration. In some embodiments, the first separation media and the second separation media have the same identity; that is, the separation media have the same support substrate and the same separation ligands immobilized on the substrate. The separation ligands are immobilized at the same or similar separation ligand densities. In other embodiments, the first separation media and the second separation media have different identities. For example, the first separation media and the second separation media have a different support substrate; different separation ligands; different separation group densities; or any combination thereof.

The separation device (e.g., membrane chromatography column, membrane chromatography cassette, or other membrane chromatography device) may provide a residence time of 5 minutes or less, 2 minutes or less, 1 minute or less, 30 seconds or less, 10 seconds or less, 6 seconds or less, 5 seconds or less, 4 seconds or less, 3 seconds or less, 2 seconds or less, or 1 second or less. The separation device (e.g., membrane chromatography column, membrane chromatography cassette, or other membrane chromatography device) may provide a residence time of 0.01 seconds or greater, 0.1 seconds or greater, 1 second or greater, 5 seconds or greater, 6 seconds or greater, 10 seconds or greater, 30 seconds or greater, 1 minute or greater, or 2 minutes or greater. Residence time is the time any normalized amount of fluid takes to traverse the separation media of the separation device (a single separation media or multiple separation media). For example, residence time is the time it takes any molecule that is not the target and/or does not bind to the separation media to traverse the separation media in a separation device. Residence time is calculated as the flow rate or the solution going through the column divided by the total bed volume of all of the separation media included in the separation device. The residence times of the separation devices of the present disclosure may be lower than those of separation media made of resins.

In some embodiments, two or more separation media of the present disclosure may be arranged in a stacked configuration. The stacked configuration may be employed in a separation device. In some embodiments, a first separation media and a second separation media are arranged in a stacked configuration. In some embodiments, the first separation media and the second separation media have the same identity; that is, the separation media have the same support substrate and the same separation ligands immobilized on the substrate. The separation ligands are immobilized at the same or similar separation ligand densities. In other embodiments, the first separation media and the second separation media have different identities. For example, the first separation media and the second separation media have a different support substrate; different separation ligands; different separation group densities; or any combination thereof.

Process productivity can be defined using the equation below. In the denominator, Vₜₒₜ is the total volume of solution passing through the separation media (e.g., column or cassette) during the whole process, including load (the volume of the isolation solution discussed herein), rinse (e.g., the volume of the washing solution as discussed herein), elution (e.g., the volume of the elution solution as discussed herein), and regeneration steps (e.g., the volume of the regeneration solution as discussed herein). BV is the chromatography medium bed volume (corresponding to the volume of the separation media), and tau is residence time. Loading volume is proportional to dynamic binding capacity of the chromatography column medium. Thus, process productivity increases with increasing binding capacity and decreasing residence time.

$$Productivity = \frac{target}{Cost of time} = \frac{Loading volume \times target \times yield}{( \frac{{V}_{tot}}{BV} ) \times τ} \vert$$

Dynamic binding capacity generally refers to the concentration of bound target on the separation media (milligram bound per unit bed volume of separation media) at breakthrough in the effluent. A dynamic binding capacity at 10% breakthrough (DBC_{10%}) can be determined via a standard chromatography method, e.g., using Cytiva AKTA pure Fast Protein Liquid chromatography (FPLC). First, the separation media is packed into a housing unit. Then, the contained separation media is connected to an FPLC system. Next, feed material (e.g., isolation solution) containing the target is passed though the separation media under certain column volumes per minute flowrate (CV/min) until the effluent concentration of the target reaches 10% of the feed concentration, as determined by a detector (e.g., a UV detector). At the end, based on the holdup volume in the FPLC system and separation media volume, the DBC_{10%} is calculated as follows ((Volume to 10% breakthrough-holdup volume)×(feed concentration))/(volume of separation media)=DBC_{10%} expressed as mg target material/unit volume separation media. The volume of the separation media is determined by the surface area of the separation media multiplied by the thickness of the separation media. The volume of the separation media can be referred to as the bed volume. In general, the volume of the separation media does not account for the void space within the separation media. The holdup volume is the total volume between the injection port (i.e., the location where a fluid enters the system) and the detector. The holdup volume includes the bed volume (e.g., the separation media volume) as well as any volume between the injection port and the bed and any volume between the bed and the detector.

In some embodiments, a separation media or separation device containing the same has a dynamic binding capacity at 10% breakthrough of 0.01 milligrams of target per 1 mL bed volume (mg/mL bed volume) or greater, 0.1 mg/mL bed volume or greater, 1 mg/mL bed volume or greater, 5 milligrams of target per 1 mL of separation media (mg/mL bed volume) or greater, 10 mg/mL bed volume or greater, 20 mg/mL bed volume or greater, 25 mg/mL bed volume or greater, 30 mg/mL bed volume or greater, 35 mg/mL bed volume or greater, 40 mg/mL bed volume or greater, 45 mg/mL bed volume or greater, 50 mg/mL bed volume or greater, 60 mg/mL bed volume or greater, 70 mg/mL bed volume or greater, 80 mg/mL bed volume or greater, 90 mg/mL bed volume or greater, 100 mg/mL bed volume or greater, or 120 mg/mL bed volume or greater. In some embodiments, a separation media has a dynamic binding capacity at 10% breakthrough of 150 mg/mL bed volume or less, 120 mg/mL bed volume or less 100 mg/mL bed volume or less, 90 mg/mL bed volume or less, 80 mg/mL bed volume or less, 70 mg/mL bed volume or less, 60 mg/mL bed volume or less, 50 mg/mL bed volume or less, 40 mg/mL bed volume or less, 35 mg/mL bed volume or less, 30 mg/mL bed volume or less, 25 mg/mL bed volume or less, 20 mg/mL bed volume or less, 10 mg/mL bed volume or less, 5 mg/mL bed volume or less, 1 mg/mL bed volume or less, or 0.1 mg/mL bed volume or less. In some embodiments, a separation media or separation device containing the same has a dynamic binding capacity at 10% breakthrough of 0.01 mg/mL bed volume to 150 mg/mL bed volume, 0.01 mg/mL bed volume to 120 mg/mL bed volume, 0.01 mg/mL bed volume to 100 mg/mL bed volume, 0.01 mg/mL bed volume to 10 mg/mL bed volume, 0.01 mg/mL bed volume to 5 mg/mL bed volume, 0.01 mg/mL bed volume to 1 mg/mL bed volume, 0.1 mg/mL bed volume to 150 mg/mL bed volume, 0.1 mg/mL bed volume to 120 mg/mL bed volume, 0.1 mg/mL bed volume to 100 mg/mL bed volume, 0.1 mg/mL bed volume to 10 mg/mL bed volume, 0.1 mg/mL bed volume to 5 mg/mL bed volume, 0.1 mg/mL bed volume to 1 mg/mL bed volume, 1 mg/mL bed volume to 150 mg/mL bed volume, 1 mg/mL bed volume to 120 mg/mL bed volume, 1 mg/mL bed volume to 100 mg/mL bed volume, 5 mg/mL bed volume to 150 mg/mL bed volume, 5 mg/mL bed volume to 120 mg/mL bed volume, 5 mg/mL bed volume to 100 mg/mL bed volume, 10 mg/mL bed volume to 150 mg/mL bed volume, 10 mg/mL bed volume to 120 mg/mL bed volume, 10 mg/mL bed volume to 100 mg/mL bed volume, 10 mg/mL bed volume to 90 mg/mL bed volume, 10 mg/mL bed volume to 80 mg/mL bed volume, 10 mg/mL bed volume to 70 mg/mL bed volume, 10 mg/mL bed volume to 60 mg/mL bed volume, 10 mg/mL bed volume to 50 mg/mL bed volume, 10 mg/mL bed volume to 40 mg/mL bed volume, 15 mg/mL bed volume to 60 mg/mL bed volume, 15 mg/mL bed volume to 50 mg/mL bed volume, 20 mg/mL bed volume to 80 mg/mL bed volume, 20 mg/mL bed volume to 70 mg/mL bed volume, 20 mg/mL bed volume to 60 mg/mL bed volume, 20 mg/mL bed volume to 50 mg/mL bed volume, 30 mg/mL bed volume to 80 mg/mL bed volume, 30 mg/mL bed volume to 70 mg/mL bed volume, 30 mg/mL bed volume to 60 mg/mL bed volume, or 30 mg/mL bed volume to 50 mg/mL bed volume. The dynamic binding capacity may depend at least in part on the target and the affinity group.

The separation media of the present disclosure may have a variety of static binding capacities (SBC). The static binding capacity is the amount of target bound to the separation media per volume of the separation media. The static binding capacity can be determined, for example, by incubating the separation media with an isolation solution containing a known amount of the target ligand for a period of time. Following incubation, the amount of the target still in the isolation solution (target not bound to the separation media) can be measured. The static binding capacity can then be calculated as the difference between the initial amount of the target in the isolation solution and the amount of target in the isolation solution following incubation with the separation media. The amount of the target in the isolation solution pre- and post-incubation with the separation media can be determined, for example, using spectroscopy and/or high performance liquid chromatography.

The static binding capacity may be higher than the dynamic binding capacity at 10% breakthrough. For example, in some embodiments, the SBC can be 10% to 40% greater than the DBC_{10%}. The pore size of the support substrate may influence the SBC and DBC_{10%}. For example, smaller pore sizes may cause a greater difference between the SBC and the DBC_{10%} as compared to relatively larger pore sizes. In some embodiments, a separation media or separation device containing the same has a static binding capacity of 0.01 milligrams of target per 1 mL of bed volume (mg/mL bed volume) or greater, 0.1 mg/mL bed volume or greater, 1 mg/mL bed volume or greater, 5 milligrams of target per 1 mL of separation media (mg/mL bed volume) or greater, 10 mg/mL bed volume or greater, 20 mg/mL bed volume or greater, 25 mg/mL bed volume or greater, 30 mg/mL bed volume or greater, 35 mg/mL bed volume or greater, 40 mg/mL bed volume or greater, 45 mg/mL bed volume or greater, 50 mg/mL bed volume or greater, 60 mg/mL bed volume or greater, 70 mg/mL bed volume or greater, 80 mg/mL bed volume or greater, 90 mg/mL bed volume or greater, 100 mg/mL bed volume or greater, or 120 mg/mL bed volume or greater. In some embodiments, a separation media or separation device containing the same has a static binding capacity of 150 mg/mL bed volume or less, 120 mg/mL bed volume or less 100 mg/mL bed volume or less, 90 mg/mL bed volume or less, 80 mg/mL bed volume or less, 70 mg/mL bed volume or less, 60 mg/mL bed volume or less, 50 mg/mL bed volume or less, 40 mg/mL bed volume or less, 35 mg/mL bed volume or less, 30 mg/mL bed volume or less, 25 mg/mL bed volume or less, 20 mg/mL bed volume or less, 10 mg/mL bed volume or less, 5 mg/mL bed volume or less, 1 mg/mL bed volume or less, or 0.1 mg/mL bed volume or less. In some embodiments, a separation media or separation device containing the same has a static binding capacity of 0.01 mg/mL bed volume to 150 mg/mL bed volume, 0.01 mg/mL bed volume to 120 mg/mL bed volume, 0.01 mg/mL bed volume to 100 mg/mL bed volume, 0.01 mg/mL bed volume to 10 mg/mL bed volume, 0.01 mg/mL bed volume to 5 mg/mL bed volume, 0.01 mg/mL bed volume to 1 mg/mL bed volume, 0.1 mg/mL bed volume to 150 mg/mL bed volume, 0.1 mg/mL bed volume to 120 mg/mL bed volume, 0.1 mg/mL bed volume to 100 mg/mL bed volume, 0.1 mg/mL bed volume to 10 mg/mL bed volume, 0.1 mg/mL bed volume to 5 mg/mL bed volume, 0.1 mg/mL bed volume to 1 mg/mL bed volume, 1 mg/mL bed volume to 150 mg/mL bed volume, 1 mg/mL bed volume to 120 mg/mL bed volume, 1 mg/mL bed volume to 100 mg/mL bed volume, 5 mg/mL bed volume to 150 mg/mL bed volume, 5 mg/mL bed volume to 120 mg/mL bed volume, 5 mg/mL bed volume to 100 mg/mL bed volume, 10 mg/mL bed volume to 150 mg/mL bed volume, 10 mg/mL bed volume to 120 mg/mL bed volume, 10 mg/mL bed volume to 100 mg/mL bed volume, 10 mg/mL bed volume to 90 mg/mL bed volume, 10 mg/mL bed volume to 80 mg/mL bed volume, 10 mg/mL bed volume to 70 mg/mL bed volume, 10 mg/mL bed volume to 60 mg/mL bed volume, 10 mg/mL bed volume to 50 mg/mL bed volume, 10 mg/mL bed volume to 40 mg/mL bed volume, 15 mg/mL bed volume to 60 mg/mL bed volume, 15 mg/mL bed volume to 50 mg/mL bed volume, 20 mg/mL bed volume to 80 mg/mL bed volume, 20 mg/mL bed volume to 70 mg/mL bed volume, 20 mg/mL bed volume to 60 mg/mL bed volume, 20 mg/mL bed volume to 50 mg/mL bed volume, 30 mg/mL bed volume to 80 mg/mL bed volume, 30 mg/mL bed volume to 70 mg/mL bed volume, 30 mg/mL bed volume to 60 mg/mL bed volume, or 30 mg/mL bed volume to 50 mg/mL bed volume. The static binding capacity may depend at least in part on the target and the affinity group.

The separation media may have a variety of separation ligand densities. Separation ligand density is the amount of separation ligands immobilized per unit volume of the separation media. In embodiments where the separation media only includes separation groups that include affinity groups, the separation group density can be a measure of affinity group density. The separation ligand density can be determined, for example, by incubating the support substrate (for example, according to S1, S2, or S3) with the reaction solution containing a known amount of the separation group precursor for immobilization for a reaction time to form the separation media. Following incubation, the amount of the separation group precursor containing still in the reaction solution (unreacted) can be measured. The density of the separation ligands can then be calculated as the difference between the initial amount of the separation group precursor in the reaction solution and the amount of separation group precursor in the reaction solution following incubation with the support substrate. The amount of the separation group precursor in the reaction solution pre- and post-incubation with the support substrate can be determined, for example, using spectroscopy and/or high performance liquid chromatography. The separation group pre-cursor can be used as a proxy for the separation ligand.

In some embodiments, the separation media has separation ligand density of 0.01 milligrams of separation ligands per 1 mL of bed volume (mg/mL bed volume) or greater, 0.1 mg/mL bed volume or greater, 1 mg/mL bed volume or greater, 5 mg/mL bed volume or greater, 10 mg/mL bed volume or greater, 20 mg/mL bed volume or greater, 30 mg/mL bed volume or greater, 40 mg/mL bed volume or greater, 50 mg/mL bed volume or greater, 60 mg/mL bed volume or greater, 70 mg/mL bed volume or greater, 80 mg/mL bed volume or greater, 90 mg/mL bed volume or greater, 100 mg/mL bed volume or greater, 110 mg/mL bed volume or greater, or 120 mg/mL bed volume or greater. In some embodiments, a separation media has a separation ligand density of 150 mg/mL bed volume or less, 120 mg/mL bed volume or less, 110 mg/mL bed volume or less, 100 mg/mL bed volume or less, 90 mg/mL bed volume or less, 80 mg/mL bed volume or less, 70 mg/mL bed volume or less, 60 mg/mL bed volume or less, 50 mg/mL bed volume or less, 40 mg/mL bed volume or less, 30 mg/mL bed volume or less, or 20 mg/mL bed volume or less, 10 mg/mL bed volume or less, 5 mg/mL bed volume or less, 1 mg/mL bed volume or less, or 0.1 mg/mL bed volume or less. In some embodiments, a separation media has a separation ligand density of 0.01 mg/mL bed volume to 150 mg/mL bed volume, 0.1 mg/mL bed volume to 150 mg/mL bed volume, 1 mg/mL bed volume to 150 mg/mL bed volume, 5 mg/mL bed volume to 150 mg/mL bed volume, 10 mg/mL bed volume to 100 mg/mL bed volume, 10 mg/mL bed volume to 90 mg/mL bed volume, 10 mg/mL bed volume to 80 mg/mL bed volume, 10 mg/mL bed volume to 70 mg/mL bed volume, 10 mg/mL bed volume to 60 mg/mL bed volume, 10 mg/mL bed volume to 50 mg/mL bed volume, 10 mg/mL bed volume to 40 mg/mL bed volume, 10 mg/mL bed volume to 20 mg/mL bed volume, 15 mg/mL bed volume to 60 mg/mL bed volume, 15 mg/mL bed volume to 50 mg/mL bed volume, 15 mg/mL bed volume to 30 mg/mL bed volume, 20 mg/mL bed volume to 80 mg/mL bed volume, 20 mg/mL bed volume to 70 mg/mL bed volume, 20 mg/mL bed volume to 60 mg/mL bed volume, 20 mg/mL bed volume to 50 mg/mL bed volume, 20 mg/mL bed volume to 30 mg/mL bed volume, 30 mg/mL bed volume to 80 mg/mL bed volume, 30 mg/mL bed volume to 70 mg/mL bed volume, 30 mg/mL bed volume to 60 mg/mL bed volume, or 30 mg/mL bed volume to 50 mg/mL bed volume, 0.01 mg/mL bed volume to 10 mg/mL bed volume, 0.01 mg/mL bed volume to 5 mg/mL bed volume, 0.01 mg/mL bed volume to 1 mg/mL bed volume, 0.1 mg/mL bed volume to 10 mg/mL bed volume, 0.1 mg/mL bed volume to 5 mg/mL bed volume, 0.1 mg/mL bed volume to 1 mg/mL bed volume, or 1 mg/mL bed volume to 10 mg/mL bed volume.

Separation ligand density can also be described as the specific surface area (SSA) in square meters (m²) relative to the bed volume of the separation media. SSA can be determined, for example, using nitrogen Brunauer-Emmett-Teller (BET) analysis. Prior to immobilization of the separation ligands on the support substrate, the support substrate will have a support substrate SSA. After immobilization of the separation ligands on the support substrate to form the separation media, the separation media has a separation media SSA. The support substrate SSA and the separation media SSA may be impacted by the pore size of the support substrate, Generally, support substrates with greater pore sizes have a larger support substrate SSA. Generally, the separation media SSA will be greater than the support substrate SSA. In some embodiments the separation media SSA is 0.5 times or greater than the support substrate SSA, 1 time or greater than the support substrate SSA, 1.5 times or greater than the support substrate SSA, 2 times or greater than the support substrate SSA, 3 time or greater than the support substrate SSA, 4 time or greater than the support substrate SSA, 5 time or greater than the support substrate SSA, or 7 time or greater than the support substrate SSA. In some embodiments the separation media SSA is 10 times or less than the support substrate SSA, 7 times or less than the support substrate SSA, 5 times or less than the support substrate SSA, 4 times or less than the support substrate SSA, 3 times or less than the support substrate SSA, 2 times or less than the support substrate SSA, 1.5 times or less than the support substrate SSA, or 1 time or less than the support substrate SSA.

In some embodiments the separation media has a separation SSA of 1.5 meters squared per milliliter of bed volume (m²/mL bed volume) or greater, 2 m²/mL bed volume or greater, 3 m²/mL bed volume or greater, 4 m²/mL bed volume or greater, 5 m²/mL bed volume or greater, 8 m²/mL bed volume or greater, 9 m²/mL bed volume or greater, 10 m²/mL bed volume or greater, or 15 m²/mL bed volume when the support substrate has an average pore size of 0.1 micrometers to 10.0 micrometers, such as 0.2 micrometers to 0.5 micrometers. In some embodiments the separation media has a separation SSA of 20 m²/mL bed volume or less, 15 m²/mL bed volume or less, 10 m²/mL bed volume or less, 9 m²/mL bed volume or less, 8 m²/mL bed volume or less, 7 m²/mL bed volume or less, 6 m²/mL bed volume or less, 5 m²/mL bed volume or less, 4 m²/mL bed volume or less, or 3 m²/mL bed volume or less, 2 m²/mL bed volume or less when the support substrate has an average pore size of 0.1 micrometers to 10.0 micrometers, such as 0.2 micrometers to 0.5 micrometers. In some embodiments the separation media has a separation SSA of 1.5 m²/mL bed volume to 20 m²/mL bed volume, 1.5 m²/mL bed volume to 15 m²/mL, 1.5 m²/mL bed volume to 10 m²/mL, 2 m²/mL bed volume to 20 m²/mL, 2 m²/mL bed volume to 15 m²/mL, 2 m²/mL bed volume to 10 m²/mL, 2 m²/mL bed volume to 9 m²/mL, 2 m²/mL bed volume to 8 m²/mL, 2 m²/mL bed volume to 7 m²/mL, 2 m²/mL bed volume to 6 m²/mL, 2 m²/mL bed volume to 5 m²/mL, 3 m²/mL bed volume to 20 m²/mL, 3 m²/mL bed volume to 15 m²/mL, 3 m²/mL bed volume to 10 m²/mL, 4 m²/mL bed volume to 20 m²/mL, 4 m²/mL bed volume to 15 m²/mL, 4 m²/mL bed volume to 10 m²/mL, 5 m²/mL bed volume to 20 m²/mL, 5 m²/mL bed volume to 15 m²/mL, or 5 m²/mL bed volume to 10 m²/mL when the support substrate has an average pore size of 0.1 micrometers to 10.0 micrometers, such as 0.2 micrometers to 0.5 micrometers.

In some embodiments, the separation media and/or separation devices containing the same are able to purify a target molecule at a fast flow rate. For example, separation media and/or separation devices containing the same may be used to purify a target at residence times of 5 minutes or less, 2 minutes or less, 1 minute or less, 30 seconds or less, 10 seconds or less, or 6 seconds or less. The residence time is somewhat dependent on the volume of the separation media and/or on the size of the device. For example, in separation media that have low volumes and/or separation devices that are small, the residence times may be as low as 1 second or less. Although there is no desired lower limit for the residence time, in practice residence times are 0.1 seconds or greater.

In some embodiments, the separation media and/or separation device containing the same may be used to purify or concentrate a target from an isolation solution with a high recovery of the target molecule. The recovery of a target molecule is amount of the target molecule recovered after passing it through the separation media divided by the amount of target molecule in the isolation solution. In some embodiments, the target molecule recovery is 50% or greater, 60% or greater, 80% or greater, 90% or greater, 95% or greater, or 99% or greater. In some embodiments, the target molecule recovery is 100% or less, 95% or less, 90% or less, 80% or less, 70% or less, or 60% or less. In some embodiments, the target molecule recovery is 80% to 100%, 90% to 100%, or 95% to 100%.

In some embodiments, the separation media and/or separation device containing the same may be used to purify or concentrate target models from an isolation solution with a high recovery of active target. An active target is a target that possesses at least some of the function as the target prior to exposure to the separation media of the present disclosure. For example, an active target is a target that has undergone purification using the separation media of the present disclosure and retains at least some binding affinity to a binding partner. The recovery of active target is the amount of active target molecule recovered after passing them through the separation media divided by the amount of target molecules in the isolation solution. In some embodiments, the active target recovery is 50% or greater, 60% or greater, 80% or greater, 90% or greater, 95% or greater, or 99% or greater. In some embodiments, the active target recovery is 100% or less, 95% or less, 90% or less, 80% or less, 70% or less, or 60% or less. In some embodiments, the active target recovery is 80% to 100%, 90% to 100%, or 95% to 100%.

In some embodiments, the separation media and/or separation device containing the same may be used to remove impurities from an isolation solution. An impurity is any molecule that is not the target molecule, or a buffering agent, a salt, or an additive that has been added to the isolation solution. In some embodiments, the separation media is able to remove 50% or greater, 60% or greater, 70% or greater, 80% or greater, 90% or greater, or 99% or greater of the impurities initially present in the isolation solution. In some embodiments, the separation media is able to remove 100% or less, 99% or less, 90% or less, 80% or less, 70% or less, or 60% or less. In some embodiments, the separation media is able to remove 50% to 100%, 60% to 100%, 70% to 100%, 80% to 100% 90% to 100%, 90% to 99%, or 90% to 95% of the impurities initially present in the isolation solution.

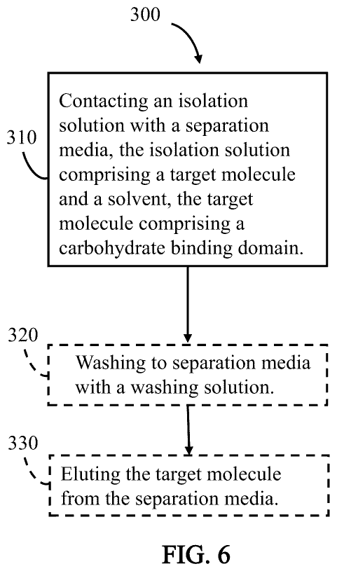

The present disclosure describes a method for using the separation media and/or the separation devices of the present disclosure. FIG. 6 is a flow diagram outlining a method 200 for using the separation media of the present disclosure to isolate and/or concentrate a target from an isolation solution. Method 300 includes contacting an isolation solution with a separation media (step 310).

The isolation solution may be any isolation solution as described herein. In some embodiments, the isolation solution includes water and one or more metals. In some embodiments, the isolation solution includes other molecules or metals for which removal may or may not be desired. For example, the isolation solution may be an industrial waste mixture, a commercial and domestic waste mixture, reaction waste, reaction mixture, electronic waste mixture, or an environmental mixture that includes inorganic compounds, organic compounds, salts, or any combination thereof in addition to the targets. It may be desirable to remove such inorganic compounds, organic compounds, and/or salts concurrently or independently from using the separation media of the present disclosure.

In some embodiments, the isolation solution includes one or more kosmotropic salts, one or more chaotropic salts, or both. Kosmotropic salts are known as salts that decrease the solubility of nonpolar substances in aqueous solutions. In contrast, chaotropic salts increase the solubility of nonpolar substances in aqueous solutions. In some embodiments, the amount and/or identity of a kosmotropic and/or chaotropic salts may be designed to increase the binding affinity and/or binding specificity between the target molecules and the affinity groups and/or assistance groups (if present).

Examples of kosmotropic salts that may be present in the isolation solution include ammonium sulfate, ammonium phosphate, potassium phosphate, sodium sulfate, sodium chloride, and any combination thereof. Suitable kosmotropic salts may be present in the isolation solution in an amount of 0.1 M or greater, 0.5 M or greater, or 1.0 M or greater, or 2.0 M or greater. Suitable kosmotropic salts may be present in the isolation solution in an amount of 6.0 M or less, 5.0 M or less, or 4.0 M or less. The kosmotropic salts may be added in an amount ranging from 0.1 M to 6M, 0.5 M to 2.5 M, or 0.5 M to 3.0 M.

Examples of chaotropic salts that may be present in the solution include sodium chloride, calcium chloride, magnesium chloride and any combination thereof. In some embodiments, the isolation solution includes 1 M or less, 0.5 M or less, or 0.1 M or less of chaotropic salts. In some embodiments, the isolation solution is free or substantially free of chaotropic salts.

Suitable additives include glycerol and other polyols; protease inhibitors; phosphatase inhibitors; cryoprotectants; detergents; chelating agents; reducing agents; and any combination thereof Suitable additives may be present in the isolation solution in amounts of 0.01 millimolar (mM) or greater, 0.1 mM or greater, 1 mM or greater, 5 mM or greater, 10 mM or greater, or 20 mM or greater. Suitable salts may be added in an amount of 100 mM or less, 50 mM or less, 30 mM or less, 10 mM or less, 5 mM or less, or 1 mM or less. Suitable additives may be present in the isolation solution in amounts ranging from 0.01 mM to 100 mM, 1 mM to 50 mM, 5 mM to 30 mM, 5 mM to 20, 0.01 mM to 5 mM, or 1 mM to 5 mM.

The isolation solution solvent may be any solvent that does not degrade the target molecule. In some embodiments, the solvent includes water, an organic solvent, or both. In some embodiments, the solvent includes an organic solvent such as, for example, methanol, ethanol, isopropanol, and acetonitrile, DMSO, DMF, or any combination thereof. In some embodiments, the majority of the solvent is water. Alternatively, in some embodiments, the majority of the solvent may be made up of organic solvents. In some embodiments, the solvent is nonaqueous, e.g., consists of organic solvents.

The pH of the isolation solution may be any pH that does not make the target unstable or insoluble. Additionally, the pH of the isolation solution should be such that the separation ligands of the separation media are not unstable. The pH of the isolation solution may be controlled to enhance the binding affinity of the target to the affinity groups and/or assistance group (if present).

The isolation solution is contacted with the separation media such that at least a portion of the plurality of the targets bind to at least a portion of the separation ligands that include an affinity group and/or an assistance group (if present). Molecules present in the solution that do not include, or are not a target, will not bind to the affinity group or will bind to the affinity group a lesser affinity than the target. Such off target molecules can be removed in a washing step as discussed herein. Through binding to the affinity group, the targets are temporarily immobilized on the support substrate.

In some embodiments, the method 300 includes washing the separation media with a washing solution (step 320). Washing the separation media with a washing solution includes contacting the separation media with the washing solution. Washing the separation media may allow for any molecules that are not the target to be removed from the separation media. In the washing step, at least a portion of the targets remain bound to the affinity group and temporarily immobilized on the support substrate.

The washing solution may include a variety of components or may simply be a solvent (e.g., water). The composition and/or pH of the washing solution should be such that none of the components degrade or react with the target. Additionally, the composition and/or pH should be such that the washing solution does not decrease the affinity of the target to the affinity group to a point where the target is able to be removed from the affinity group and washed through the separation media. The washing solution includes a washing solvent. The washing solvent may be water, an organic solvent, or both. The solvent may be any solvent as described herein such as those described relative to the isolation solution. In embodiments, the washing solution includes one or more buffering agents, one or more salts, one or more additives, or any combination thereof. In some embodiments, the one or more salts, one or more buffering agents, or one or more additives may be present in the washing solution in any amount as described relative to the isolation solution.

The pH of the washing solution may be any pH that does not make the target unstable or insoluble. Additionally, the pH of the washing solution should be such that the separation ligands of the separation media are not unstable. The pH of the washing solution may be controlled to enhance the binding affinity of the target molecules to the affinity groups and/or decrease the binding affinity of any off target molecules to the affinity groups.

In some embodiments, step 320 may be repeated with additional washing solutions. The additional washing solutions may have the same composition and/or pH as the first washing solution or a different composition and/or pH than the first washing composition.

In some embodiments, method 300 further includes eluting the plurality of targets that were temporarily immobilized on the support substrate (step 330). The targets may be eluted by contacting the separation media with an elution solution. The elution solution includes an elution solvent. The elution solvent may be any solvent as described herein (e.g., the solvent included in the washing solution and/or the isolation solution). The elution solution may be of any composition and/or pH that allows for the targets to be separated from the affinity groups and exit the separation media.

In some embodiments, the elution solution may include a molecule that is bound by the affinity group and/or can compete for binding to the affinity group or target. Such a molecule may be present in an amount such as to compete off the target molecule from an affinity group. To that end, in some embodiments, the elution solution includes an affinity group competitive molecule and the elution solvent. Different targets (or targets and other molecules) may be eluted using a linear gradient elution or using a step isocratic elution.

An affinity group competitive molecule is a molecule that binds to the affinity group or the target, and when present at a sufficient concentration can compete off the target from the affinity group. In some embodiments, the affinity group competitive molecule has a higher affinity for the target than the affinity group. In other embodiments, the affinity group competitive molecule has a lower affinity for the target than the affinity molecule. In yet other embodiments, the affinity group competitive molecule may have the same affinity for the target as the affinity group.

An affinity group competitive molecule may be any molecule that binds to a given affinity group or target. For example, free affinity groups (i.e., affinity groups that are not covalently linked to the support substrate), metal binding compounds, or both may be used to disrupt the binding interaction between the affinity groups and the targets. For example, the elution solution may include EDTA. The EDTA compounds can compete for coordination to the metals immobilized on the support substrate and strip the molecules from the affinity groups.

An affinity group competitive molecule may be present in an elution solution at a concentration sufficient to compete off the target molecules from the affinity groups. In some embodiments, the affinity group competitive molecule may be present in an elution solution the amount of 20 millimolar (mM) or greater, 50 mM or greater, 100 mM or greater, 200 mM or greater, 300 mM or greater, 400 mM or greater, or 500 mM or greater. In some embodiments, the affinity group competitive molecule may be present in an elution solution the amount of 1 M or less, 500 mM or less, 400 mM or less, 300 mM or less, 200 mM or less, 100 mM or less, or 50 mM or less. In some embodiments, the affinity group competitive molecule may be present in an elution solution the amount of 20 mM to 400 mM, 50 mM to 200 mM, or 100 mM to 500 mM.

In some embodiments, the elution solution includes high amounts of one or more salts in order to decrease the binding affinity between the target and the affinity groups and/or assistance groups (if present). The salt or mixture of salts may be any salt as described herein, for example, in reference to the isolation solution. The salt or mixture of salts may be present in the elution solution in an amount of 50 millimolar (mM) or greater, 100 mM or greater, 150 mM or greater, 200 mM or greater, 300 mM or greater, 500 mM or greater, or 1 M or greater. The salt or mixture of salts may be present in the elution solution in an amount of 5 M or less, 1 M or less, 500 mM or less, 300 mM or less, 200 mM or less, or 100 mM or less.

In some embodiments, the amount and/or identity of a kosmotrope and/or chaotropic salts may be designed to decrease the binding affinity between the target molecule and the affinity group and/or assistance group (if present).

In some embodiments, the pH of the elution solution may be such as to decrease the binding affinity between the target molecules and the affinity groups. Without wishing to be bound by theory, the pH of the solution may impact the strength and/or availability of various affinity group-target interactions. For example, the binding interaction between an affinity group that includes carboxylic acid donors may decrease with decreasing pH. In some embodiments, the pH of the elution solution may be higher than the pH of the washing and/or isolation solution. In some embodiments, the pH of the elution solution may be lower than the pH of the washing and/or isolation solution. In some embodiments, the pH of the elution solution may be the same as the pH of the washing and/or isolation solution.

The volume of the elution solution used to elute the target may vary. For example, in embodiments where the separation media is being employed to concentrate the target, the volume of elution solution is less than the volume of isolation solution.

In some embodiments, the method includes regenerating the separation media. Regeneration is done to prepare the separation media (or the separation media of a separation device) for subsequent uses. Regeneration may include washing the separation media with a solution designed to strip any molecule that is not covalently attached to the support substrate from the separation media. Regeneration may also include flowing an equilibration solution through the separation media such as to prepare the separation media for future use. In some embodiments, the equilibrium solution may be the same as the isolation solution but without the target or the same as the washing solution.

In some such embodiments, it may be desirable to not recover the target once immobilized on the separation media. In some such embodiments, the method does not include a washing step and/or does not include an elution step. In some such embodiments, after exposure to a specific volume of elution solution, exposure to the elution solution for a specific time, or exposure to an absolute amount of a target in an isolation solution specific, the separation media is retired. For example, the separation media may be exposed to an isolation solution until a certain amount of the target is immobilized on the support substrate. In some such embodiments, the separation media is exposed to the isolation solution until the separation media is saturated with the target and/or other off targets.

### Illustrative Embodiments

The technology described herein is defined in the claims. However, below is provided a non-exhaustive listing of non-limiting embodiments. Any one or more of the features of these embodiments may be combined with any one or more features of another example, embodiment, or aspect described herein.

Embodiment 1 is a separation media that includes:
a support substrate; and
a plurality of separation ligands for formula SL1 or SL2

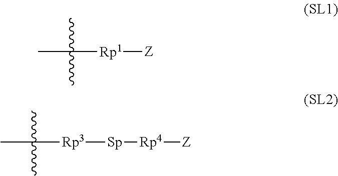

wherein:
Z is a separation group that includes an affinity group capable of binding a metal, capable of binding an enantiomer of a chiral molecule, or both; and
Rp¹, Rp³, and Rp⁴ each independently include the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, Rp^{M}, or an isomer thereof, wherein Rp^{A}, Rp^{B}, Rp^{C}, Rp^{D}, Rp^{E}, Rp^{F}, Rp^{G}, Rp^{H}, Rp^{I}, Rp^{J}, and Rp^{K} are represented by:

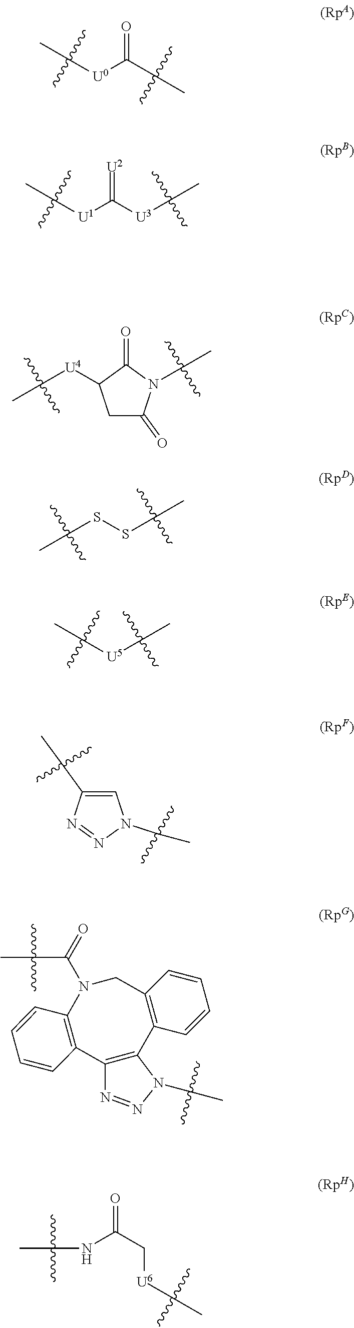

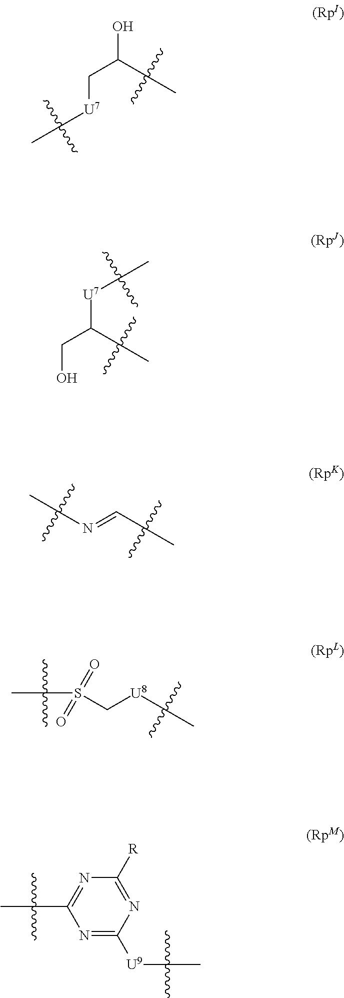

wherein:
U⁰, U¹, U², U³, U⁴, U⁵, U⁶, U⁷, U⁸ and U⁹ are each independently NH, O, or S;
R is an organic group, H, or halogen; and
Sp is a spacer that includes a divalent organic group.

Embodiment 2 is a separation media that includes:
a support substrate; and
a plurality of separation ligands for formula SL1 or SL2

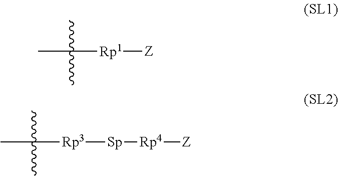

wherein:
Z is a separation group that includes an affinity group capable of binding a metal, capable of binding an enantiomer of a chiral molecule, or both; the affinity group that includes a crown ether, the separation media not comprising an amine; and
Rp¹, Rp³, and Rp⁴ each independently includes the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, Rp^{M}, or an isomer thereof,
wherein Rp^{A}, Rp^{B}, Rp^{C}, Rp^{D}, Rp^{E}, Rp^{F}, Rp^{G}, Rp^{H}, Rp^{I}, Rp^{J}, and Rp^{K} are represented by:

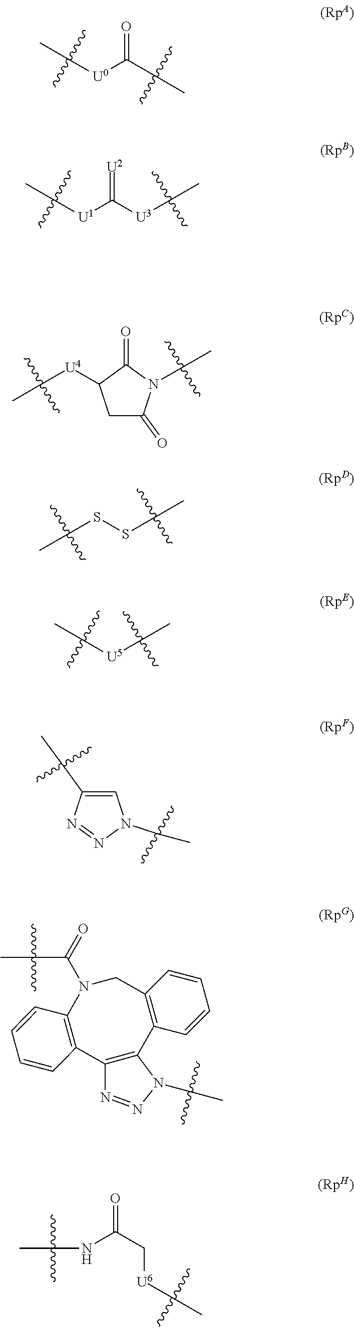

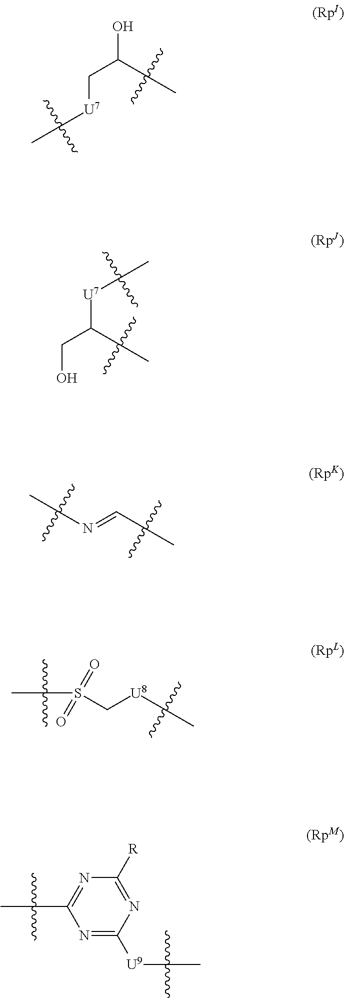

wherein:
U⁰, U¹, U², U³, U⁴, U⁵, U⁶, U⁷, U⁸ and U⁹ are each independently NH, O, or S;
R is an organic group, H, or halogen; and
Sp is a spacer includes a divalent organic group.

Embodiment 3 is a separation media that includes:
a support substrate; and
a plurality of separation ligands for formula SL1 or SL2

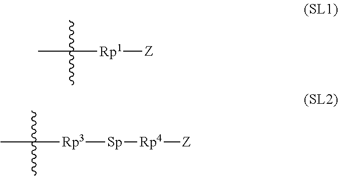

wherein:
Z is a separation group that includes an affinity group capable of binding a metal, capable of binding an enantiomer of a chiral molecule, or both; the affinity group that includes a crown ether, the separation media not comprising a silicon atom; and
Rp¹, Rp³, and Rp⁴ each independently include the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, Rp^{M}, or an isomer thereof,
wherein Rp^{A}, Rp^{B}, Rp^{C}, Rp^{D}, Rp^{E}, Rp^{F}, Rp^{G}, Rp^{H}, Rp^{I}, Rp^{J}, and Rp^{K} are represented by:

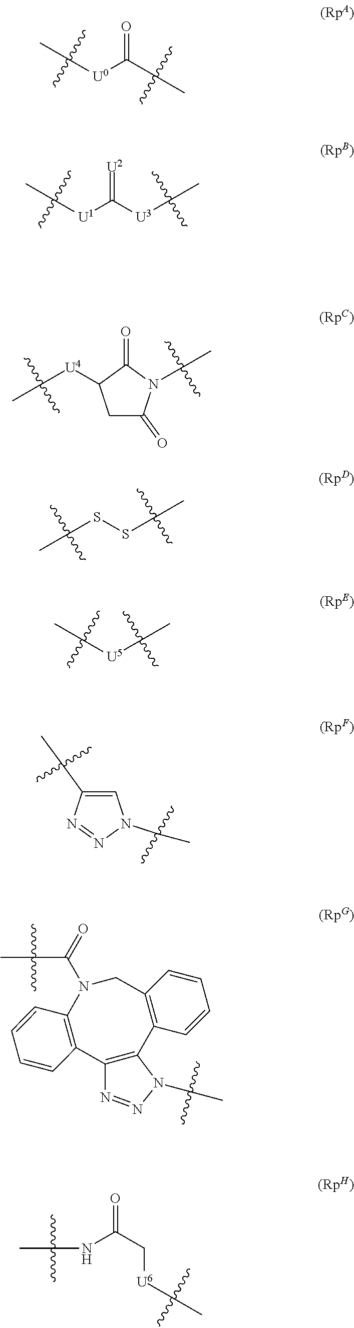

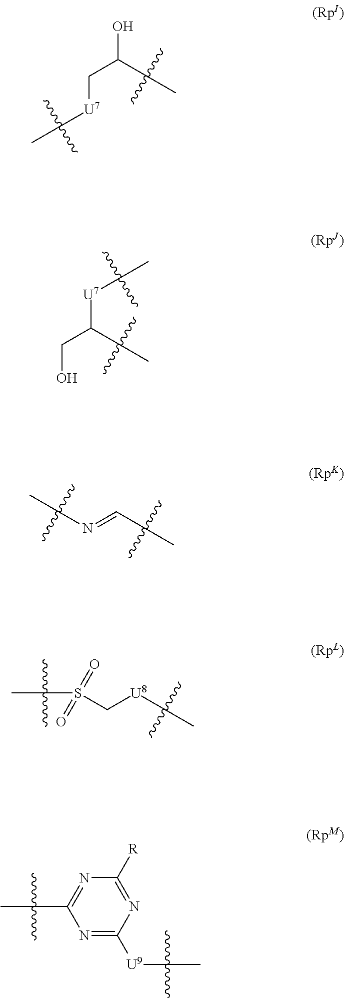

wherein:
U⁰, U¹, U², U³, U⁴, U⁵, U⁶, U⁷, U⁸ and U⁹ are each independently NH, O, or S;
R is an organic group; and
Sp is a spacer includes a divalent organic group.

Embodiment 4 is a separation media that includes:
a support substrate; and
a plurality of separation ligands for formula SL1 or SL2

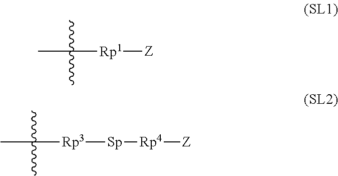

wherein:
Z is a separation group that includes an affinity group capable of binding a metal, capable of binding an enantiomer of a chiral molecule, or both; the affinity group comprising a chiral biological molecule, a chiral polymer, a helical polymer, a macrocyclic antibiotic, or any combination thereof; and
Rp¹, Rp³, and Rp⁴ each independently that includes the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, Rp^{M}, or an isomer thereof,
wherein Rp^{A}, Rp^{B}, Rp^{C}, Rp^{D}, Rp^{E}, Rp^{F}, Rp^{G}, Rp^{H}, Rp^{I}, Rp^{J}, and Rp^{K} are represented by:

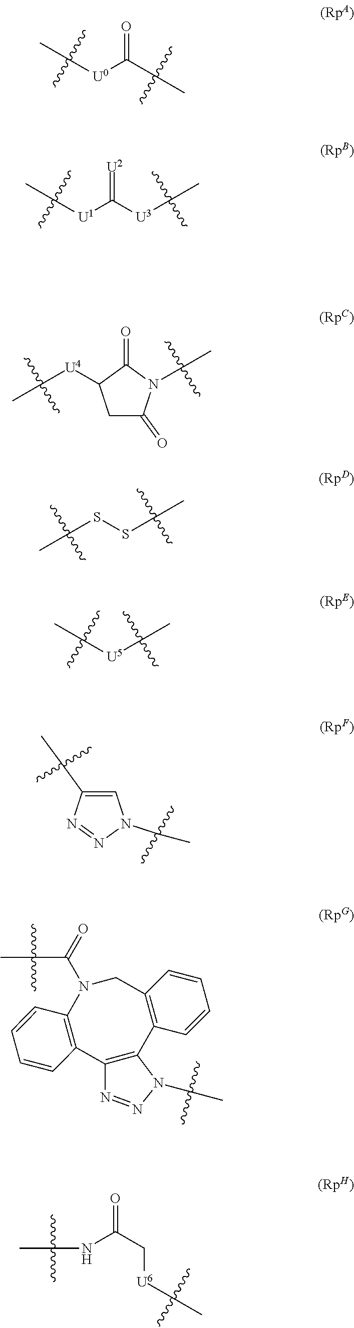

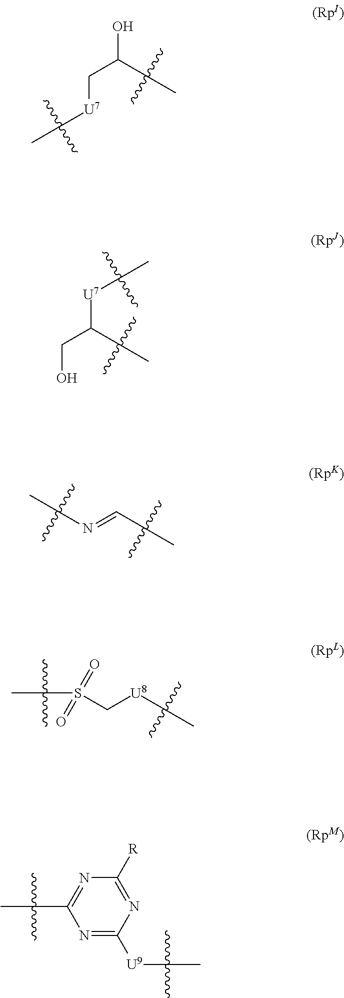

wherein:
U⁰, U¹, U², U³, U⁴, U⁵, U⁶, U⁷, U⁸ and U⁹ are each independently NH, O, or S;
R is an organic group, H, or halogen; and
Sp is a spacer that includes a divalent organic group.

Embodiment 5 is the separation media of any of Embodiments 1 through 4, wherein the plurality of separation ligands are of formula SL2 and Sp is an alkanediyl or alkenediyl that includes one or more catenated functional groups.

Embodiment 6 is the separation media of Embodiment 5, wherein the alkanediyl or alkenediyl includes a backbone chain of length C1 to C18.

Embodiment 7 is the separation media of Embodiment 6, wherein the alkanediyl or alkenediyl includes a backbone chain of length C1 to C3.

Embodiment 8 is the separation media of any of Embodiments 1 through 7, wherein Sp includes or is —C(O)—.

Embodiment 9 is the separation media of any of Embodiments 1 through 8, wherein Rp³, Rp⁴, or both includes or is Rp^{E}.

Embodiment 10 is the separation media of Embodiment 9, wherein Rp³ and Rp⁴ include or are RpE.

Embodiment 11 is the separation media of Embodiment 9, wherein each U⁵ is O.

Embodiment 12 is the separation media of Embodiment 9, wherein each U⁵ is NH.

Embodiment 13 is the separation media of Embodiment 9, wherein one U⁵ is NH and the other U⁵ is O.

Embodiment 14 is the separation media of any of Embodiments 1 through 4, wherein SL2 includes or is

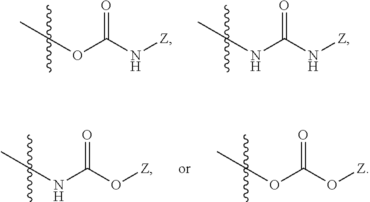

Embodiment 15 is the separation media of any of Embodiments 1 through 4, wherein SL2 includes or is

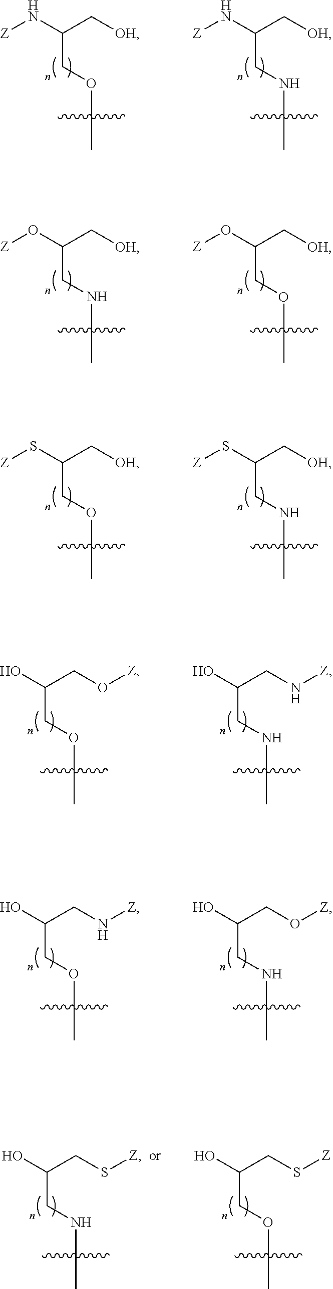

wherein n is 0, 1, 2, 3, 4, 5, 6, 7, 8, 9, or 10.

Embodiment 16 is the separation media of Embodiment 15, wherein n is 1.

Embodiment 17 is the separation media of any of Embodiment 1 through 16, wherein the support substrate includes or is a polyolefin membrane, a polyethersulfone membrane, a poly(tetrafluoroethylene) membrane, a nylon membrane, a fiberglass membrane, a hydrogel membrane, a hydrogel monolith, a polyvinyl alcohol membrane, a cellulose membrane, a cellulose ester membrane, a cellulose acetate membrane, a regenerated cellulose membrane, a cellulosic nanofiber membrane, a cellulosic monolith, a filter paper, or any combination thereof.

Embodiment 18 is the separation media of Embodiments 1 through 17, wherein the separation media is configured for use with an organic solvent.

Embodiment 19 is the separation media of any of Embodiments 1 to 18, wherein the separation media is configured for use with an aqueous solvent.

Embodiment 20 is the separation media of any of Embodiment 1 through 19, wherein the metal is a transition metal.

Embodiment 21 is the separation media any of Embodiments 1 through 19, wherein the metal is a lanthanide, actinide, or both.

Embodiment 22 is the separation media of any of Embodiments 1 through 19, wherein the metal is a post-transition metal.

Embodiment 23 is the separation media of Embodiments 1 through 19, wherein the metal is a metalloid.

Embodiment 24 is the separation media of any of Embodiments 1 through 23, wherein the affinity group includes or is a dithiocarbamate.

Embodiment 25 is the separation media of Embodiment 23, wherein the affinity group includes or is pyrrolidine dithiocarbamate, dimethyldithiocarbamate, or both.

Embodiment 26 is the separation media of any of Embodiments 1 through 23, wherein the affinity group includes or is an ethylene bis(dithiocarbamate).

Embodiment 27 is the separation media of Embodiment 26, wherein the affinity group includes or is ethylene-1,2-bisdithiocarbamate, propylenebis(dithiocarbamic); ethane-1,2-diylbis(dithiocarbamate), or any combination thereof.

Embodiment 28 is the separation media of any of Embodiments 1 through 23, wherein the affinity group includes or is a polyaminocarboxylic acid, an aminopolycarboxylic acid, or both.

Embodiment 29 is the separation media of Embodiment 28, wherein the affinity group includes or is ethylenediaminetetraacetic acid; 1,2-bis(o-aminophenoxy)ethane-N,N,N′,N′-tetraacetic acid; 1,4,7-triazacyclononane-1,4,7-triacetic acid; 2,2′,2″,2′″-(1,4,7,10-tetraazacyclododecane-1,4,7,10-tetrayl)tetraacetic acid; 2-[6-[bis(carboxymethyl)amino]-5-[2-[2-[bis(carboxymethyl)amino]-5-methylphenoxy]ethoxy]-2-benzofuranyl]-5-oxazolecarboxylic acid; diethylenetriaminepentaacetic acid; 3,12-bis(carboxymethyl)-6,9-dioxa-3,12-diazatetradecane-1,14-dioic acid; nicotianamine; thylenediamine-N,N′-bis(2-hydroxyphenylacetic acid; ethylenediamine-N,N′-disuccinic acid; or any combination thereof.

Embodiment 30 is the separation media of any of Embodiments 4 through 19, wherein the helical polymer is double stranded DNA.

Embodiment 31 is the separation media of Embodiment 30, wherein the chiral biological molecule includes or is a substituted or unsubstituted polysaccharide.

Embodiment 32 is the separation media of Embodiment 31, wherein the substituted or unsubstituted polysaccharide includes or is amylose, cellulose chitosan, fructan, or aliginic acid.

Embodiment 33 is the separation media of any of Embodiments 4 through 19, wherein the biological molecule includes or is a peptide.

Embodiment 34 is the separation media of Embodiment 33, wherein the peptide includes or is albumin.

Embodiment 35 is a separation media comprising two or more of the separation media of any of Embodiments 1 through 34 arranged in a stacked configuration.

Embodiment 36 is the separation media of Embodiment 35, wherein the separation media comprises two separation media and the separation media are of the same identity.

Embodiment 37 is the separation media of Embodiment 35, wherein the separation media comprises two separation media and the separation media are of a different identity.

Embodiment 38 is a separation device comprising a housing and the separation media of any of Embodiments 1 through 37 disposed within the housing.

Embodiment 39 is a method of isolating a target from an isolation solution, the isolation solution including a solvent; and the target; the method includes: contacting the isolation solution with the separation media of any of Embodiments 1 to 37.

Embodiment 40 is the method of Embodiment 39, wherein the target is a metal.

Embodiment 41 is the method of Embodiment 39, wherein the target is an enantiomer of a chiral molecule.

Embodiment 42 is the method of any of Embodiments 39 through 41, wherein the isolation solution includes or is a waste mixture.

Embodiment 43 is the method of Embodiment 42, wherein the isolation solution includes or is reaction waste.

Embodiment 44 is the method of Embodiment 42, wherein the isolation solution includes or is wastewater.

Embodiment 45 is the method of any of Embodiments 39 through 44, wherein the method further includes washing the separation media with a washing solution.

Embodiment 46 is the method of any of Embodiments 39 through 45, wherein the method further includes contacting the separation media with an elution solution.

### EXAMPLES

The present disclosure is illustrated by the following examples. It is to be understood that the particular examples, materials, amounts, and procedures are to be interpreted broadly in accordance with the scope and spirit of the disclosure as set forth herein.

### Example 1. Example Synthetic Methods that May be Used to Prepare the Separation Media of the Present Disclosure

Several synthetic strategies may be employed to construct the separation media of the present disclosure. The synthetic strategies include direct or indirect immobilization of separation ligands. The synthetic strategies also include amine assisted coupling and/or organic solvent assisted coupling.

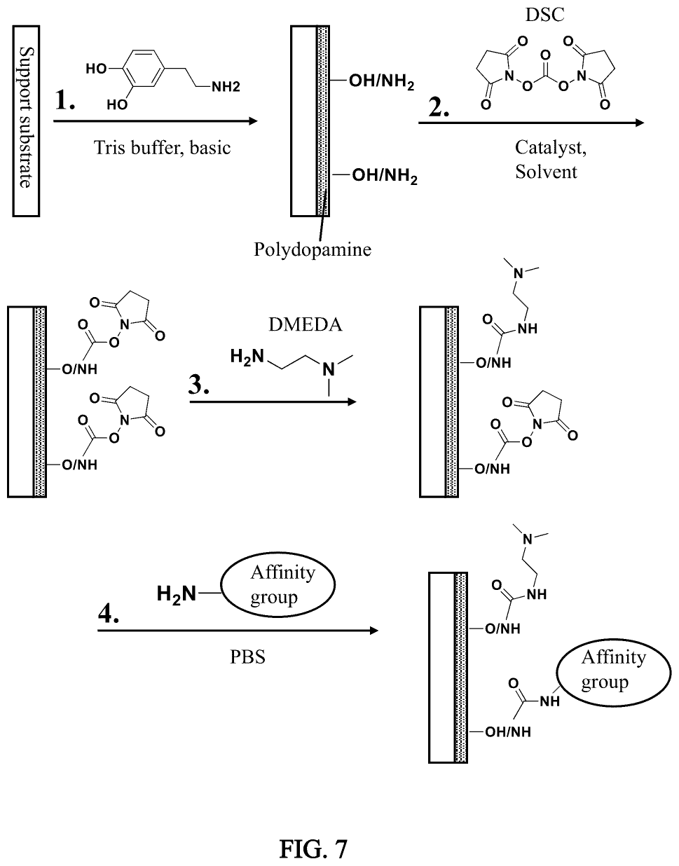

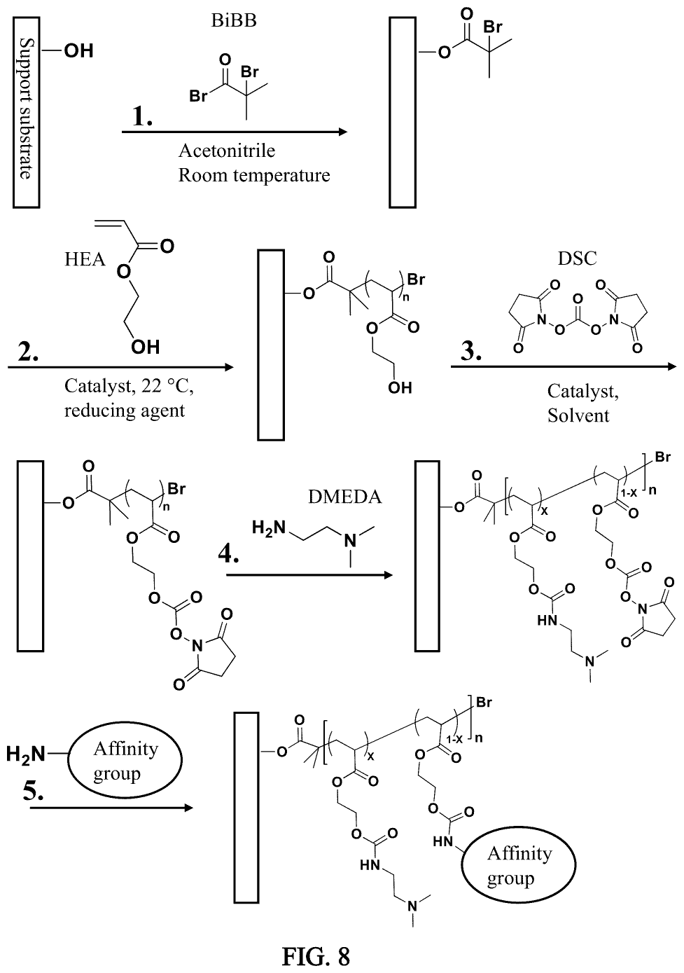

FIG. 7 and FIG. 8 show schematics of synthetic schemes that include the indirect immobilization of the separation ligands to the support substrate. The strategies of FIG. 7 and FIG. 8 also include the amine assisted coupling method.

In Step 1, of the scheme in FIG. 7, polydopamine (PDA) is incorporated onto a support membrane through oxidative polymerization of dopamine in basic aqueous buffer in the presence of air. Deposition of PDA may function to hydrophilize the support substrate and introduce support substrate reactive handles (e.g., hydroxyl, amine, and quinone). In step 2, the PDA reactive handles may be reacted with the bifunctional (has two NHS ester reactive handles) of linker precursor disuccinimidyl carbonate (DSC). The PDA reactive handles (OH and NH₂) may react with the first N-hydroxy succinimidyl (NHS) ester of the linker precursor to form a first amide or carbamate reaction product. In step 3, a portion of the second NHS ester groups may be reacted with the amine reactive handle of N,N-dimethylethylenediamine (DMEDA; a first separation group precursor) to form a second amide reaction product. The DMEDA groups (e.g., the tertiary amine of DMEDA) may act as an assistance affinity groups to increase the local concentration of negatively charged (in aqueous buffer) affinity groups at the membrane surface through coulombic interaction. In step 4, the second portion of the second NHS ester groups may be reacted with a second separation group (including an affinity group) precursor reactive handle (an amine as shown in this scheme) to form an amide reaction product. The conjugation reaction of step 4 may be done in an aqueous buffer.

In the first step of the scheme depicted in FIG. 8, an initiator (α-bromoisobutyryl bromide, BiBB) may be coupled to the OH groups of a support substrate. In the second step, hydroxyethyl acrylate monomers may be polymerized from the immobilized initiator to from poly(HEA). In step 3, the poly(HEA) reactive handles (OH groups) may be reacted with the bifunctional (has two NHS ester reactive handles) linker precursor disuccinimidyl carbonate (DSC). The poly(HEA) reactive handles (OH) may react with the first NHS ester of the linker precursor to form a first carbamate reaction product. In step 4, a portion of the second NHS ester groups may be reacted with the amine reactive handle of N,N-dimethylethylenediamine (DMEDA; a first separation group precursor) to form an amide reaction product and install the separation ligands containing the amine assistance groups. The DMEDA groups (e.g., the tertiary amine of DMEDA) may act as assistance groups which may allow for a higher density of negatively charged (in aqueous buffer) affinity groups at the support substrate surface through coulombic interaction. In step 5, the second portion of the second NHS ester groups may be reacted with a second separation group (including the affinity group) precursor reactive handle to form an amide reaction product and install the separation ligands containing the affinity group on the support substrate. The conjugation reaction of step 5 may be completed in an aqueous buffer reaction mixture. In some embodiments, the support substrate may be exposed to a tris base solution as a final step to quench unreacted NHS intermediates and to install separation ligands containing a capping group.

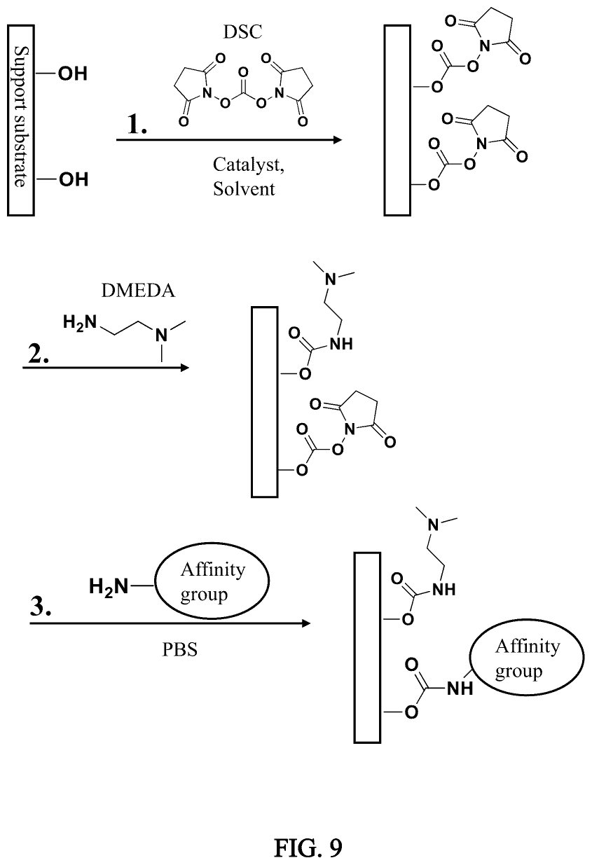

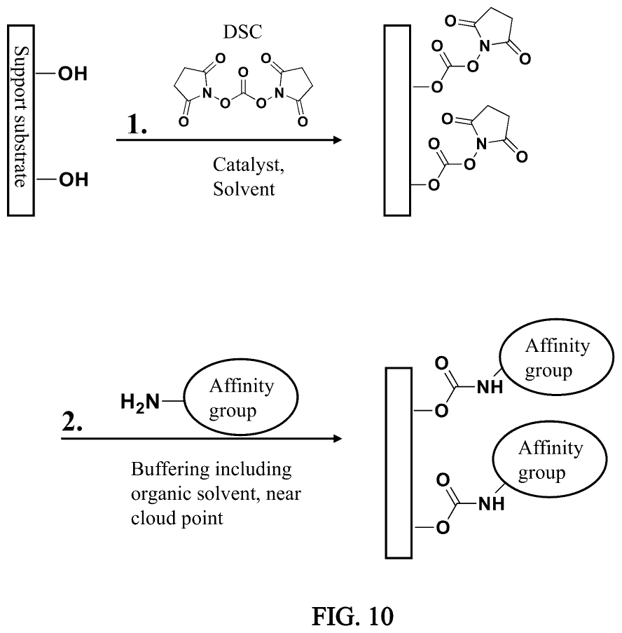

FIG. 9 and FIG. 10 show schematics of synthetic schemes that include the direct immobilization of the separation ligands on the support substrate. The strategies of FIG. 9 include the amine assisted cooling method. The strategy of FIG. 10 includes the organic solvent assistance method.

FIG. 9 shows a synthetic strategy where the separation ligands can be directly immobilized on the support substrate and the amine assisted method may be used to achieve a high density of separation ligands. This synthetic strategy is similar to the strategy in FIG. 7 except that the membrane was not functionalized with a polymer. Instead, the hydroxyl reactive handles of the support substrate can be directly reacted with one of the NHS ester reactive handles of DSC to form a carbamate reaction product (step 1). Separation ligands having an amine assistance group can be installed (step 2). The amine assistance group may facilitate the installation of the separation groups that include an affinity group (step 3). The conjugation reaction of step 3 may be done in an aqueous buffer reaction mixture.

FIG. 10 shows a synthetic strategy where the separation ligands can be directly immobilized on the support substrate and the organic solvent assisted method may be used to achieve a high density of separation ligands. Residual tertiary amine moieties in the final separation media may have the potential for nonspecific binding when the solution conductivity is very low. As affinity chromatography typically is performed at conductivity levels above that which tertiary amines retain significant binding capacity, the residual amine groups were expected to have negligible effect on chromatographic performance. In an effort to circumvent this potential issue completely, an organic solvent assisted coupling method may be employed to install the separation ligands containing the affinity group. The organic assisted coupling method utilizes water-miscible organic solvents as a constituent of the coupling solution to increase separation group precursor coupling efficiency, which enables use of low separation group precursor concentrations in the coupling solution. Additions of organic solvents to the aqueous buffered reaction mixture (10%-80% by volume depending on the organic solvent used) to bring solution near the cloud point. At the cloud point, the reaction mixture starts to appear turbid upon increasing the concentration of organic solvent. Organic solutions replace water molecules in the separation group precursor solvation shell which can facilitate greater interaction between the separation group precursor and the support substrate. Additional organic solutions added beyond the cloud point may exacerbate aggregation and flocculation dynamics of the separation group precursor, which can comparatively reduce efficiency of coupling reaction. This coupling methodology may allow for high performance separation media to be prepared with low separation group consumption.

FIG. 10 shows an example synthetic scheme that may be used to prepare separation media of the present application via direct immobilization of the separation ligands using the organic solvent assisted coupling method. In step 1 the support substrate reactive handles (OH) may be reacted with the first N-hydroxy succinimidyl (NHS) ester of the DSC linker precursor to form a carbamate reaction product. In the second step, a reaction mixture that is near the cloud point that includes the separation group precursor (includes the affinity group), water, and a water-miscible solvent may be exposed to the reaction product of step 2. The second NHS ester groups of the support substrate-linker conjugate may react with the reactive handle (NH₂) of the separation group precursor to form an amide reaction product and install the separation ligands having the affinity group on the support substrate.

The complete disclosure of all patents, patent applications, and publications, and electronically available material cited herein are incorporated by reference in their entirety. Supplementary materials referenced in publications (such as supplementary tables, supplementary figures, supplementary materials and methods, and/or supplementary experimental data) are likewise incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The disclosure is not limited to the exact details shown and described, for variations obvious to one skilled in the art will be included within the disclosure defined by the claims.

Notwithstanding that the numerical ranges and parameters setting forth the broad scope of the disclosure are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

What is claimed is:

1. A separation media comprising:
a support substrate; and
a plurality of separation ligands for formula SL1 or SL2 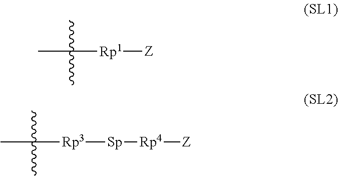
wherein:
Z is a separation group comprising an affinity group capable of binding a metal, capable of binding an enantiomer of a chiral molecule, or both; and
Rp¹, Rp³, and Rp⁴ each independently comprise the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, Rp^{M}, or an isomer thereof, wherein Rp^{A}, Rp^{B}, Rp^{C}, Rp^{D}, Rp^{E}, Rp^{F}, Rp^{G}, Rp^{H}, Rp^{I}, Rp^{J}, and Rp^{K} are represented by: 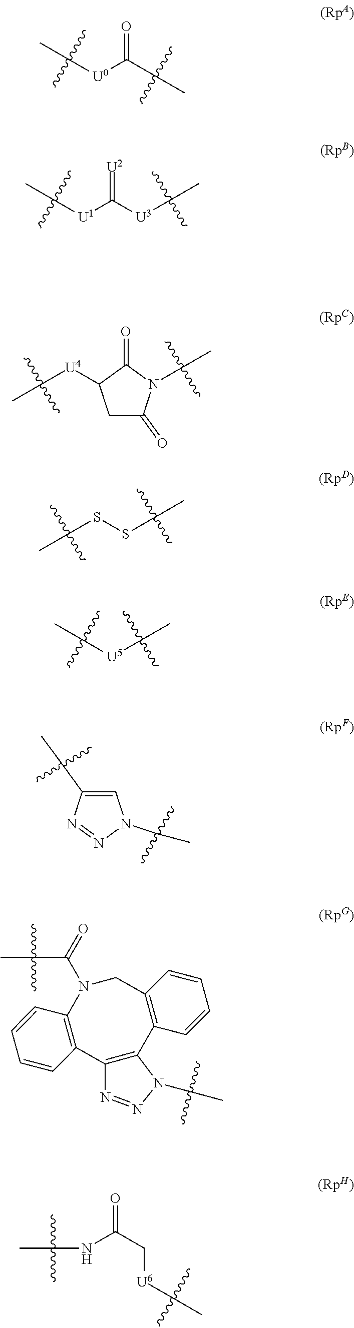 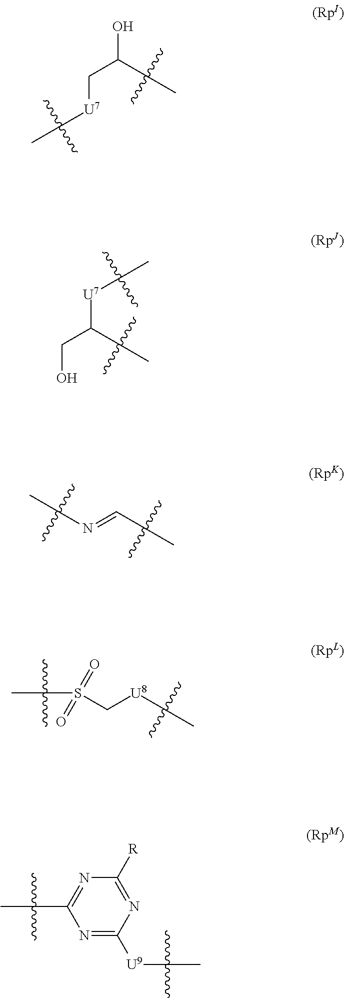
wherein:
U⁰, U¹, U², U³, U⁴, U⁵, U⁶, U⁷, U⁸ and U⁹ are each independently NH, O, or S;
R is an organic group, H, or halogen; and
Sp is a spacer comprising a divalent organic group.

2. The separation media claim 1, wherein the plurality of separation ligands are of formula SL2 and Sp is an alkanediyl or alkenediyl comprising one or more catenated functional groups, and wherein the alkanediyl or alkenediyl comprises a backbone chain of length C1 to C18.

3. The separation media of any one of claim 1, wherein Rp³ and Rp⁴ comprises Rp^{E} and wherein one U⁵ is NH and the other U⁵ is O.

4. The separation media of any one of claim 1, wherein SL2 comprise 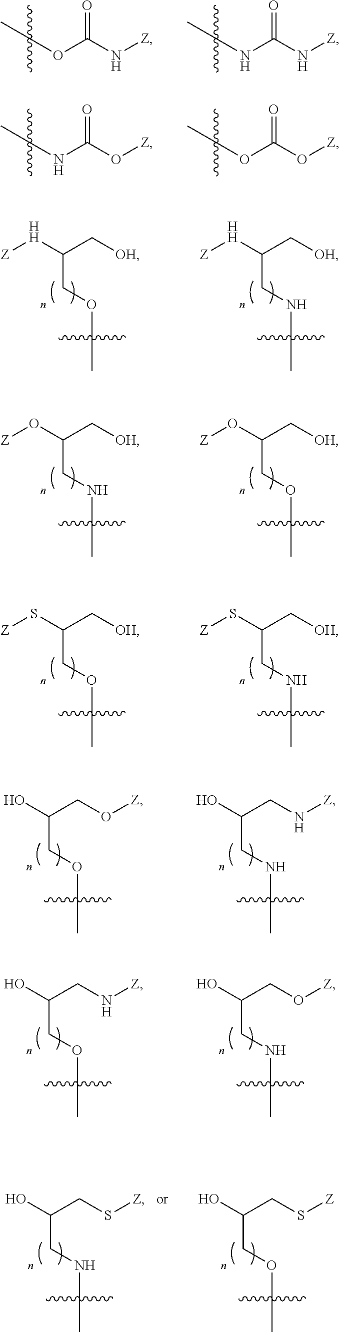
or wherein n is 0, 1, 2, 3, 4, 5, 6, 7, 8, 9, or 10.

5. The separation media of claim 1, wherein the support substrate comprises a polyolefin membrane, a polyethersulfone membrane, a poly(tetrafluoroethylene) membrane, a nylon membrane, a fiberglass membrane, a hydrogel membrane, a hydrogel monolith, a polyvinyl alcohol membrane, a cellulose membrane, a cellulose ester membrane, a cellulose acetate membrane, a regenerated cellulose membrane, a cellulosic nanofiber membrane, a cellulosic monolith, a filter paper, or any combination thereof.

6. The separation media of claim 1, wherein the metal is a transition metal, a lanthanide, an actinide, a pos-transition metal, or a metalloid.

7. The separation media of claim 1, wherein the affinity group comprises a dithiocarbamate and wherein the dithiocarbamate is a pyrrolidine dithiocarbamate, dimethyldithiocarbamate, an ethylene bis(dithiocarbamate), or any combination thereof.

8. The separation media of claim 1, wherein the affinity group comprises ethylene-1,2-bisdithiocarbamate, propylenebis(dithiocarbamic); ethane-1,2-diylbis(dithiocarbamate), or any combination thereof.

9. The separation media of claim 1, wherein the affinity group comprises a polyaminocarboxylic acid, an aminopolycarboxylic acid, or both.

10. The separation media of claim 1, wherein the affinity group comprises ethylenediaminetetraacetic acid; 1,2-bis(o-aminophenoxy)ethane-N,N,N′,N′-tetraacetic acid; 1,4,7-triazacyclononane-1,4,7-triacetic acid; 2,2′,2″,2′″-(1,4,7,10-tetraazacyclododecane-1,4,7,10-tetrayl)tetraacetic acid; 2-[6-[bis(carboxymethyl)amino]-5-[2-[2-[bis(carboxymethyl)amino]-5-methylphenoxy]ethoxy]-2-benzofuranyl]-5-oxazolecarboxylic acid; diethylenetriaminepentaacetic acid; 3,12-bis(carboxymethyl)-6,9-dioxa-3,12-diazatetradecane-1,14-dioic acid; nicotianamine; thylenediamine-N,N′-bis(2-hydroxyphenylacetic acid; ethylenediamine-N,N′-disuccinic acid; or any combination thereof.

11. A separation device comprising a housing and the separation media of claim 1 disposed within the housing.

12. A method of isolating a target from an isolation solution:
the isolation solution comprising:
a solvent; and
the target, the target comprising a metal or an enantiomer of a chiral molecule;
the method comprising:
contacting the isolation solution with the separation media of claim 1.

13. A separation media comprising:
a support substrate; and
a plurality of separation ligands for formula SL1 or SL2 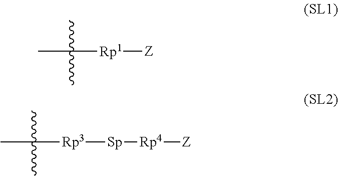
wherein:
Z is a separation group comprising an affinity group capable of binding a metal, capable of binding an enantiomer of a chiral molecule, or both; the affinity group comprising a chiral biological molecule, a chiral polymer, a helical polymer, a macrocyclic antibiotic, or any combination thereof; and
Rp¹, Rp³, and Rp⁴ each independently comprise the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, Rp^{M}, or an isomer thereof,
wherein Rp^{A}, Rp^{B}, Rp^{C}, Rp^{D}, Rp^{E}, Rp^{F}, Rp^{G}, Rp^{H}, Rp^{I}, Rp^{J}, and Rp^{K} are represented by: 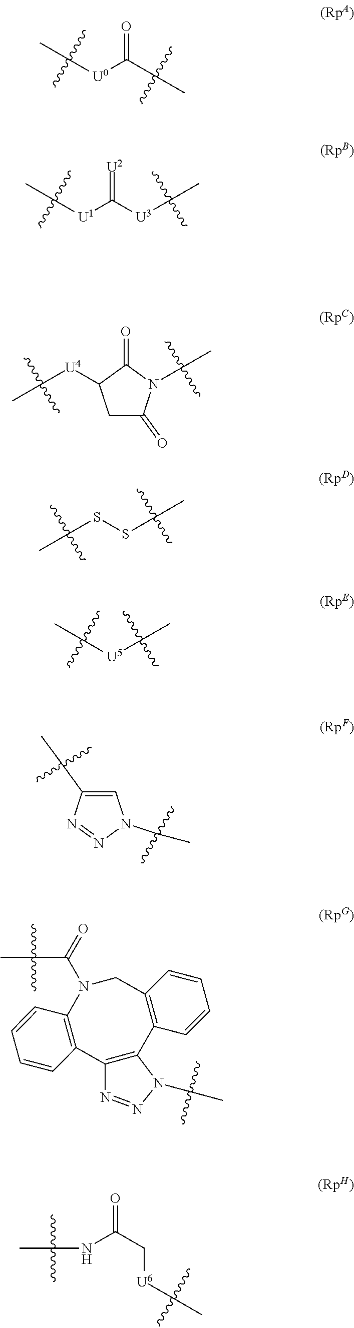 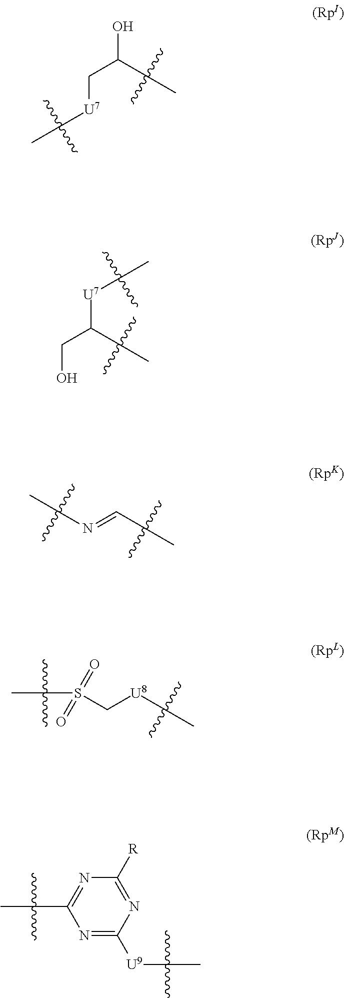
wherein:
U⁰, U¹, U², U³, U⁴, U⁵, U⁶, U⁷, U⁸ and U⁹ are each independently NH, O, or S;
R is an organic group, H, or halogen; and
Sp is a spacer comprising a divalent organic group.

14. The separation media of claim 13, wherein the helical polymer is double stranded DNA.

15. The separation media of claim 13, wherein the chiral biological molecule is a substituted or unsubstituted polysaccharide and wherein the substituted or unsubstituted polysaccharide is amylose, cellulose chitosan, fructan, or aliginic acid.

16. A separation device comprising a housing and the separation media of claim 13 disposed within the housing.

17. A method of isolating a target from an isolation solution:
the isolation solution comprising:
a solvent; and
the target, the target comprising a metal, capable of binding an enantiomer of a chiral molecule, or both;
the method comprising:
contacting the isolation solution with the separation media of claim 13.

18. A separation media comprising:
a support substrate; and
a plurality of separation ligands for formula SL1 or SL2 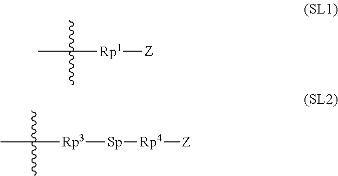
wherein:
Z is a separation group comprising an affinity group capable of binding a metal, capable of binding an enantiomer of a chiral molecule, or both; the affinity group comprising a crown ether, the separation media not comprising an amine or the separation not comprising a silicon atom; and
Rp¹, Rp³, and Rp⁴ each independently comprise the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, Rp^{M}, or an isomer thereof,
wherein Rp^{A}, Rp^{B}, Rp^{C}, Rp^{D}, Rp^{E}, Rp^{F}, Rp^{G}, Rp^{H}, Rp^{I}, Rp^{J}, and Rp^{K} are represented by: 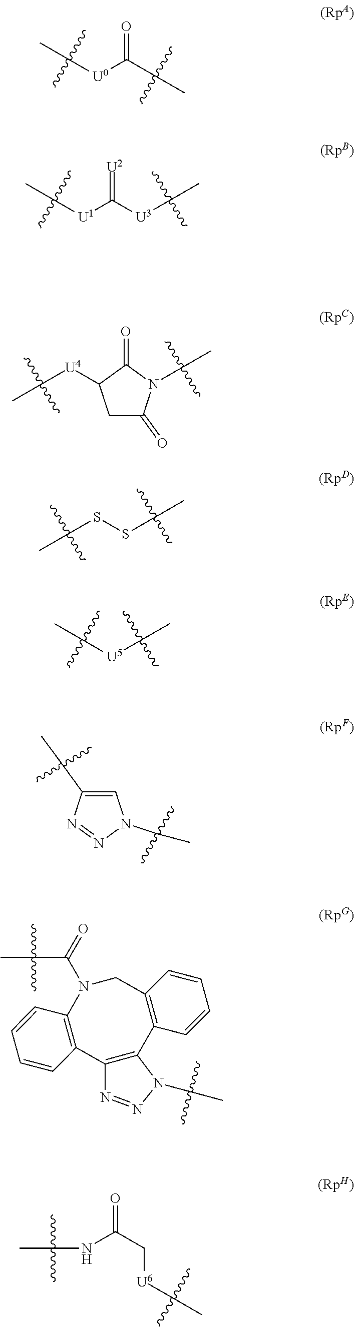 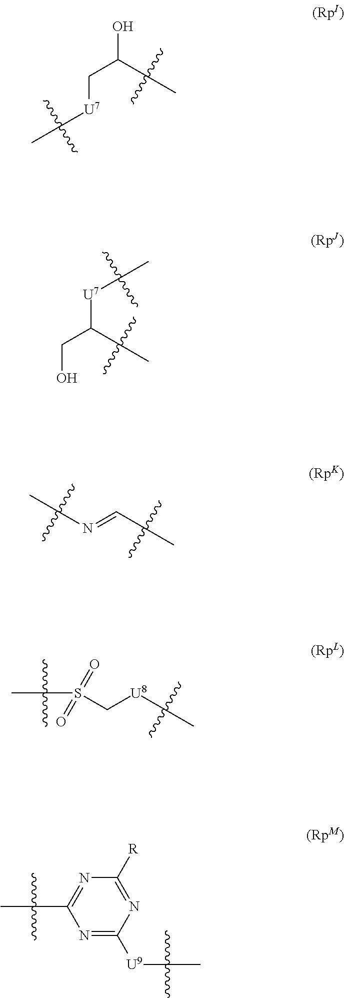
wherein:
U⁰, U¹, U², U³, U⁴, U⁵, U⁶, U⁷, U⁸ and U⁹ are each independently NH, O, or S;
R is an organic group, H, or halogen; and
Sp is a spacer comprising a divalent organic group.

19. A separation device comprising a housing and the separation media of claim 18 disposed within the housing.

20. A method of isolating a target from an isolation solution:
the isolation solution comprising:
a solvent; and
the target, the target comprising a metal, capable of binding an enantiomer of a chiral molecule, or both;
the method comprising:
contacting the isolation solution with the separation media of claim 19.
